(19) United States
(12) Patent Application Publication
(10) Pub. No.: US 2026/0045986 A1
(43) Pub. Date: Feb. 12, 2026

(54) METHODS, DEVICES, AND MEDIUM FOR COMMUNICATION

(71) Applicant: NEC Corporation, Tokyo (JP)

(72) Inventors: Yukai GAO, Beijing (CN); Peng GUAN, Beijing (CN); Gang WANG, Beijing (CN)

(73) Assignee: NEC Corporation, Tokyo (JP)

(21) Appl. No.: 19/100,353

(22) PCT Filed: Aug. 1, 2022
(86) PCT No.: PCT/CN2022/109552

§ 371 Date: Jan. 31, 2025

(51) Int. Cl. H04B 7/06; H04W 24/10

(52) U.S. Cl. CPC H04B 7/061; H04W 24/10

(57) ABSTRACT

Example embodiments of the present disclosure relate to an effective mechanism for processing the CSI reports. In this solution, the terminal device receives, at a terminal device and from a network device, at least one configuration for channel state information (CSI) feedback; and transmits, based on at least one configuration, to the network device, the CSI feedback comprising a plurality of partitions with different omission priorities, the plurality of partitions comprising parameters associated with: a plurality of first vectors, a plurality of second vectors, and a plurality of third vectors. In this way, by associating the parameters with three types of vectors, the TD/DD information may be reported together with the SD information and FD information.

### FIELD

Example embodiments of the present disclosure generally relate to the field of communication techniques and in particular, to methods, devices, and medium for configuring and transmitting the channel state information (CSI) feedback.

### BACKGROUND

In order to meet the increasing wireless data traffic demand, a plurality of schemes have been proposed and implemented, where the multiple input multiple output (MIMO) technology is considered as one powerful scheme to achieve high data throughputs in the communication system. MIMO includes features that facilitate utilization of a large number of antenna elements at a network device (such as, a base station, BS) for both sub-6 GHz and over-6 GHz frequency bands.

Generally speaking, during the communication between the terminal device and the network device, the terminal device needs to report CSI feedback to the network device, such that the network device may understand the network condition and make a more proper subsequent schedule. In some scenarios, the terminal device moves at a high/medium velocity, which causes that the reported CSI feedback may be not available (i.e., out of date) for the future channel.

Specifically, in the case of downlink multi-antenna transmission, the terminal device may measure a CSI-reference signal (CSI-RS) transmitted from the network device and report a recommended pre-coder matrix or an indication of the recommended pre-coder matrix and/or channel quality indicator, CQI, in a CSI report to the network device. The network device may then use the recommended pre-coder matrix when performing data transmission to the terminal device. However, in non-ideal conditions, the preferred pre-coder matrix and/or CQI may be time-sensitive, and the recommended pre-coder matrix and/or CQI may be not applicable anymore when the network device is scheduling downlink data transmission for the terminal device after a time period. Thus, it is desirable to provide a solution to support the CSI reporting in a scenario where the terminal device moves at a high/medium velocity.

### SUMMARY

In general, embodiments of the present disclosure provide methods, devices and computer storage media of configuring and transmitting the CSI feedback.

In a first aspect, there is provided a method of communication performed by a terminal device. The method comprises: receiving, at a terminal device and from a network device, at least one configuration for CSI feedback; and transmitting, based on at least one configuration, to the network device, the CSI feedback comprising a plurality of partitions with different omission priorities, the plurality of partitions comprising parameters associated with: a plurality of first vectors, a plurality of second vectors, and a plurality of third vectors.

In a second aspect, there is provided a method of communication performed by a network device. The method comprises: transmitting, at a network device and to a terminal device, at least one configuration for CSI feedback; and receiving, based on at least one configuration, from the terminal device, the CSI feedback comprising a plurality of partitions with different omission priorities, the plurality of partitions comprising parameters associated with: a plurality of first vectors, a plurality of second vectors, and a plurality of third vectors.

In a third aspect, there is provided a terminal device. The terminal device includes a processing unit; and a memory coupled to the processing unit and storing instructions thereon, the instructions, when executed by the processing unit, causing the device to perform the method according to the first aspect.

In a fourth aspect, there is provided a network device. The network device includes a processing unit; and a memory coupled to the processing unit and storing instructions thereon, the instructions, when executed by the processing unit, causing the device to perform the method according to the second aspect.

In a fifth aspect, there is provided a computer readable medium having instructions stored thereon, the instructions, when executed on at least one processor, causing the at least one processor to carry out the method according to any of the above first and second aspects.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example block of CSI report according to a traditional solution;

FIG. 2 illustrates an example communication environment in which example embodiments of the present disclosure can be implemented;

FIG. 3 illustrates a signaling chart illustrating a process for communication according to some embodiments of the present disclosure;

FIG. 4A illustrates a schematic diagram of spatial domain, frequency domain and doppler/time domain basis;

FIG. 4B illustrates another schematic diagram of spatial domain, frequency domain and doppler/time domain basis;

FIG. 4C illustrates a further schematic diagram of spatial domain, frequency domain and doppler/time domain basis;

FIGS. 5A and 5B illustrate example blocks of CSI feedback according to some embodiments of the present disclosure;

FIG. 6 illustrates an example method performed by the terminal device according to some embodiments of the present disclosure;

FIG. 7 illustrates an example method performed by the network device according to some embodiments of the present disclosure; and

FIG. 8 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (JAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As discussed above, the CSI feedback is important in the wireless communication network. In the 3rd-generation partnership project (3GPP) release 18, some discussions for CSI enhancement are expected to be further discussed, for example. It is expected that CSI enhancement for a high/medium velocity and for coherent joint transmission (CJT) will be specified and the maximum number of CSI-RS ports per resource may be 32.

Further, it is expected to specify CSI reporting enhancement for a high/medium velocity by exploiting time-domain (TD) correlation and/or doppler-domain (DD) information to assist downlink precoding, targeting frequency range 1 (FR 1), as follows:
Release 16/17 type-II codebook refinement, without modification to the spatial domain (SD) basis and frequency domain (FD) basis;
UE reporting of TD channel properties (TDCP) measured via CSI-reference signal (RS) for tracking.

In addition, it is expected to specify enhancements of CSI acquisition for CJT targeting FR1 and up to 4 TRPs, assuming ideal backhaul and synchronization as well as the same number of antenna ports across TRPs, as follows:
Release 16/17 type-II codebook refinement for CJT multi-TRP targeting FDD and its associated CSI reporting, taking into account throughput-overhead trade-off,
sounding reference signal (SRS) enhancement to manage inter-TRP cross-SRS interference targeting time division duplex (TDD) CJT via SRS capacity enhancement and/or interference randomization, with the constraints: 1) without consuming additional resources for SRS; 2) reusing existing SRS comb structure; 3) without new SRS root sequences.

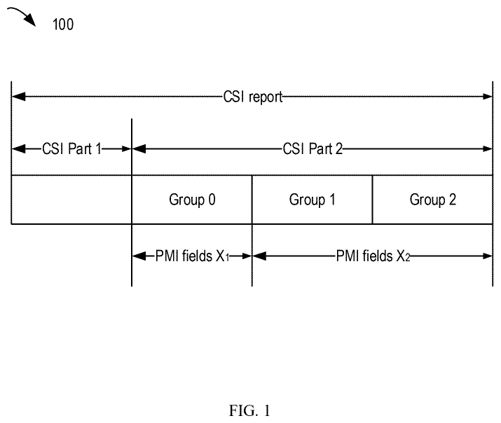

FIG. 1 illustrates an example block of CSI report 100. As shown in FIG. 1, a CSI report may be divided into two parts, i.e., part 1 and part 2, where part 2 is further divided into three groups, i.e., group 0 to group 2. In addition, a CSI report may comprise PMI fields X₁ and PMI fields X₂. For example, PMI fields X₁ may be comprised in CSI group 0. For another example, PMI fields X₂ may be comprised in CSI group 1 and CSI group 2. For a further example, a subset of PMI fields X₂ may be comprised in CSI group 1, and the remaining of PMI fields X₂ may be comprised in CSI group 2.

Below table 1 illustrates an example mapping order of CSI fields of one CSI report, CSI part 1.

TABLE 1
an example mapping order of CSI fields of one CSI report, CSI part 1

| CSI report number | CSI fields |
|---|---|
| CSI report #n | Rank Indicator (RI), if reported |
| CSI part 1 | Wideband channel quality indicator (CQI) for the first transport |
| | block (TB), if reported |
| | Subband differential CQI for the first TB with increasing order of |
| | subband number, if reported, |
| | Subbands for given CSI report n indicated by the higher layer |
| | parameter csi-ReportingBand are numbered continuously in the |
| | increasing order with the lowest subband of csi-ReportingBand as |
| | subband 0 |
| | Indicator of the total number of non-zero coefficients summed |
| | across all layers K^{NZ}, if reported |

Below table 2 illustrates an example RI and CQI (defined by information element codebookType=typeII-r16 or typeII-PortSelection-r16).

TABLE 2
an example RI and CQI

| Field | Bitwidth |
|---|---|
| Rank Indicator (RI) | min(2, ┌log₂n_{RI}┐) |
| | where n_{RI} is the number of allowed rank indicator |
| | values |
| Wide-band CQI | 4 |
| Subband differential CQI | 2 |
| Indicator of the total number of non- | ┌log₂(K₀)┐ if max allowed rank is 1; |
| zero coefficients summed across all | ┌log₂(2K₀)┐ otherwise, |
| layers K^{NZ} | ${K}_{0} = ⌈ 2 L ⌈ {p}_{1} \times \frac{{N}_{3}}{R} ⌉ β ⌉ , where {p}_{1} , {N}_{3} , R , and β are$ |
| | configured or determined by a network device (for |
| | example, given by Clause 5.2.2.2.5 and 5.2.2.2.6 by |
| | TS 38.214). For example, p₁ may be the parameter |
| | of p_{ν} when ν = 1. |

Further, the values of the rank indicator (RI) field are mapped to allowed rank indicator values with increasing order, where ‘0’ is mapped to the smallest allowed rank indicator value. The values of the K^{NZ} indicator field are mapped to the allowed values of K^{NZ}, according to Clauses 5.2.2.2.5 and 5.2.2.2.6 of TS 38.214, with increasing order, where ‘0’ is mapped to K^{NZ}×1.

In some embodiments, a parameter of number of allowed rank indicator values (e.g. n_{RI}) may be configured by the network device.

In some embodiments, v may be the number of layers or the value of rank indicator field. For example, the number of layers or the value of the rank indicator field may be reported by the terminal device to the network device.

Below table 3 illustrate an example RI and CQI (defined by information element codebookType=typeII-PortSelection-r17).

TABLE 3
illustrates an example RI and CQI

| Field | Bitwidth |
|---|---|
| Rank Indicator (RI) | min(2, ┌log₂n_{RI}┐) |
| | where n_{RI} is the number of allowed |
| | rank indicator values |
| Wide-band CQI | 4 |
| Subband | 2 |
| differential CQI | |
| Indicator of the total | ┌log₂(K₀)┐ if max allowed rank is 1; |
| number of non-zero | ┌log₂(2K₀)┐ otherwise, |
| coefficients summed | K₀ = ┌K₁Mβ┐ , where K₁, M, and β are |
| across all layers | configured or determined by network device (for |
| K^{NZ} | example, given by Clause 5.2.2.2.7 by TS 38.214) |

The values of the rank indicator (RI) field are mapped to allowed rank indicator values with increasing order, where ‘0’ is mapped to the smallest allowed rank indicator value. The values of the K^{NZ} indicator field are mapped to the allowed values of K^{NZ}, according to Clauses 5.2.2.2.7 of TS 38.214, with increasing order, where ‘0’ is mapped to K^{NZ}=1.

In some embodiments, the terminal device may receive, from the network device, at least one configuration for CSI feedback, wherein the at least one configuration may include at least one of
a plurality of CSI-RS resources,
a plurality of antenna ports for one CSI-RS resource,
at least one parameter for antenna port configuration, a configuration for codebook type,
a configuration for reporting type,
at least one parameter for codebook,
the number of physical resource blocks (PRBs) in a bandwidth part (BWP),
the number of a plurality of first subbands,
a size of one first subband,
the number of PRBs of one first subband,
the number of a plurality of second subbands (e.g. represented as N₃),
a size of one second subband,
the number of PRBs of one second subband,
the number of a plurality of time units (e.g. represented as N₄),
a size of one time unit (e.g. represented as Tᵤ or Tᵢ),
the number of slots/subslots/symbols of one time unit (e.g. represented as Tᵤ or Tᵢ),
the number of a plurality of second vectors (e.g. represented as L),
the number of a plurality of first vectors (e.g. represented as Mᵥ),
the number of a plurality of third vectors (e.g. represented as M_{d}),
a first parameter for codebook (e.g. represented as R),
a second parameter for codebook (e.g. represented as pᵥ),
a third parameter for codebook (e.g. represented as β),
a fourth parameter for codebook (e.g. represented as R_{d}),
a fifth parameter for codebook (e.g. represented as p_{v,d}),
a sixth parameter for codebook (e.g. represented as β_{d}) and
a seventh parameter for codebook (e.g. represented as M).

In some embodiments, the number of the plurality of CSI-RS resources may be a positive integer. For example, the number of the plurality of CSI-RS resources may be larger than or equal to 1 and smaller than or equal to 64. In some embodiments, the number of the plurality of antenna ports for one CSI-RS resource may be a positive integer. For example, the number of the plurality of antenna ports for one CSI-RS resource may be one of {1, 2, 4, 8, 12, 16, 24, 32}.

In some embodiments, the terminal device may transmit, to the network device, the number of layers and at least one codebook indicator based on the at least one configuration for CSI feedback. In some embodiments, the at least one codebook indicator may comprise at least one of
one or more indicators for a plurality of first vectors,
one or more indicators for a plurality of second vectors,
one or more indicators for a plurality of third vectors,
a field for a plurality of first amplitude coefficients corresponding to one layer with an index,
a field for a plurality of second amplitude coefficients corresponding to one layer with an index,
a field for a plurality of third amplitude coefficients corresponding to one layer with an index,
a field for a plurality of first phase coefficients corresponding to one layer with the index,
a field for a plurality of second phase coefficients corresponding to one layer with the index,
a field for a plurality of third phase coefficients corresponding to one layer with the index,
a bitmap for indicating nonzero coefficients corresponding to one layer with the index and
an indicator of strongest coefficient corresponding to one layer with the index.

In some embodiments, the bitmap for indicating nonzero coefficients may indicate which coefficients in the field for the plurality of first/second/third amplitude coefficients are nonzero or reported. In some embodiments, the bitmap for indicating nonzero coefficients may indicate which coefficients in the field for the plurality of first/second/third phase coefficients are nonzero or reported.

Below table 4 illustrates an example mapping order of CSI fields of one CSI report, CSI part 2 (defined by information element codebookType=typeII-r16 or typeII-PortSelection-r16)

TABLE 4
One example of mapping order of CSI fields of one CSI report, CSI part 2

| CSI report number | CSI fields |
|---|---|
| CSI report #n | PMI fields X₁, if reported |
| CSI part 2, group 0 | |
| CSI report #n | The following PMI fields X₂, from left to right,: {i_{2,3,l}: l = |
| CSI part 2, group 1 | $1 , … , υ \} , {i}_{1 , 5} , \{ {i}_{1 , 6 , l} : l = 1 , … , υ \} and max ( 0 , ⌈ \frac{{K}^{NZ}}{2} ⌉ - υ ) \times 3$ |
| | $highest priority bits of \{ {i}_{2 , 4 , l} \text{:} l = 1 , … , υ \} , max ( 0 , ⌈ \frac{{K}^{NZ}}{2} ⌉ - υ ) \times 4$ |
| | highest priority bits of |
| | {i_{2,5,l}: l = 1, ... , υ} and ν * 2LM_{υ} − └K^{NZ}/2┘ highest |
| | priority bits of {i_{1,7,l}:l = 1, ... , υ}, in decreasing order of |
| | priority based on the corresponding function Pri(l, i, f) |
| | (for example, defined by clause 5.2.3 of TS38.214), if |
| | reported |
| CSI report #n | The following PMI fields X₂ , from left to right: |
| CSI part 2, group 2 | $min ( {K}^{NZ} - v , ⌊ \frac{{K}^{NZ}}{2} ⌋ ) \times 3 lowest priority bits of$ |
| | $\{ {i}_{2 , 4 , l} \text{:} l = 1 , … , υ \} , min ( {K}^{NZ} - v , ⌊ \frac{{K}^{NZ}}{2} ⌋ ) \times 4 lowest$ |
| | priority bits of {i_{2,5,l}: l = 1, ... , υ} and └K^{NZ}/2┘ lowest |
| | priority bits of {i_{1,7,l}: l = 1, ... , υ}, in decreasing order of |
| | priority based on the corresponding function Pri(l,i, f) |
| | (for example, defined by clause 5.2.3 of TS38.214), if |
| | reported |

Below table 5 illustrates an example mapping order of CSI fields of one CSI report, CSJ part 2 (defined by information element codebookType=typeII-PortSelection-r17).

TABLE 5
Another example of mapping order of CSI fields of one CSI report, CSI part 2

| CSI report number | CSI fields |
|---|---|
| CSI report #n | PMI fields X₁, if reported |
| CSI part 2, group 0 | |
| CSI report #n | The following PMI fields X2, from left to right,: |
| CSI part 2, group 1 | $\{ {i}_{2 , 3 , l} \text{:} l = 1 , … , υ \} ( max ( 0 , ⌈ \frac{{K}^{NZ}}{2} ⌉ - υ ) ) \times 3 highest priority bits of$ |
| | $\{ {i}_{2 , 4 , l} \text{:} l = 1 , … , υ \} , ( max ( 0 , ⌈ \frac{{K}^{NZ}}{2} ⌉ - υ ) ) \times 4 highest$ |
| | priority bits of {i_{2,5,l}: l = 1, ... , υ} and ν * K₁M [− └K^{NZ}/2┘ |
| | highest priority bits of {i_{1,7,l}: l = 1, ... , υ}, in decreasing |
| | order of priority based on the corresponding function |
| | Pri(l, i, f) (for example, defined in clause 5.2.3 of |
| | TS38.214), if reported |
| CSI report #n | The following PMI fields X₂, from left to right, as in Tables |
| CSI part 2, group 2 | $6.3 \text{.2} \text{.1} \text{.2} - 2 B : ( min ( {K}^{NZ} - v , ⌊ \frac{{K}^{NZ}}{2} ⌋ ) ) \times 3 lowest priority$ |
| | $bits of \{ {i}_{2 , 4 , l} \text{:} l = 1 , … , υ \} , ( min ( {K}^{NZ} - ν , ⌊ \frac{{K}^{NZ}}{2} ⌋ ) ) \times 4$ |
| | lowest priority bits of {i_{2,5,l}: l = 1, ... , υ] and └K^{NZ}/2┘ |
| | lowest priority bits of {i_{1,7,l} l = 1, ... , υ}, in decreasing |
| | order of priority based on the corresponding function |
| | Pri(l, i, f) (for example, defined in clause 5.2.3 of |
| | TS38.214), if reported |

As discussed above, in some scenarios, the terminal device may move at a high/medium velocity, which causes that the reported CSI feedback may be not available for future channel prediction. In order to achieve a better future channel prediction for a terminal device with a high/medium velocity, time domain (TD)/doppler domain (DD) information is introduced. By reporting the TD/DD information, the network device may predict the future channel prediction even if the terminal device moves at a high/medium velocity. However, the CSI report defined in release 16 and release 17 does not support reporting a TD/DD information.

In some embodiments, the at least one codebook indicator may comprise at least one of one or more fields for the plurality of first vectors, one or more fields for the plurality of second vectors and one or more fields for the plurality of third vectors. In some embodiments, one field for the plurality of first vectors may correspond to one indicator for the plurality of first vectors. In some embodiments, one field for the plurality of second vectors may correspond to one indicator for the plurality of second vectors. In some embodiments, one field for the plurality of third vectors may correspond to one indicator for the plurality of third vectors.

In some embodiments, each one of the one or more fields for the plurality of first vectors may correspond to one layer with an index. In some embodiments, each one of the one or more fields for the plurality of second vectors may correspond to one layer with an index. In some embodiments, each one of the one or more fields for the plurality of third vectors may correspond to one layer with an index.

In some embodiments, the one or more fields for the plurality of first vectors may correspond to each layer of the number of layers. For example, the one or more fields for the plurality of first vectors may be same for each layer of the number of layers. In some embodiments, the one or more fields for the plurality of second vectors may correspond to each layer of the number of layers. For example, the one or more fields for the plurality of second vectors may be same for each layer of the number of layers. In some embodiments, the one or more fields for the plurality of third vectors may correspond to each layer of the number of layers. For example, the one or more fields for the plurality of third vectors may be same for each layer of the number of layers.

In some embodiments, a plurality of precoding matrices or a plurality of codebooks corresponding to N₃ subbands and/or N₄ time units may be determined based on the at least one codebook indicator.

In some embodiments, the terminal device may be configured with a number of PRBs for a bandwidth part (BWP) or with a size for the BWG. In some embodiments, the number of PRBs for the BWP (e.g. represented as

$${N}_{BWP}^{size} )$$

may be a positive integer. For example, N_{BWP} may be a positive integer. For example,

$$24 \leq {N}_{BWP}^{size} \leq 275 .$$

In some embodiments, the terminal device may be configured with a starting position of the BWP (e.g. represented as

$${N}_{BWP}^{start} ) .$$

For example,

$${N}_{BWP}^{start}$$

may be a non-negative integer. For example,

$$0 \leq {N}_{BWP}^{start} \leq 275 .$$

In some embodiments, the starting position of the BWP and the number of PRBs for the BWP may be configured in one higher layer parameter.

In some embodiments, a first subband may correspond to a subband for CQI or CQI subband or CSI subband. In one specific example embodiment, the first subband corresponds to one time unit.

In some embodiments, the size of one first subband or the number of PRBs of one first subband may be represented as

$${N}_{PRB}^{SB} , and {N}_{PRB}^{SB}$$

is a positive integer. For example,

$$1 \leq {N}_{PRB}^{SB} \leq 32 .$$

For example,

$${N}_{PRB}^{SB}$$

may be one of {4, 8, 16, 32}.

In some embodiments,

$${N}_{PRB}^{SB}$$

may be based on the value of N_{BWP}. In some embodiments, if 24≤N_{BWP}≤72,

$${N}_{PRB}^{SB}$$

may be 4 or 8. For example,

$${N}_{PRB}^{SB}$$

may be configured to be 4 or 8 based on one higher layer parameter for subband. In some embodiments, if 73≤N_{BWP}≤144,

$${N}_{PRB}^{SB}$$

may be 8 or 16. For example,

$${N}_{PRB}^{SB}$$

may be configured to be 8 or 16 based on the higher layer parameter for subband. In some embodiments, if 14≤N_{BWP}≤275,

$${N}_{PRB}^{SB}$$

may be 16 or 32. For example,

$${N}_{PRB}^{SB}$$

may be configured to be 16 or 32 based on the higher layer parameter for subband.

In some embodiments, the at least one parameter for antenna port configuration may comprise at least one of
the number of the plurality of CSI-RS resources,
the number of antenna ports for one CSI-RS resource,
a first plurality of antenna port groups,
the number of the first plurality of antenna port groups,
the number of antenna ports in one antenna port group,
a first parameter of antenna port configuration and a second parameter of antenna port configuration.

In some embodiments, one antenna port group may correspond to a TRP or antenna ports of a TRP. In some embodiments, one antenna port group may correspond to one CSI-RS resource. In some embodiments, the number of antenna ports may be same for each CSI-RS resource in the plurality of CSI-RS resources.

In some embodiments, the at least one configuration may comprise a plurality of antenna ports in one antenna port group or for one CSI-RS resource. In some embodiments, a number of the plurality of antenna ports in one antenna port group or for one CSI-RS resource (e.g. represented as P) may be one of {1, 2, 4, 6, 8, 12, 16, 24, 32}. In some embodiments, the number of antenna ports in each antenna port group or for each CSI-RS resource in the plurality of CSI-RS resources may be same. For example, P may be a positive integer. For example, P may be one of {1, 2, 4, 6, 8, 12, 16, 24, 32}.

In some embodiments, the terminal device may receive at least one of the plurality of CSI-RS resources based on the number of antenna ports for the at least one CSI-RS resource.

In some embodiments, a value of the first parameter of antenna port configuration may be represented as N₁. For example, N₁ may be a positive integer. For example, N₁ may be one of {2, 3, 4, 6, 8, 12, 16}. In some embodiments, a value of the second parameter of antenna port configuration may be represented as N₂. For example, N₂ may be a positive integer. For example, N₂ may be one of {1, 2, 3, 4}. In some embodiments, the first parameter of antenna port configuration and the second parameter of antenna port configuration may be configured in one higher layer parameter.

In some embodiments, the number of antenna ports in one antenna port group or for one CSI-RS resource may be determined based on the first parameter of antenna port configuration and a second parameter of antenna port configuration. In some embodiments, the number of antenna ports in one antenna port group or for one CSI-RS resource may be P=N₁·N₂·2.

In some embodiments, there may be a parameter “O₁”, and “O₁” may represent a first discrete fourier transform (DFT) oversampling in the first dimension. For example, “O₁” may be one of {1, 2, 4}. For another example, “01” may be 2 or 4. In some embodiments, there may be a parameter “02”, and “02” may represent a second DFT oversampling in the second dimension. For example, “O₂” may be one of {1, 2, 4}. For another example, “O₂” may be 2 or 4.

In some embodiments, one configuration of (N₁,N₂) may correspond to one configuration of (O₁, O₂). In some embodiments, one configuration of (O₁, O₂) may correspond to one configuration of (N₁, N₂).

In some embodiments, the example configurations of (N₁, N₂) and (O₁, O₂) and/or P may be at least one of row and/or column in the following Table 6.

TABLE 6
example configurations

| P | (N₁, N₂) | (O₁, O₂) |
|---|---|---|
| 4 | (2, 1) | (4, 1) |
| 8 | (2, 2) | (4, 4) |
| 8 | (4, 1) | (4, 1) |
| 12 | (3, 2) | (4, 4) |
| 12 | (6, 1) | (4, 1) |
| 16 | (4, 2) | (4, 4) |
| 16 | (8, 1) | (4, 1) |
| 24 | (4, 3) | (4, 4) |
| 24 | (6, 2) | (4, 4) |
| 24 | (12, 1) | (4, 1) |
| 32 | (4, 4) | (4, 4) |
| 32 | (8, 2) | (4, 4) |
| 32 | (16, 1) | (4, 1) |

In some embodiments, there may be a vector uₘ. In some embodiments, uₘ, may be a DFT vector. In some embodiments, if N₂>1,

$${u}_{m} = [ 1 , {e}^{j \frac{2 π m}{{O}_{2} {N}_{2}}} , … , {e}^{j \frac{2 π m ( {N}_{2} - 1 )}{{O}_{2} {N}_{2}}} ] .$$

In some embodiments, if N₂=2,

$${u}_{m} = [ 1 , {e}^{j \frac{2 π}{{O}_{2} {N}_{2}}} ] .$$

In some embodiments, the length of the vector uₘ, may be N₂. In some embodiments, the size of the vector uₘ, may be (N₂)*1 1*(N₂). In some embodiments, if N₂=1, uₘ=1. In some embodiments, m may be the index of the vector uₘ. In some embodiments, m may be a non-negative integer. For example, 0≤m≤O₂N₂−1.

In some embodiments, there may be a vector v_{l,m}. In some embodiments,

$${v}_{l , m} = {[ {u}_{m} , {u}_{m} * {e}^{j \frac{2 π l}{{O}_{1} {N}_{1}}} , … , {u}_{m} * {e}^{j \frac{2 π l ( {N}_{1} - 1 )}{{O}_{1} {N}_{1}}} ]}^{T} .$$

In some embodiments, l may be the index of the vector v_{i,m}. In some embodiments, the length of the vector v_{l,m} may be N₁*N₂ or P/2. In some embodiments, the size of the vector v_{l,m}, may be (N₁*N₂)*1 or (P/2)*1 or 1*(N₁*N₂) or 1*(P/2).

In some embodiments, if N₁=2 and N₂=2,

$${v}_{l , m} = {[ 1 , {e}^{j \frac{2 π m}{{O}_{2} {N}_{2}}} , {e}^{j \frac{2 π}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, if N₁=4 and N₂=1,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, l may be a non-negative integer. For example, 0≤l≤O₁N₁−1. In some embodiments, [ ]^{T} may represent a transposition of a vector or a matrix.

In some embodiments, the terminal device may determine or report a number of layers and at least one codebook indicator based on the at least one configuration to the network device. In some embodiments, the number of layers (e.g. represented as vᵣᵢ) may be one of {1, 2} or {1, 2, 3, 4} or {1, 2, 3, 4, 5, 6, 7, 8}. In some embodiments, there may be a plurality of layers, and each layer may be with an index, wherein the index of a layer may be represented as r, r may be non-negative integer. For example, 1≤r≤vᵣᵢ. For example, r may be one of {1, 2, . . . vᵣᵢ} or {1, 2} or {1, 2, 3, 4} or {1, 2, 3, 4, 5, 6, 7, 8}.

In some embodiments, the at least one codebook indicator may comprise at least one is of
one or more indicators (or a field) for a plurality of first vectors,
one or more indicators (or one or more fields) for a plurality of second vectors, one or more indicators (or a field) for a first plurality of rotations for the plurality of second vectors,
one or more indicators (or a field) for a plurality of third vectors, one or more indicators (or one or more fields) for a second plurality of rotations for the plurality of third vectors, one or more indicators (or one or more fields) for a strongest coefficient,
one or more indicators (or a field) for a plurality of first amplitude coefficients,
one or more indicators (or one or more fields) for a plurality of second amplitude coefficients,
one or more indicators (or one or more fields) for a plurality of phase coefficients, a first number of nonzero coefficients, or
one or more indicators (or one or more bitmaps) for indicating nonzero coefficients.

In some embodiments, the one or more indicators (or one or more bitmaps) for indicating nonzero coefficients may indicate indexes of second amplitude coefficients and/or indicating indexes of phase coefficients, and values of the second amplitude coefficients corresponding to the indexes and/or the values of the phase coefficients corresponding to the indexes may be nonzero.

Alternatively, in some embodiments, the one or more indicators (or one or more bitmaps) for indicating nonzero coefficients may indicate which coefficients in the one or more indications or in the field for the plurality of second amplitude coefficients are nonzero or reported.

Alternatively, in some embodiments, the one or more indicators (or one or more bitmaps) for indicating nonzero coefficients may indicate which coefficients in the one or more indications or in the field for the plurality of phase coefficients are nonzero or reported.

In some embodiments, one or more of the at least one codebook indicator or field may be same or applied for each layer of the number of layers, for example, layer common. In some embodiments, each one of the one or more of the at least one codebook indicator or field may correspond to one layer with an index, for example, layer specific.

In some embodiments, the one or more indicators (or the one or more fields) for the plurality of first vectors may be same or applied for each layer of the number of layers, for example, layer common. In some embodiments, the one or more indicators (or the field) for the plurality of first vectors may correspond to one layer with an index, for example, layer specific.

In some embodiments, the one or more indicators (or the one or more fields) for the plurality of second vectors may be same or applied for each layer of the number of layers, for example, layer common. In some embodiments, the one or more indicators (or the one or more fields) for the plurality of second vectors may correspond to one layer with an index, for example, layer specific.

In some embodiments, the one or more indicators (or the one or more fields) for the first plurality of rotations for the plurality of second vectors may be same or applied for each layer of the number of layers, f or example, layer common. In some embodiments, the one or more indicators (or the field) for the first plurality of rotations for the plurality of second vectors may correspond to one layer with an index, f or example, layer specific.

In some embodiments, the one or more indicators (or the one or more fields) for the second plurality of rotations for the plurality of third vectors may be same or applied for each layer of the number of layers, f or example, layer common. In some embodiments, the one or more indicators (or the one or more fields) for the second plurality of rotations for the plurality of third vectors may correspond to one layer with an index, f or example, layer specific.

In some embodiments, the one or more indicators (or the one or more fields) for the plurality of third vectors may be same or applied for each layer of the number of layers, f or example, layer common. In some embodiments, the one or more indicators (or the one or more fields) for the plurality of third vectors may correspond to one layer with an index, f or example, layer specific.

In some embodiments, the indicator (or the field) for the strongest coefficient may be same or applied for each layer of the number of layers, f or example, layer common. In some embodiments, the indicator (or the field) for the strongest coefficient may correspond to one layer with an index, f or example, layer specific.

In some embodiments, the one or more indicators (or the one or more fields) for the plurality of first amplitude coefficients may be same or applied for each layer of the number of layers, f or example, layer common. In some embodiments, the one or more indicators (or the one or more fields) for the plurality of first amplitude coefficients may correspond to one layer with an index, f or example, layer specific.

In some embodiments, the one or more indicators (or the one or more fields) for the plurality of phase coefficients may be same or applied for each layer of the number of layers, f or example, layer common. In some embodiments, the one or more indicators (or the one or more fields) for the plurality of phase coefficients may correspond to one layer with an index, f or example, layer specific.

In some embodiments, the one or more indicators (or the one or more fields) for the plurality of second amplitude coefficients may be same or applied for each layer of the number of layers, f or example, layer common. In some embodiments, the one or more indicators (or the one or more fields) for the plurality of second amplitude coefficients may correspond to one layer with an index, f or example, layer specific.

In some embodiments, the one or more indicators (or the one or more fields) for indicating nonzero coefficients may be same or applied for each layer of the number of layers, for example, layer common. In some embodiments, the one or more indicators (or the field) for indicating nonzero coefficients may correspond to one layer with an index, f or example, layer specific.

In some embodiments, the first number of nonzero coefficients may be same or applied for each layer of the number of layers, f or example, layer common. In some embodiments, the first number of nonzero coefficients may correspond to one layer with an index, f or example, layer specific.

In some embodiments, the number of the plurality of second vectors, the second parameter for codebook and the third parameter for codebook may be configured or indicated in one higher layer parameter. In some embodiments, the fifth parameter for codebook and the sixth parameter for codebook may be configured or indicated in one higher layer parameter.

In some embodiments, the second parameter for codebook may be one of {½, ¼, ⅛}. In some embodiments, the third parameter for codebook may be one of {¼, ½, ¾}.

In some embodiments, the number of the plurality of second vectors (e.g. represented as L) may be one of {2, 4, 6} or at least {2,4,6,8} or at least one of{2, 4, 6, 8, 12, 16, 24, 32}. In some embodiments, L may be a positive integer. In some embodiments, L may be one of {2, 4, 6} or one of {2,4,6,8} or one of {2, 4, 6, 8, 12, 16, 24, 32}.

In some embodiments, the third parameter for codebook may further be based on number of layers. In some embodiments, one higher layer parameter may indicate L=2 and β=¼, and if number of layers is 1 or 2, pᵥ=¼, and if number of layers is 3 or 4, pᵥ=⅛.

Alternatively, in some embodiments, one higher layer parameter may indicate L=2 and β=½, and if number of layers is 1 or 2, pᵥ=¼, and if number of layers is 3 or 4, pᵥ=⅛.

Alternatively, in some embodiments, one higher layer parameter may indicate L=4 and β=¼, and if number of layers is 1 or 2, pᵥ=¼, and if number of layers is 3 or 4, pᵥ=⅛.

Alternatively, in some embodiments, one higher layer parameter may indicate L=4 and β=½, and if number of layers is 1 or 2, pᵥ=¼, and if number of layers is 3 or 4, pᵥ=⅛.

Alternatively, in some embodiments, one higher layer parameter may indicate L=4 and β=¾, and pᵥ=¼.

Alternatively, in some embodiments, one higher layer parameter may indicate L=4 and β=½, and if number of layers is 1 or 2, pᵥ=½, and if number of layers is 3 or 4, pᵥ=¼.

Alternatively, in some embodiments, one higher layer parameter may indicate L=6 and β=½, and pᵥ=¼. For example, the number of layers is 1 or 2. In some embodiments, one higher layer parameter may indicate L=6 and β=¾, and pᵥ=¼. For example, the number of layers is 1 or 2.

In some embodiments, the first parameter for codebook (for example, represented as R) may be a positive integer. For example, R may be a positive integer. For example, R may be one of {1, 2}. In some embodiments, a number of precoding matrices may be determined based on the first parameter for codebook, the number of the plurality of first subbands. In some embodiments, the first parameter for codebook may control the total number of precoding matrices indicated by the PMI as a function of the number of configured first subbands or the number of the plurality of first subbands, the size of one first subband and of the number of PRBs for the BWP.

In some embodiments, second subband may correspond to a subband for precoding matrix indicator (PMI) or PMI subband.

In some embodiments, the size of one second subband or the number of PRBs of one second subband may be represented as N_{PMI}, and N_{PMI} is a positive integer. For example, 1≤N_{PMI}≤32. For example, N_{PMI} may be one of {2, 4, 8, 16, 32}. In some embodiments, N_{PMI} may be based on

$${N}_{PRB}^{SB}$$

and R. For example,

$${N}_{PMI} = {N}_{PRB}^{SB} / R .$$

In some embodiments, the number of the plurality of second subbands N₃ or the size or the length of one first vector may be a positive integer. For example, 9≤N₃≤36 For example,

$${N}_{3} = R * {N}_{BWP}^{size} / {N}_{PRB}^{SB} .$$

. For another example,

$${N}_{3} = R * ⌊ {N}_{BWP}^{size} / {N}_{PRB}^{SB} ⌋ .$$

For another example,

$${N}_{3} = R * ⌈ {N}_{BWP}^{size} / {N}_{PRB}^{SB} ⌉ .$$

For another example,

$${N}_{3} = R * ⌊ {N}_{BWP}^{size} / {N}_{PRB}^{SB} ⌋ + 1.$$

For another example,

$${N}_{3} = R * ⌊ {N}_{BWP}^{size} / {N}_{PRB}^{SB} ⌋ + 2.$$

For another example,

$${N}_{3} = R * ⌊ {N}_{BWP}^{size} / {N}_{PRB}^{SB} ⌋ + 3.$$

For another example,

$${N}_{3} = R * ⌊ {N}_{BWP}^{size} / {N}_{PRB}^{SB} ⌋ + 4.$$

In some embodiments, when R=1, there may be one precoding matrix indicated for each first subband. In some embodiments, when R=2, for one first subband that is not the first/beginning one or the last/ending one of the plurality of first subbands in the BWP, there may be two precoding matrixes indicated for the one of the plurality of first subbands. For example, the first precoding matrix corresponds to the first

$${N}_{PRB}^{SB} / 2 PRBs$$

of the one of the plurality of first subbands, and the second precoding matrix corresponds to the last

$${N}_{PRB}^{SB} / 2 PRBs$$

of the one of the plurality of first subbands.

In some embodiments, when R=2, for one first subband that is the first/beginning one or the last/ending one of the plurality of first subbands in the BWP, if

$$( {N}_{BWP}^{start} mod {N}_{PRB}^{SB} ) \geq \frac{{N}_{PRB}^{SB}}{2} ,$$

there may be one precoding matrix indicated corresponding to the first/beginning one of the plurality of first subbands.

In some embodiments, when R=2, for one first subband that is the first/beginning one or the last/ending one of the plurality of first subbands in the BWP, if

$$( {N}_{BWP}^{start} mod {N}_{PRB}^{SB} ) < \frac{{N}_{PRB}^{SB}}{2} ,$$

there may be two precoding matrices indicated corresponding to the first/beginning one of the plurality of first subbands. For example, the first precoding matrix may correspond to the first

$$\frac{{N}_{PRB}^{SB}}{2} - ( ( {N}_{BWP}^{start} mod {N}_{PRB}^{SB} ) PRBs$$

of the first/beginning one of the plurality of first subbands and the second precoding matrix corresponds to the last

$$\frac{{N}_{PRB}^{SB}}{2} PRBs$$

of the first/beginning one of the plurality of first subbands. In some embodiments, when R=2, for one first subband that is the first/beginning one or the last/ending one of the plurality of first subbands in the BWP, if

$$1 + ( {N}_{BWP}^{start} + {N}_{BWP}^{size} - 1 ) mod {N}_{PRB}^{SB} \leq \frac{{N}_{PRB}^{SB}}{2} ,$$

there may be one precoding matrix indicated corresponding to the last/ending one of the plurality of first subbands.

In some embodiments, when R=2, for one first subband that is the first/beginning one or the last/ending one of the plurality of first subbands, if

$$1 + ( {N}_{BWP}^{start} + {N}_{BWP}^{size} - 1 ) mod {N}_{PRB}^{SB} > \frac{{N}_{PRB}^{SB}}{2} ,$$

there may be two precoding matrices indicated corresponding to the last/ending one of the plurality of first subbands. For example, the first precoding matrix may correspond to the first

$$\frac{{N}_{PRB}^{SB}}{2} PRBs$$

of the last/ending one of the plurality of first subbands and the second precoding matrix may correspond to the last

$$1 + ( {N}_{BWP , i}^{start} + {N}_{BWP , i}^{size} - 1 ) mod {N}_{PRB}^{SB} - \frac{{N}_{PRB}^{SB}}{2} PRBs$$

of the last/ending one of the plurality of first subbands.

In some embodiments, the number of the plurality of first vectors Mᵥ may be a positive integer. For example,

$${M}_{υ} = ⌈ {p}_{υ} \frac{{N}_{3}}{R} ⌉ .$$

For example, Mᵥ may be one of {1, 2, 3, 4, 5, 6, 7, 8, 9, 10}.

In some embodiments, nchoosek may be a function to choose k values from n values. In some embodiments, nchoosek(a,b)=a!/(b!*(a−b)!). In some embodiments, “!” may be factorial. In some embodiments, a!=1*2* . . . *(a−1)*a.

In some embodiments, the at least one codebook indicator may be comprised in a PMI or in a CST. In some embodiments, the PMI or the CSI may comprise a first part of the PMI (or the CSI) and a second part of the PMI (or the CSI). For example, the size of the second part of the PMI (or the CSI) may be based on the first part of the PMI (or the CSI). In some embodiments, the PMI (or the CSI) may comprise a first part of the PMI (or the CSI), a second part of the PMI (or the CSI) and a third part of the PMI (or the CSI). For example, the size of the second part of the PMI (or the CSI) may be based on the first part of the PMI (or the CSI). For another example, the size of the third part of the PMI (or the CSI) may be based on at least one of the first part of the PMI (or the CSI) and the second part of the PMI (or the CSI).

In some embodiments, the length of one second vector may be based on the number of antenna ports in one antenna port group or for one CSI-RS resource. In some embodiments, the length of one second vector may be the number of the plurality of antenna ports in one antenna port group or for one CSI-RS resource and divided by 2. In some embodiments, the length of one second vector may be P/2. For example, P may be one of {4, 8, 12, 16, 24, 32}.

In some embodiments, the number of indicators (or the fields) for the strongest coefficient may be based on the number of layers, and each one indicator (or the field) for the strongest coefficient corresponds to a layer with an index.

In some embodiments, the indicator (or the field) for the strongest coefficient corresponds to a layer with an index or the bit size (or bitwidth) of indicator (or the field) for the strongest coefficient corresponds to a layer with an index may be based on at least one of: a value of 2; the first number of nonzero coefficients corresponding to one layer with an index; the number of the plurality of second vectors.

In some embodiments, the bit size of the indicator (or the field) for the strongest coefficient corresponds to a layer with an index may be based on at least one of: the first number of nonzero coefficients corresponding to one layer with the index; 2 multiplies the number of the plurality of second vectors.

In some embodiments, the indicator (or the field) for the strongest coefficient corresponds to a layer with an index may be comprised in the PMI (or the CSI) or in the first part of the PMI (or the CSI) or in the second part of the PMI (or the CSI).

In some embodiments, Kb₂ may be the bit size for each of the phase coefficients. For example, K_{b2} may be 2 or 3 or 4 bits.

In some embodiments, the one or more indicators (or one or more bitmaps) for indicating nonzero coefficients may indicate indexes of second amplitude coefficients and/or indexes of phase coefficients. In some embodiments, each bit or codepoint of the indicator (or bitmap) may indicate whether the second amplitude coefficient and/or the phase coefficient corresponding to a layer with an index, corresponding to a second vector (or a beam) with an index and corresponding to a first vector with an index and corresponding to a third vector with an index is reported or not (or the value is 0 or not).

In some embodiments, a value of each bit is either 0 or 1. For example, 0 may indicate the second amplitude coefficient and/or the phase coefficient corresponding to the layer with an index, corresponding to a second vector (or a beam) with the index and corresponding to the first vector with an index and corresponding to the third vector with an index is not reported (or the value is 0). For example, 1 may indicate the second amplitude coefficient and/or the phase coefficient corresponding to the layer with an index, corresponding to a second vector (or a beam) with the index and corresponding to the first vector with an index and corresponding to the third vector with an index is reported (or the value is not 0).

In some embodiments, the number of the one or more indicators (or one or more bitmaps) for indicating nonzero coefficients may be same as the number of layers. For example, each one indicator (or one bitmap) for indicating nonzero coefficients may correspond to one layer with an index.

In some embodiments, the size of the indicator (or the bitmap) for indicating nonzero coefficients corresponding to the layer with an index may be based on the number of the plurality of first vectors corresponding to the layer with an index, the number of the plurality of second vectors and the number of the plurality of third vectors corresponding to the layer with the index.

In some embodiments, the number of the plurality of first vectors may be determined based on at least one of: the number of layers; the size of one first subband; the first parameter for codebook; the size of one second subband; the third parameter for codebook; and the second parameter for codebook.

In some embodiments, a number of the one or more indicators (or the one or more bitmaps) for indicating nonzero coefficients may be based on the number of layers. In some embodiments, each one of the one or more indicators (or the one or more bitmaps) for indicating nonzero coefficients may correspond to a layer with an index.

In some embodiments, the number of one or more indicators (or the one or more fields) for the plurality of second amplitude coefficients corresponding to a layer with an index may be based on at least one of: the first number of nonzero coefficients; a number of values (or bits or codepoints) with value “1” or a number of ones in the indicator (or bitmap) for indicating nonzero coefficients corresponding to the layer with the index.

In some embodiments, the number of one or more indicators (or the one or more fields) for the plurality of phase coefficients corresponding to a layer with an index may be is based on at least one of: the first number of nonzero coefficients; a number of values (or bits or codepoints) with value “1” or a number of ones in the indicator (or bitmap) for indicating nonzero coefficients corresponding to the layer with the index.

In some embodiments, the number of the plurality of first vectors Mᵥ may be determined based on at least one of: the number of PRBs for the BWP; the number of layers; the size of one first subband; the number of the plurality of first subbands; the first parameter for codebook the size of one second subband; the number of the plurality of second subbands; and the second parameter for codebook. In some embodiments, the second parameter for codebook may be determined based on the number of layers.

In some embodiments, a size or a length of one first vector may be determined based on at least one of: the number of PRBs for the BWP; the number of layers; the size of one first subband; the number of the plurality of first subbands; the first parameter for codebook; the size of one second subband; the number of the plurality of second subbands; and the second parameter for codebook. In some embodiments, the size or the length of one first vector may be N₃.

In some embodiments, the number of the plurality of third vectors M_{d} may be determined based on at least one of: a number of time units, the number of layers, the size of one time unit, the number of slots/subslots/symbols for one time unit, the time interval between two time units, the fourth parameter for codebook, the fifth parameter for codebook and the sixth parameter for codebook.

In some embodiments, the number of the plurality of third vectors M_{d} may be configured by the network device 210. In some embodiments, the number of the plurality of third vectors M_{d} may be reported by the terminal device 220.

In some embodiments, the number of the plurality of fourth vectors M_{d} may be a positive integer. For example,

$${M}_{d} = ⌈ {p}_{v , d} \frac{{N}_{4}}{{R}_{d}} ⌉ .$$

F or example, M_{d} may be one of {1, 2, 3, 4, 5, 6, 7, 8, 9, 10}.

In some embodiments, a size or a length of one third vector may be determined based on at least one of: the number of time units, the number of layers, the size of one time unit, the number of slots/subslots/symbols for one time unit, the time interval between two time units, the fourth parameter for codebook, the fifth parameter for codebook and the sixth parameter for codebook. In some embodiments, the size or the length of one third vector may be N₄.

In some embodiments, the fourth parameter for codebook R_{d} may be one of {⅛, ¼, ½, 1, 2}.

In some embodiments, the size or the length of one third vector may be a positive integer. For example, 1≤N₄≤256.

In some embodiments, the terminal device may receive at least one CSI-RS, wherein the number of antenna ports for the at least one CSI-RS may be determined based on the at least one parameter for antenna port configuration.

In some embodiments, the second vector may be a vector in spatial domain. In some embodiments, the second vector may be represented as v_{l,m}. In some embodiments, the second vector may be a vector in frequency domain. In some embodiments, the second vector may be a DFT vector. In some embodiments, the third vector may be a vector in Doppler domain or in time domain. In some embodiments, the third vector may be a DFT vector or a Discrete Cosine Transformation (DCT) vector or a Slepian vector or an oversampled/rotated DFT vector or a vector with only one element of value 1, and other elements with value 0 or a identity vector.

In some embodiments, a plurality of precoding matrices or a plurality of codebooks corresponding to N₃ subbands and/or N₄ time units may be determined from L+Mᵥ vectors or L+Mᵥ+M_{d} vectors.

In some embodiments, the length of one second vector may be based on the number of the plurality of antenna ports in one CSI-RS resource divided by 2.

In some embodiments, the length of one first vector may be determined based on a first parameter for codebook and a number of first subbands. In some embodiments, the number of the plurality of first vectors may be determined based on a third parameter for codebook, a number of second subbands and the first parameter for codebook. In some embodiments, the number of second subbands may be based on the first parameter for codebook and the number of first subbands. In some embodiments, a second size of one second subband may be determined based on the first parameter for codebook and a first size of one first subband.

Embodiments of the present disclosure provide a solution for configuring and transmitting the CSI feedback. In the present solution, CSI feedback comprises a plurality of partitions with different omission priorities, and the parameters reported by the CSI feedback are associated with a plurality of first vectors, a plurality of second vectors, and a plurality of third vectors. By associating the parameters with three types of vectors, the TD/DD information may be reported together with the spatial domain (SD) information and frequency domain (FD) information. Moreover, these parameters are included in different partitions with different omission priorities, which ensure that the network device may at least predict the future channel prediction for at least one beam, such that the communication between the network device and the terminal device may not be suspended.

For ease of discussion, some terms used in the following description are listed as below:
An omission priority: a priority for controlling dropping or omitting. Specifically, different partitions/information groups in the CSI feedback may be configured/associated with different omission priorities. For example, in case that the transmission resource is insufficient or the code rate for the transmission is larger than or equal to a threshold, the partition(s)/information group(s) (including the related parameters) with lower level of omission priority(ies) would be dropped or omitted first.
A first vector, refers to a specific vector, which may be an FD basis, a SD basis or a DD/TD basis. Further, the first vector may correspond to the strongest coefficient, the strongest amplitude coefficient or the maximum power.
A primary first vector, refers to the first FD basis.
A first set of FD bases: refers to a set of FD bases including the first FD basis;
A second set of FD bases: refers to a set of FD bases different from the first set of FD bases.
A subset of FD bases: refers to a subset of FD bases with the first FD basis excluded.
A primary first vector, refers to the first SD basis.
A first set of SD bases: refers to a set of SD bases including the first SD basis;
A second set of SD bases: refers to a set of SD bases different from the first set of SD bases.
A subset of SD bases: refers to a subset of SD bases with the first SD basis excluded.
A primary first vector, refers to the first DD/TD basis.
A first set of DD/TD bases: refers to a set of DD/TD bases including the first DD/TD basis;
A second set of DD/TD bases: refers to a set of DD/TD bases different from the first set of DD/TD bases.
A subset of DD/TD bases: refers to a subset of DD/TD bases with the first DD/TD basis excluded.
The plurality of first vectors/FD bases: refers to all the FD bases;
The plurality of second vectors/SD bases: refers to all the SD bases;
The plurality of third vectors/DD bases/TD bases: refers to all the DD/TD bases.

In the context of the present application, the terms “vector”, “beam”, “bases” and “basis” can be used interchangeably.

The terms “first vector”, “first bases”, “frequency domain/FD basis vectors”, “frequency domain/FD vectors”, “frequency domain/FD basis”, “frequency domain/FD bases” and “first basis” can be used interchangeably.

The terms “second vector”, “second beam”, “beam”, “second bases”, “spatial domain/SD basis vectors”, “spatial domain/SD vectors”, “spatial domain/SD basis”, “spatial domain/SD bases” and “second basis” can be used interchangeably.

The terms “third vector”, “third bases”, “doppler/time domain basis vectors”, “doppler/time domain vectors”, “doppler/time domain basis”, “doppler/time domain bases”, “DD/TD basis vectors”, “DD/TD vectors”, “DD/TD basis”, “doppler/time domain bases”, “DD/TD vectors” and “third basis” can be used interchangeably.

The terms “time unit”, “doppler unit”, “a unit in time domain”, “a unit in doppler domain”, “time point” and “a unit for the third vector” can be used interchangeably.

In the context of the present application, the terms “transmission occasions”, “reception occasions”, “repetitions”, “transmission”, “reception”, “physical downlink shared channel (PDSCH) transmission occasions”, “PDSCH repetitions”, “physical uplink shared channel (PUSCH) transmission occasions”, “PUSCH repetitions”, “physical uplink control channel (PUCCH) occasions”, “PUCCH repetitions”, “repeated transmissions”, “repeated receptions”, “PDSCH transmissions”, “PDSCH receptions”, “PUSCH transmissions”, “PUSCH receptions”, “PUCCH transmissions”, “PUCCH receptions”, “RS transmission”, “RS reception”, “communication”, “transmissions” and “receptions” can be used interchangeably.

In the context of the present application, the terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably.

The terms “precoding matrix”, “precoding”, “beam”, “beamforming” and “precoder” may be used interchangeably.

In the context of the present application, the terms “single TRP”, “single TCI state”, “single TCI”, “S-TCI”, “single CORESET”, “single control resource set pool”, “S-TRP” and “S-TCI state” can be used interchangeably.

The terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably.

In the context of the present application, the terms “pool”, “set”, “subset”, “group”, “unit” and “subgroup” can be used interchangeably.

In the context of the present application, the terms “index”, “indicator”, “indication”, “field”, “bit field” and “bitmap” can be used interchangeably. The terms “physical resource block”, “resource block”, “PRB” and “RB” can be used interchangeably. The terms “bit size”, “size of bits”, “number of bits”, “size of field” and “field size” can be used interchangeably.

In the context of the present application, the terms “element of indication field”, “parameter”, “indication” can be used interchangeably.

Principles and implementations of the present disclosure will be described in detail below with reference to the figures.

### Example of Communication Network

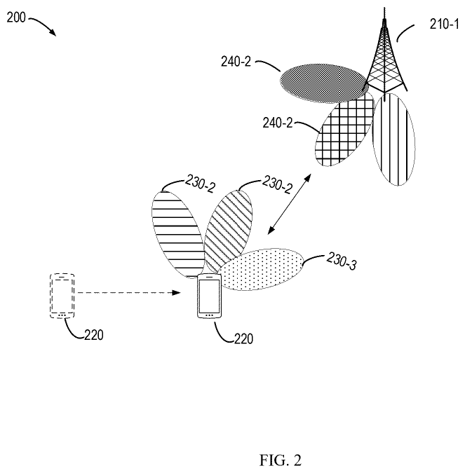

FIG. 2 shows an example communication environment 200 in which example embodiments of the present disclosure can be implemented.

The communication environment 200 includes a network device 210 and a terminal device 220, and further the network device 210 can communicate with the terminal device 220 via physical communication channels or links. Additionally, the network device 210 may provide more than one serving area.

In the specific example of communication environment 200, a link from the terminal device 220 to the network device 210 is referred to as uplink, while a link from the network device 210 to the terminal device 220 is referred to as a downlink. Further, MIMO is supported in the communication environment 200, such that the network device 210 and the terminal device 220 may communicate with each other via different beams to enable a directional communication. In downlink, the network device 210 is a transmitting (TX) device (or a transmitter) and the terminal device 220 is a receiving (RX) device (or a receiver), and the network device 210 may transmit downlink transmission to the terminal device 220 via one or more beams. As illustrated in FIG. 2, the network device 210 transmits downlink transmission to the terminal device 220 via the beams 240-1 to 240-3.

Correspondingly, in uplink, the network device 210 is a RX device (or a receiver) and the terminal device 220 is a TX device (or a transmitter), and the terminal device 220 may transmit uplink transmission to the network device 210 via one or more beams. As illustrated in FIG. 2, the terminal device 220 transmits uplink transmission to the network device 210 via the beams 230-1 to 230-3. For purpose of discussion, the beams 230-1 to 230-3 or beams 240-1 to 240-3 are collectively or individually referred to as beam 230 or beam 240, respectively.

In some embodiments, the network device 210-1 may transmit configuration(s) for CSI feedback to the terminal device 220, and the terminal device 220 also may transmit the CSI feedback to the network device 210. In some embodiments, the CSI feedback is transmitted on PUSCH. Alternatively, in some other embodiments, the CSI feedback is transmitted on PUCCH.

In the specific example of FIG. 2, the terminal device 220 may be under a high/medium velocity movement when transmitting the feedback. Further, the terminal device 220 is configured with DD/TD basis reporting for CSI/PMI reporting, or the TD/DD compression is applied for codebook.

It is to be understood that the number of devices and their connections in FIG. 2 are given for the purpose of illustration without suggesting any limitations to the present disclosure. The communication environment 200 may include any suitable number of network devices and/or terminal devices adapted for implementing implementations of the present disclosure.

In some embodiments, the terminal device 220 and the network device 210 may communicate with each other via a channel such as a wireless communication channel on an air interface (e.g., Uu interface). The wireless communication channel may comprise a PUCCH, a PUSCH, a physical random-access channel (PRACH), a physical downlink control channel (PDCCH), a PDSCH and a physical broadcast channel (PBCH). Of course, any other suitable channels are also feasible.

The communications in the communication environment 200 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

### Example of Processes

It should be understood that although feature(s)/operation(s) are discussed in specific example embodiments separately, unless clearly indicated to the contrary, these feature(s)/operation(s) described in different example embodiments may be used in any suitable combination.

In addition, in the following description, some interactions are performed among the terminal device 220 and the network device 210 (such as, exchanging configuration (s) and so on). It is to be understood that the interactions may be implemented either in one single signaling/message or multiple signaling/messages, including system information, radio resource control (RRC) message, downlink control information (DCI) message, uplink control information (UCI) message, media access control (MAC) control element (CE) and so on. The present disclosure is not limited in this regard.

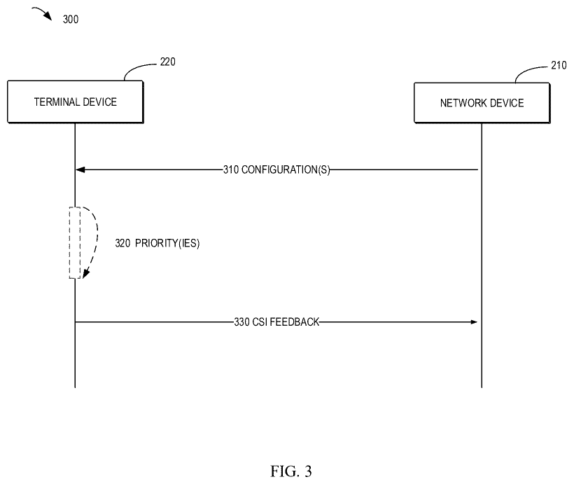

Principle and implementations of the present disclosure will be described in detail below with reference to FIG. 3, which shows a signaling chart illustrating a process 300 of communication according to some example embodiments of the present disclosure. For the purpose of discussion, the process 300 will be described with reference to FIG. 2. The process 300 may involve the terminal device 220 and the network device 210.

As discussed above, in some scenarios, the terminal device may move at a high/medium velocity, which causes that the reported CSI feedback may be not available for future channel prediction. In order to achieve a better future channel prediction for a terminal device 220 with a high/medium velocity, TD/DD information is introduced. By reporting the TD/DD information, the network device 210 may predict the future channel prediction even if the terminal device 220 moves at a high/medium velocity.

In some embodiments, a CSI feedback may comprise CSI-RS Resource Indicator (CRI), RI, PMI, CQI and Layer Indicator (LI). The RI is calculated conditioned on CRI. The PMI is calculated conditioned on RI and CRI. The CQI is calculated conditioned on PMI, RI and CRI. The L1 is calculated conditioned on CQI, PMI, RI and CRI. As mentioned above, for handling the high/medium velocity movement of the terminal device 220, the CSI feedback comprises CQI conditioned on a PMI corresponding to a time unit that is not earlier than the time duration 210. The time unit may comprise one or more slots and the time unit may be different from time duration or have the same time length as the time duration.

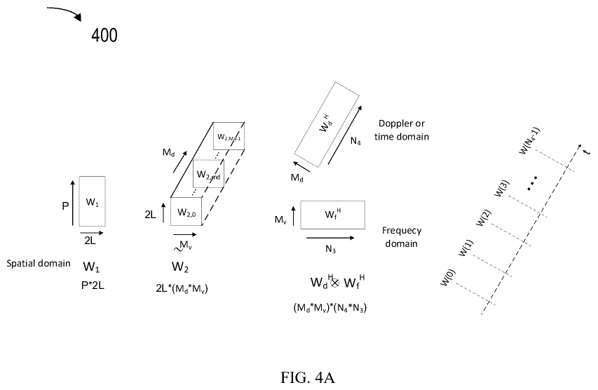

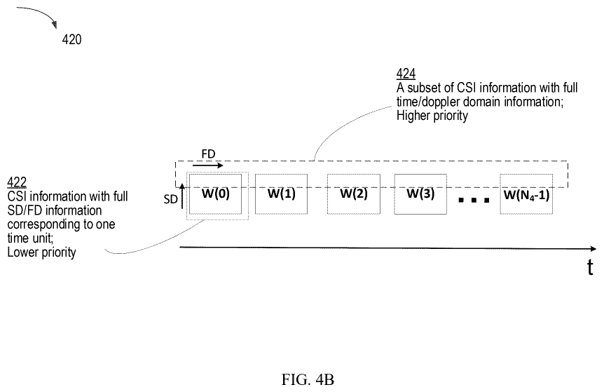

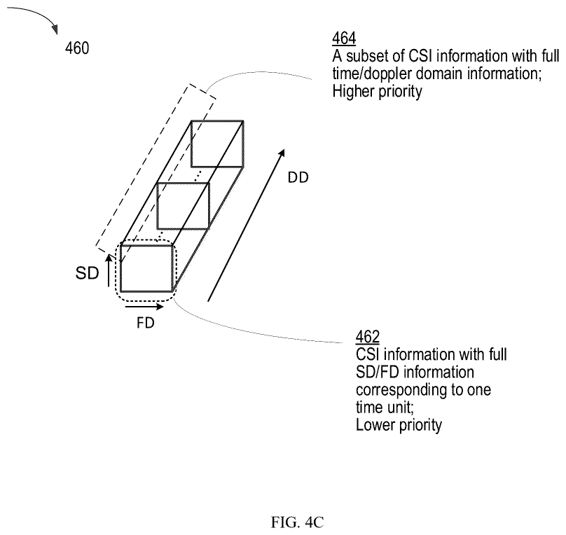

FIG. 4A illustrates a schematic diagram 400 of spatial domain, frequency domain and doppler/time domain basis. As illustrated in FIG. 4A, in a plurality of codebooks or precoding matrices which comprises spatial domain, frequency domain and DD/TD vectors. As illustrated in FIG. 4A, in the spatial domain, a first matrix (for example, composed by SD basis or the plurality of second vectors) W₁ has a dimension of P*2L, where P denotes the number of antenna ports for a CSI-RS resource or of an antenna port group, and L denotes the number of beams or second vectors (for example, in each polarization group consisting of two polarization directions.

In the frequency domain a third matrix (for example, composed by FD basis or the plurality of first vectors)

$${W}_{f}^{H}$$

has a dimension of M_{d}*N₃, where N₃ denotes the number of frequency unit or the number of second subbands. For example, N₃ can be understood as the number of subbands in the frequency domain. Mᵥ is the number of FD bases or the first vectors. In the doppler/time domain, a fourth matrix (for example composed by doppler/time domain basis or the plurality of third vectors)

$${W}_{d}^{H}$$

has a dimension of M_{d}*N₄ where N₄ denotes the number of doppler/time unit, and M_{d} is the number of DD/TD bases or the number of the third vectors.

In some embodiments, in each time point or time unit in the doppler/time domain, such as t=0, 1, 2, 3, . . . , N₄−1, there is a corresponding W(t), as illustrated in FIG. 4A. In a plurality of codebooks or precoding matrices which comprises spatial domain, frequency domain and doppler/time domain vectors, the plurality of codebooks or the plurality of precoding matrices corresponding to N₃ subbands and/or N₄ time units W (for example, the corresponding W) may be obtained by below equation (1-1):

$$W = {W}_{1} * * {( {W}_{d} ⊗ {W}_{f} )}^{H} , t = \{ 0 , 1 , … {N}_{4} - 1 \} \qquad ( 1 - 1 )$$

In some embodiments, there may be N₄*N₃ columns of vectors (for example, each column of vector may be indexed or represented as Cₚ, Cₚ is positive integer, and 1≤Cₚ≤N₄*N₃) in the plurality of codebooks or precoding matrices W. In some embodiments, the length or the size of each column of vector may be 2*N₁*N₂ or P. For example, each column of vector may be a precoder corresponding to a time unit in doppler/time domain and a subband (for example, second subband) in frequency domain. In some embodiments, W(t) may correspond to a subset of codebooks or precoding matrices corresponding to a time unit with an index and corresponding to all second subbands in frequency domain. In some embodiments, W(t) may be composed by a plurality of columns and/or a plurality of rows from the plurality of codebooks or precoding matrices W. For example, the plurality of columns may be columns with indexes t+1≤Cₚ≤t+N₃. For example, W(0) may be composed by the plurality of columns of vectors from the first column to the (N₃)-th column from the plurality of codebooks or precoding matrices W.

In some embodiments, in a plurality of codebooks or precoding matrices which comprises spatial domain, frequency domain and doppler/time domain vectors, the plurality of codebooks or precoding matrices corresponding to N₃ subbands and/or N₄ time units W′ can be expressed as equation (1-2):

$$W = {W}_{1} * * {( {W}_{f} ⊗ {W}_{d} )}^{H} , t = \{ 0 , 1 , … {N}_{4} - 1 \} \qquad ( 1 - 2 )$$

In some embodiments, in each time point or time unit in the doppler/time domain, such as t=0, 1, 2, 3, . . . , N₄−1, there is a corresponding W(t). In some embodiments, there may be N₄*N₃ columns of vectors (for example, each column of vector may be indexed or represented as Cₚ, Cₚ is positive integer, and 1≤Cₚ≤N₄*N₃) in the plurality of codebooks or precoding matrices W′. In some embodiments, the length or the size of each column of vector may be 2*N₁*N₂ or P. For example, each column of vector may be a precoder corresponding to a time unit in doppler/time domain and a second subband in frequency domain.

In some embodiments, W(t) may correspond to a subset of codebooks or precoding matrices corresponding to a time unit with an index and corresponding to all second subbands in frequency domain. In some embodiments, W(t) may be composed by a plurality of columns and/or a plurality of rows from the codebook or precoding matrix W′. For example, the plurality of columns may be columns with indexes Cₚ=t+f*N₄+1, and f is non-negative integer, 0≤f≤N₃−1. For example, W(0) may be composed by the plurality of columns of vectors with indexes {1, N₄+1, 2*N₄+1, . . . (N₃−1)*N₄+1} from the plurality of codebooks or precoding matrices W′.

In some embodiments, the plurality of codebooks or the plurality of precoding matrices corresponding to N₃ subbands and/or N₄ time units may be represented as Wor W′.

In some embodiments, the plurality of codebooks or the plurality of precoding matrices corresponding to N₃ subbands and/or N₄ time units may be composed by a first matrix (for example, W₁), a second matrix (for example, [symbol] or [symbol] ), a third matrix (for example, W_{f} or

$${W}_{f}^{H} )$$

and a fourth matrix (for example, W_{d} or

$${W}_{d}^{H} ) .$$

In some embodiments, the size of the second matrix may be (2L)*(Mᵥ*M_{d}). In some embodiments, each element of the second matrix may be represented as

$${P}_{r}^{( 1 )} * {P}_{r , i , mv , md}^{( 2 )} * {φ}_{r , i , mv , md} .$$

In some embodiments

$${P}_{r}^{( 1 )}$$

may be the first amplitude coefficient corresponding to layer with index r. In some embodiments,

$${P}_{r}^{( 1 )}$$

may not be needed. In some embodiments,

$${P}_{r}^{( 1 )}$$

may be fixed to be 1. In some embodiments,

$${P}_{r , i , mv , md}^{( 2 )}$$

may be second amplitude coefficient corresponding to the layer with index r and corresponding to one second vector with index i and corresponding to third vector with index my and corresponding to third vector with index md.

In some embodiments, φ_{r,ijm,md} may be phase coefficient corresponding to the layer with index r and corresponding to a second vector with index i and corresponding to third vector with index my and corresponding to third vector with index md.

In some embodiments, the value of

$${P}_{r}^{( 1 )}$$

and/or the value of

$${P}_{r , i , mv , md}^{( 2 )}$$

and/or the value of φ_{r,i,mv,md} may be separate for each one of two polarizations or for different groups of second vectors.

In some embodiments, for the third matrix or the plurality of second vectors (e.g. represented as W_{f}) corresponding to layer with index r,

$${W}_{f} = {[ {F}_{{n}_{3 , r}^{( 0 )}} {F}_{{n}_{3 , r}^{( 1 )}} … {F}_{{n}_{3 , r}^{( {M}_{v} - 1 )}} ]}^{T} .$$

In some embodiments, the size of W_{f} may be Mᵥ*N₃.

In some embodiments,

$${n}_{3 , l}^{( m v )} ∈ \{ 0 , 1 , … , {N}_{3} - 1 \} .$$

In some embodiments,

$${F}_{{n}_{3 , r}^{( m v )}} = {[ 1 {e}^{j \frac{2 π * 1 * {n}_{3 , r}^{( mv )}}{{N}_{3}}} {e}^{j \frac{2 π * 2 * {n}_{3 , r}^{( mv )}}{{N}_{3}}} … {e}^{j \frac{2 π * ( {N}_{3} - 1 ) * {n}_{3 , r}^{( mv )}}{{N}_{3}}} ]}^{T} .$$

In some embodiments,

$${y}_{z , r}^{( m v )} = {e}^{j \frac{2 π * z * {n}_{3 , r}^{( m ν )}}{{N}_{3}}} .$$

In some embodiments, z may be an index of a second subband. For example, z={0,1, . . . N₃−1}.

In some embodiments, one second vector may be represented as vᵢ,

$${v}_{i} = {v}_{{l}^{( i )} , {m}^{( i )}}$$

In some embodiments,

$${W}_{1} = [ \begin{matrix}B & 0 \\ 0 & B\end{matrix} ] ,$$

wherein B=v₀v₁ . . . v_{L-1}. For example, size of W₁ may be (2*N₁*N₂)*(2*L). For example, a size of each element in W₁ may be (N₁*N₂)*L, “0” in W₁ may be a zero matrix with size (N₁*N₂)*L.

In some embodiments,

$${W}_{1} = [ \begin{matrix}{v}_{0} {v}_{1} … {v}_{L - 1} & 0 \\ 0 & {v}_{0} {v}_{1} … {v}_{L - 1}\end{matrix} ] .$$

In some embodiments, [symbol] =[W_{2,0} W_{2,1} . . . W_{2,M}_{ᵥ}₋₁] or [symbol] =[W_{2,0} W_{2,1} . . . W_{2,M}_{ᵥ}₋₁]. In some embodiments, my may be a non-negative integer. For example, 0≤mᵥ≤Mᵥ. In some embodiments, W_{2,mv} may be a matrix with size (2L)*(M_{d}). For example, corresponding to a second vector with index my and corresponding to the plurality of third vectors.

In some embodiments, [symbol] =[W_{2,0} W_{2,1} . . . W_{2,M}_{_{d}}₋₁] or [symbol] =[W_{2,0} W_{2,1} . . . W_{2,M}_{_{d}}₋₁]. In some embodiments, md may be a non-negative integer. For example, 0≤md≤M_{d}. In some embodiments, W_{2,md} may be a matrix with size (2L)*(Mᵥ). For example, corresponding to a third vector with index md and corresponding to the plurality of second vectors.

In some embodiments, corresponding to the layer with index r, the second matrix may be [symbol] = or

[symbol]

$$[ \begin{matrix}\begin{matrix}\begin{matrix}{P}_{0 , 0}^{( 1 )} * {P}_{0 , 0 , 0}^{( 2 )} * \\ {φ}_{0 , 0 , 0}^{( 1 )}\end{matrix} \\ \begin{matrix}{P}_{0 , 0}^{( 1 )} * {P}_{1 , 0 , 0}^{( 2 )} * \\ {φ}_{1 , 0 , 0}^{( 1 )}\end{matrix} \\ ⋮ \\ \begin{matrix}{P}_{0 , 0}^{( 1 )} * {P}_{L - 1 , 0 , 0}^{( 2 )} * \\ {φ}_{L - 1 , 0 , 0}^{( 1 )}\end{matrix} \\ \begin{matrix}{P}_{1 , 0}^{( 1 )} * {P}_{L , 0 , 0}^{( 2 )} * \\ {φ}_{L , 0 , 0}^{( 1 )}\end{matrix} \\ \begin{matrix}{P}_{1 , 0}^{( 1 )} * {P}_{L + 1 , 0 , 0}^{( 2 )} * \\ {φ}_{L + 1 , 0 , 0}^{( 1 )}\end{matrix} \\ ⋮ \\ \begin{matrix}{P}_{1 , 0}^{( 1 )} * {P}_{2 * L - 1 , 0 , 0}^{( 2 )} * \\ {φ}_{2 * L - 1 , 0 , 0}^{( 1 )}\end{matrix}\end{matrix} & \begin{matrix}\begin{matrix}{P}_{0 , 0}^{( 1 )} * {P}_{0 , 1 , 0}^{( 2 )} * \\ {φ}_{0 , 1 , 0}^{( 1 )}\end{matrix} \\ \begin{matrix}{P}_{0 , 0}^{( 1 )} * {P}_{1 , 1 , 0}^{( 2 )} * \\ {φ}_{1 , 1 , 0}^{( 1 )}\end{matrix} \\ ⋮ \\ \begin{matrix}{P}_{0 , 0}^{( 1 )} * {P}_{L - 1 , 1 , 0}^{( 2 )} * \\ {φ}_{L - 1 , 1 , 0}^{( 1 )}\end{matrix} \\ \begin{matrix}{P}_{1 , 0}^{( 1 )} * {P}_{L , 1 , 0}^{( 2 )} * \\ {φ}_{L , 1 , 0}^{( 1 )}\end{matrix} \\ \begin{matrix}{P}_{1 , 0}^{( 1 )} * {P}_{L + 1 , 1 , 0}^{( 2 )} * \\ {φ}_{L + 1 , 1 , 0}^{( 1 )}\end{matrix} \\ ⋮ \\ \begin{matrix}{P}_{1 , 0}^{( 1 )} * {P}_{2 * L - 1 , 1 , 0}^{( 2 )} * \\ {φ}_{2 * L - 1 , 1 , 0}^{( 1 )}\end{matrix}\end{matrix} & … & \begin{matrix}\begin{matrix}{P}_{0 , 0}^{( 1 )} * {P}_{0 , {M}_{d} - 1 , 0}^{( 2 )} * \\ {φ}_{0 , {M}_{d} - 1 , 0}^{( 1 )}\end{matrix} \\ \begin{matrix}{P}_{0 , 0}^{( 1 )} * {P}_{0 , {M}_{d} - 1 , 0}^{( 2 )} * \\ {φ}_{0 , {M}_{d} - 1 , 0}^{( 1 )}\end{matrix} \\ ⋮ \\ \begin{matrix}{P}_{0 , 0}^{( 1 )} * {P}_{L - 1 , {M}_{d} - 1 , 0}^{( 2 )} * \\ {φ}_{L - 1 , {M}_{d} - 1 , 0}^{( 1 )}\end{matrix} \\ \begin{matrix}{P}_{1 , 0}^{( 1 )} * {P}_{L , {M}_{d} - 1 , 0}^{( 2 )} * \\ {φ}_{L , {M}_{d} - 1 , 0}^{( 1 )}\end{matrix} \\ \begin{matrix}{P}_{1 , 0}^{( 1 )} * {P}_{L + 1 , {M}_{d} - 1 , 0}^{( 2 )} * \\ {φ}_{L + 1 , {M}_{d} - 1 , 0}^{( 1 )}\end{matrix} \\ ⋮ \\ \begin{matrix}{P}_{1 , 0}^{( 1 )} * {P}_{2 * L - 1 , {M}_{d} - 1 , 0}^{( 2 )} * \\ {φ}_{2 * L - 1 , {M}_{d} - 1 , 0}^{( 1 )}\end{matrix}\end{matrix} & \begin{matrix}\begin{matrix}{P}_{0 , 0}^{( 1 )} * {P}_{0 , 0 , 1}^{( 2 )} * \\ {φ}_{0 , 0 , 1}^{( 1 )}\end{matrix} \\ \begin{matrix}{P}_{0 , 0}^{( 1 )} * {P}_{1 , 0 , 1}^{( 2 )} * \\ {φ}_{1 , 0 , 1}^{( 1 )}\end{matrix} \\ ⋮ \\ \begin{matrix}{P}_{0 , 0}^{( 1 )} * {P}_{L - 1 , 0 , 1}^{( 2 )} * \\ {φ}_{L - 1 , 0 , 1}^{( 1 )}\end{matrix} \\ \begin{matrix}{P}_{1 , 0}^{( 1 )} * {P}_{L , 0 , 1}^{( 2 )} * \\ {φ}_{L , 0 , 1}^{( 1 )}\end{matrix} \\ \begin{matrix}{P}_{1 , 0}^{( 1 )} * {P}_{L + 1 , 0 , 1}^{( 2 )} * \\ {φ}_{L + 1 , 0 , 1}^{( 1 )}\end{matrix} \\ ⋮ \\ \begin{matrix}{P}_{1 , 0}^{( 1 )} * {P}_{2 * L - 1 , 0 , 1}^{( 2 )} * \\ {φ}_{2 * L - 1 , 0 , 1}^{( 1 )}\end{matrix}\end{matrix} & \begin{matrix}\begin{matrix}{P}_{0 , 0}^{( 1 )} * {P}_{0 , 1 , 1}^{( 2 )} * \\ {φ}_{0 , 1 , 1}^{( 1 )}\end{matrix} \\ \begin{matrix}{P}_{0 , 0}^{( 1 )} * {P}_{1 , 1 , 1}^{( 2 )} * \\ {φ}_{1 , 1 , 1}^{( 1 )}\end{matrix} \\ ⋮ \\ \begin{matrix}{P}_{0 , 0}^{( 1 )} * {P}_{L - 1 , 1 , 1}^{( 2 )} * \\ {φ}_{L - 1 , 1 , 1}^{( 1 )}\end{matrix} \\ \begin{matrix}{P}_{1 , 0}^{( 1 )} * {P}_{L , 1 , 1}^{( 2 )} * \\ {φ}_{L , 1 , 1}^{( 1 )}\end{matrix} \\ \begin{matrix}{P}_{1 , 0}^{( 1 )} * {P}_{L + 1 , 1 , 1}^{( 2 )} * \\ {φ}_{L + 1 , 1 , 1}^{( 1 )}\end{matrix} \\ ⋮ \\ \begin{matrix}{P}_{1 , 0}^{( 1 )} * {P}_{2 * L - 1 , 1 , 1}^{( 2 )} * \\ {φ}_{2 * L - 1 , 1 , 1}^{( 1 )}\end{matrix}\end{matrix} & … & \begin{matrix}\begin{matrix}\begin{matrix}{P}_{0 , 0}^{( 1 )} * {P}_{0 , {M}_{d} - 1 , 1}^{( 2 )} *\end{matrix} \\ {φ}_{0 , {M}_{d} - 1 , 1}^{( 1 )}\end{matrix} \\ \begin{matrix}{P}_{0 , 0}^{( 1 )} * {P}_{1 , {M}_{d} - 1 , 1}^{( 2 )} * \\ {φ}_{1 , {M}_{d} - 1 , 1}^{( 1 )}\end{matrix} \\ ⋮ \\ \begin{matrix}{P}_{0 , 0}^{( 1 )} * {P}_{L - 1 , {M}_{d} - 1 , 1}^{( 2 )} * \\ {φ}_{L - 1 , {M}_{d} - 1 , 1}^{( 1 )}\end{matrix} \\ \begin{matrix}{P}_{1 , 0}^{( 1 )} * {P}_{L , {M}_{d} - 1 , 1}^{( 2 )} * \\ {φ}_{L , {M}_{d} - 1 , 1}^{( 1 )}\end{matrix} \\ \begin{matrix}{P}_{1 , 1}^{( 1 )} * {P}_{L + 1 , {M}_{d} - 1 , 1}^{( 2 )} * \\ {φ}_{L + 1 , {M}_{d} - 1 , 1}^{( 1 )}\end{matrix} \\ ⋮ \\ \begin{matrix}{P}_{1 , 0}^{( 1 )} * {P}_{2 * L - 1 , {M}_{d} - 1 , 1}^{( 2 )} * \\ {φ}_{2 * L - 1 , {M}_{d} - 1 , 1}^{( 1 )}\end{matrix}\end{matrix} \\ & … & \begin{matrix}\begin{matrix}\begin{matrix}{P}_{0 , 0}^{( 1 )} * {P}_{0 , 0 , {M}_{v} - 1}^{( 2 )} *\end{matrix} \\ {φ}_{0 , 0 , {M}_{v} - 1}^{( 1 )}\end{matrix} \\ \begin{matrix}{P}_{0 , 0}^{( 1 )} * {P}_{1 , 0 , {M}_{v} - 1}^{( 2 )} * \\ {φ}_{1 , 0 , {M}_{v} - 1}^{( 1 )}\end{matrix} \\ ⋮ \\ \begin{matrix}{P}_{0 , 0}^{( 1 )} * {P}_{L - 1 , 0 , {M}_{v} - 1}^{( 2 )} * \\ {φ}_{L - 1 , 0 , {M}_{v} - 1}^{( 1 )}\end{matrix} \\ \begin{matrix}{P}_{1 , 0}^{( 1 )} * {P}_{L , 0 , {M}_{v} - 1}^{( 2 )} * \\ {φ}_{L , 0 , {M}_{v} - 1}^{( 1 )}\end{matrix} \\ \begin{matrix}{P}_{1 , 0}^{( 1 )} * {P}_{L + 1 , 0 , {M}_{v} - 1}^{( 2 )} * \\ {φ}_{L + 1 , 0 , {M}_{v} - 1}^{( 1 )}\end{matrix} \\ ⋮ \\ \begin{matrix}{P}_{1 , 0}^{( 1 )} * {P}_{2 * L - 1 , 0 , {M}_{v} - 1}^{( 2 )} * \\ {φ}_{2 * L - 1 , 0 , {M}_{v} - 1}^{( 1 )}\end{matrix}\end{matrix} & \begin{matrix}\begin{matrix}\begin{matrix}{P}_{0 , 0}^{( 1 )} * {P}_{0 , 1 , {M}_{v} - 1}^{( 2 )} *\end{matrix} \\ {φ}_{0 , 1 , {M}_{v} - 1}^{( 1 )}\end{matrix} \\ \begin{matrix}{P}_{0 , 0}^{( 1 )} * {P}_{1 , 1 , {M}_{v} - 1}^{( 2 )} * \\ {φ}_{1 , 1 , {M}_{v} - 1}^{( 1 )}\end{matrix} \\ ⋮ \\ \begin{matrix}{P}_{0 , 0}^{( 1 )} * {P}_{L - 1 , 1 , {M}_{v} - 1}^{( 2 )} * \\ {φ}_{L - 1 , 1 , {M}_{v} - 1}^{( 1 )}\end{matrix} \\ \begin{matrix}{P}_{1 , 0}^{( 1 )} * {P}_{L , 1 , {M}_{v} - 1}^{( 2 )} * \\ {φ}_{L , 0 , {M}_{v} - 1}^{( 1 )}\end{matrix} \\ \begin{matrix}{P}_{1 , 0}^{( 1 )} * {P}_{L + 1 , 0 , {M}_{v} - 1}^{( 2 )} * \\ {φ}_{L + 1 , 1 , {M}_{v} - 1}^{( 1 )}\end{matrix} \\ ⋮ \\ \begin{matrix}{P}_{1 , 0}^{( 1 )} * {P}_{2 * L - 1 , 1 , {M}_{v} - 1}^{( 2 )} * \\ {φ}_{2 * L - 1 , 1 , {M}_{v} - 1}^{( 1 )}\end{matrix}\end{matrix} & … & \begin{matrix}\begin{matrix}\begin{matrix}{P}_{0 , 0}^{( 1 )} *\end{matrix} {P}_{0 , {M}_{d} - 1 , {M}_{v} - 1}^{( 2 )} * \\ {φ}_{0 , {M}_{d} - 1 , {M}_{v} - 1}^{( 1 )}\end{matrix} \\ \begin{matrix}\begin{matrix}{P}_{0 , 0}^{( 1 )} * {P}_{1 , {M}_{d} - 1 , {M}_{v} - 1}^{( 2 )} *\end{matrix} \\ {φ}_{1 , {M}_{d} - 1 , {M}_{v} - 1}^{( 1 )}\end{matrix} \\ ⋮ \\ \begin{matrix}\begin{matrix}{P}_{0 , 0}^{( 1 )} * {P}_{L - 1 , {M}_{d} - 1 , {M}_{v} - 1}^{( 2 )} *\end{matrix} \\ {φ}_{L - 1 , {M}_{d} - 1 , {M}_{v} - 1}^{( 1 )}\end{matrix} \\ \begin{matrix}\begin{matrix}{P}_{1 , 0}^{( 1 )} * {P}_{L , {M}_{d} - 1 , {M}_{v} - 1}^{( 2 )} *\end{matrix} \\ {φ}_{L , {M}_{d} - 1 , {M}_{v} - 1}^{( 1 )}\end{matrix} \\ \begin{matrix}\begin{matrix}{P}_{1 , 0}^{( 1 )} * {P}_{L + 1 , {M}_{d} - 1 , {M}_{v} - 1}^{( 2 )} *\end{matrix} \\ {φ}_{L + 1 , {M}_{d} - 1 , {M}_{v} - 1}^{( 1 )}\end{matrix} \\ ⋮ \\ \begin{matrix}{P}_{1 , 0}^{( 1 )} * {P}_{2 * L - 1 , {M}_{d} - 1 , {M}_{v} - 1}^{( 2 )} * \\ {φ}_{2 * L - 1 , {M}_{d} - 1 , {M}_{v} - 1}^{( 1 )}\end{matrix}\end{matrix} & & \end{matrix} ]$$

In some embodiments,

$${P}_{0 , 0}^{( 1 )} and {P}_{1 , 0}^{( 1 )}$$

(for example, same as

$${P}_{r}^{( 1 )} )$$

may be the first amplitude coefficient corresponding to layer with index r. In some embodiments,

$${P}_{i , mv , md}^{( 2 )}$$

may be second amplitude coefficient corresponding to the layer with index r and corresponding to one second vector with index i and corresponding to third vector with index my and corresponding to third vector with index md. In some embodiments,

$${φ}_{r , i , mv , md}^{( 1 )}$$

(for example, same as φ_{r,i,mv,md}) may be phase coefficient corresponding to the layer with index r and corresponding to a second vector with index i and corresponding to third vector with index my and corresponding to third vector with index md.

In some embodiments, for the codebook or precoding matrix or precoder corresponding to layer with index r and corresponding to second subband with index z and corresponding to time unit with index T,

$${W}_{z , T}^{r} = \frac{1}{\sqrt{{N}_{1} {N}_{2} {γ}_{z , r , T}}} [ \begin{matrix}{\sum }_{i = 0}^{L - 1} {v}_{i} {P}_{r , 0}^{( 1 )} & {\sum }_{mv = 0}^{{M}_{υ} - 1} {y}_{z , r}^{( mv )} {d}_{T , r}^{( md )} {P}_{r , i , 0 , mv , md}^{( 2 )} {φ}_{r , i , 0 , mv , md}^{( 1 )} \\ {\sum }_{i = 0}^{L - 1} {v}_{i} {P}_{r , 1}^{( 1 )} & {\sum }_{mv = 0}^{{M}_{υ} - 1} {y}_{z , r}^{( mv )} {d}_{T , r}^{( md )} {P}_{r , i , 1 , mv , md}^{( 2 )} {φ}_{r , i , 1 , mv , md}^{( 1 )}\end{matrix} ]$$

In some embodiments, γ_{z,r,T} may be a variant for power calculation or power normalization.

In some embodiments, γ_{z,r,T} may be based on the plurality of second amplitude coefficients, the plurality of phase coefficients and the plurality of first amplitude coefficients. In some embodiments, γ_{z,r,T} may be based on the number of the plurality of second vectors and at least one of: the number of the plurality of first vectors, the number of the plurality of second vectors.

In some embodiments,

$${γ}_{t , l} = {\sum }_{i = 0}^{2 L - 1} {( {p}_{l , ⌊ \frac{i}{L} ⌋}^{( 1 )} )}^{2} {\vert {\sum }_{mv = 0}^{{M}_{υ} - 1} {\sum }_{md = 0}^{{M}_{d} - 1} {y}_{t , l}^{( mv )} {d}_{t , l}^{( md )} {p}_{l , i , mv , md}^{( 2 )} {φ}_{l , i , mv , md} \vert}^{2} .$$

In some embodiments, for bits or codepoints or values of the one or more indicators (or one or more bitmaps) for indicating nonzero coefficients with value to be 0, the second amplitude coefficient and/or the phase coefficient corresponding to the bits or codepoints or values may be set to 0.

In some embodiments, for the fourth matrix or the plurality of third vectors (e.g. represented as W_{d}) corresponding to layer with index r,

$${W}_{d} = {[ {F}_{{n}_{4}^{( 0 )}} {F}_{{n}_{4}^{( 1 )}} … {F}_{{n}_{4}^{( {M}_{d} - 1 )}} ]}^{T} .$$

In some embodiments, the size of W_{d} may be M_{d}*N₄.

In some embodiments,

$${n}_{4}^{( md )} ∈ \{ 0 , 1 , … , {N}_{4} - 1 \} .$$

In some embodiments,

$${F}_{{n}_{4}^{( md )}} = {[ 1 {e}^{j \frac{2 π * 1 * {n}_{4}^{( m d )}}{{N}_{4}}} {e}^{j \frac{2 n * 2 * {n}_{4}^{( m d )}}{{N}_{4}}} … {e}^{j \frac{2 π * ( {N}_{4} - 1 ) * {n}_{4}^{( m d )}}{{N}_{4}}} ]}^{T} .$$

In some embodiments,

$${d}_{X}^{( m d )} = {e}^{j \frac{2 π * X * {n}_{4}^{( m d )}}{{N}_{4}}} .$$

In some embodiments, md may be an index of one third vector. For example, mnd=0, 1, . . . M_{d}−1.

In some embodiments, a value of one first amplitude coefficient may be one of

$$\{ 0 , \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \text{} \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} .$$

In some embodiments, the bit size for one first amplitude coefficient may be 4 bits. In some embodiments, a value of an indicator or a field for one first amplitude coefficient may be one of {0, 1, 2, 3, 4, 5, 6, 7, 8, 9, 10, 11, 12, 13, 14, 15}

In some embodiments, an indicator or a field for one first amplitude coefficient with value 0 may correspond to the first amplitude coefficient with value 0. In some embodiments, an indicator or a field for one first amplitude coefficient with value 1 may correspond to the first amplitude coefficient with value

$$\frac{1}{\sqrt{128}} .$$

In some embodiments, an indicator or a field for one first amplitude coefficient with value 2 may correspond to the first amplitude coefficient with value

$${( \frac{1}{8192} )}^{1 / 4} .$$

In some embodiments, an indicator or a field for one first amplitude coefficient with value 3 may correspond to the first amplitude coefficient with value ⅛. In some embodiments, an indicator or a field for one first amplitude coefficient with value 4 may correspond to the first amplitude coefficient with value

$${( \frac{1}{2048} )}^{1 / 4} .$$

In some embodiments, an indicator or a field for one first amplitude coefficient with value 5 may correspond to the first amplitude coefficient with value

$$\frac{1}{2 \sqrt{8}} .$$

In some embodiments, an indicator or a field for one first amplitude coefficient with value 6 may correspond to the first amplitude coefficient with value

$${( \frac{1}{512} )}^{1 / 4} .$$

In some embodiments, an indicator or a field for one first amplitude coefficient with value 7 may correspond to the first amplitude coefficient with value ¼. In some embodiments, an indicator or a field for one first amplitude coefficient with value 8 may correspond to the first amplitude coefficient with value

$${( \frac{1}{128} )}^{1 / 4} .$$

In some embodiments, an indicator or a field for one first amplitude coefficient with value 9 may correspond to the first amplitude coefficient with value

$$\frac{1}{\sqrt{8}} .$$

In some embodiments, an indicator or a field for one first amplitude coefficient with value 10 may correspond to the first amplitude coefficient with value

$${( \frac{1}{32} )}^{1 / 4} .$$

In some embodiments, an indicator or a field for one first amplitude coefficient with value 11 may correspond to the first amplitude coefficient with value ½. In some embodiments, an indicator or a field for one first amplitude coefficient with value 12 may correspond to the first amplitude coefficient with value

$${( \frac{1}{8} )}^{1 / 4} .$$

In some embodiments, an indicator or a field for one first amplitude coefficient with value 13 may correspond to the first amplitude coefficient with value

$$\frac{1}{\sqrt{2}} .$$

In some embodiments, an indicator or a field for one first amplitude coefficient with value 14 may correspond to the first amplitude coefficient with value

$${( \frac{1}{2} )}^{1 / 4} .$$

In some embodiments, an indicator or a field for one first amplitude coefficient with value 15 may correspond to the first amplitude coefficient with value 1.

In some embodiments, a value of one first amplitude coefficient may be one of

$$\{ 0 , \frac{1}{\sqrt{64}} , \frac{1}{\sqrt{32}} , \frac{1}{4} , \frac{1}{\sqrt{8}} , \frac{1}{2} , \frac{1}{\sqrt{2}} , 1 \} .$$

In some embodiments, the bit size for one first amplitude coefficient may be 4 bits. In some embodiments, a value of an indicator or a field for one first amplitude coefficient may be one of {0, 1, 2, 3, 4, 5, 6, 7}.

In some embodiments, an indicator or a field for one first amplitude coefficient with value 0 may correspond to the first amplitude coefficient with value 0. In some embodiments, an indicator or a field for one first amplitude coefficient with value 1 may correspond to the first amplitude coefficient with value

$$\frac{1}{\sqrt{64}} .$$

In some embodiments, an indicator or a field for one first amplitude coefficient with value 2 may correspond to the first amplitude coefficient with value

$$\frac{1}{\sqrt{32}} .$$

In some embodiments, an indicator or a field for one first amplitude coefficient with value 3 may correspond to the first amplitude coefficient with value ¼.

In some embodiments, an indicator or a field for one first amplitude coefficient with value 4 may correspond to the first amplitude coefficient with value

$$\frac{1}{\sqrt{8}} .$$

In some embodiments, an indicator or a field for one first amplitude coefficient with value 5 may correspond to the first amplitude coefficient with value ½.

In some embodiments, an indicator or a field for one first amplitude coefficient with value 6 may correspond to the first amplitude coefficient with value

$$\frac{1}{\sqrt{2}} .$$

In some embodiments, an indicator or a field for one first amplitude coefficient with value 7 may correspond to the first amplitude coefficient with value 1.

In some embodiments, the value of the first amplitude coefficient corresponding to the first antenna port group (for example, the antenna port group with index Tₘ) may be 1. In some embodiments, the value of the indicator or the field for the first amplitude coefficient corresponding to the first antenna port group (for example, the antenna port group with index Tₘ) may be 15. In some embodiments, the value of the first amplitude coefficient or the indicator or the field for the first amplitude coefficient corresponding to the first antenna port group (for example, the antenna port group with index Tₘ) may not be reported in the PMI.

In some embodiments, the value of the first amplitude coefficient corresponding to the antenna port group which is not included in the second plurality of antenna port groups may be 0. In some embodiments, the value of the indicator or the field for the first amplitude coefficient corresponding to the antenna port group which is not included in the second plurality of antenna port groups may be 0. In some embodiments, the value of the first amplitude coefficient or the indicator or the field for the first amplitude coefficient corresponding to the antenna port group which is not included in the second plurality of antenna port groups may not be reported in the PMI.

In some embodiments, a value of one second amplitude coefficient may be one of

$$\{ \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \text{} \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} .$$

some embodiments, the bit size for one second amplitude coefficient may be 4 bits. In some embodiments, a value of an indicator or a field for one second amplitude coefficient may be one of {1, 2, 3, 4, 5, 6, 7, 8, 9, 10, 11, 12, 13, 14, 15}.

In some embodiments, an indicator or a field for one second amplitude coefficient with value 0 may correspond to the second amplitude coefficient with value 0. In some embodiments, an indicator or a field for one second amplitude coefficient with value 1 may correspond to the second amplitude coefficient with value

$$\frac{1}{\sqrt{128}} .$$

In some embodiments, an indicator or a field for one second amplitude coefficient with value 2 may correspond to the second amplitude coefficient with value

$${( \frac{1}{8192} )}^{1 / 4} .$$

In some embodiments, an indicator or a field for one second amplitude coefficient with value 3 may correspond to the second amplitude coefficient with value ⅛.

In some embodiments, an indicator or a field for one second amplitude coefficient with value 4 may correspond to the second amplitude coefficient with value

$${( \frac{1}{2048} )}^{1 / 4} .$$

In some embodiments, an indicator or a field for one second amplitude coefficient with value 5 may correspond to the second amplitude coefficient with value

$$\frac{1}{2 \sqrt{8}} .$$

In some embodiments, an indicator or a field for one second amplitude coefficient with value 6 may correspond to the second amplitude coefficient with value

$${( \frac{1}{512} )}^{1 / 4} .$$

In some embodiments, an indicator or a field for one second amplitude coefficient with value 7 may correspond to the second amplitude coefficient with value ¼.

In some embodiments, an indicator or a field for one second amplitude coefficient with value 8 may correspond to the second amplitude coefficient with value

$${( \frac{1}{128} )}^{1 / 4} .$$

In some embodiments, an indicator or a field for one second amplitude coefficient with value 9 may correspond to the second amplitude coefficient with value

$$\frac{1}{\sqrt{8}} .$$

In some embodiments, an indicator or a field for one second amplitude coefficient with value 10 may correspond to the second amplitude coefficient with value

$${( \frac{1}{32} )}^{1 / 4} .$$

In some embodiments, an indicator or a field for one second amplitude coefficient with value 11 may correspond to the second amplitude coefficient with value ½.

In some embodiments, an indicator or a field for one second amplitude coefficient with value 12 may correspond to the second amplitude coefficient with value

$${( \frac{1}{8} )}^{1 / 4} .$$

In some embodiments, an indicator or a field for one second amplitude coefficient with value 13 may correspond to the second amplitude coefficient with value

$$\frac{1}{\sqrt{2}} .$$

In some embodiments, an indicator or a field for one second amplitude coefficient with value 14 may correspond to the second amplitude coefficient with value

$${( \frac{1}{2} )}^{1 / 4} .$$

In some embodiments, an indicator or a field for one second amplitude coefficient with value 15 may correspond to the second amplitude coefficient with value 1.

In some embodiments, a value of one second amplitude coefficient may be one of

$$\{ 0 , \frac{1}{\sqrt{64}} , \frac{1}{\sqrt{32}} , \frac{1}{4} , \frac{1}{\sqrt{8}} , \frac{1}{2} , \frac{1}{\sqrt{2}} , 1 \} .$$

In some embodiments, the bit size for one second amplitude coefficient may be 4 bits. In some embodiments, a value of an indicator or a field for one second amplitude coefficient may be one of {0, 1, 2, 3, 4, 5, 6, 7}. In some embodiments, an indicator or a field for one second amplitude coefficient with value 0 may correspond to the second amplitude coefficient with value 0.

In some embodiments, an indicator or a field for one second amplitude coefficient with value 1 may correspond to the second amplitude coefficient with value

$$\frac{1}{\sqrt{64}} .$$

In some embodiments, an indicator or a field for one second amplitude coefficient with value 2 may correspond to the second amplitude coefficient with value

$$\frac{1}{\sqrt{32}} .$$

In some embodiments, an indicator or a field for one second amplitude coefficient with value 3 may correspond to the second amplitude coefficient with value ¼. In some embodiments, an indicator or a field for one second amplitude coefficient with value 4 may correspond to the second amplitude coefficient with value

$$\frac{1}{\sqrt{8}} .$$

In some embodiments, an indicator or a field for one second amplitude coefficient with value 5 may correspond to the second amplitude coefficient with value ½. In some embodiments, an indicator or a field for one second amplitude coefficient with value 6 may correspond to the second amplitude coefficient with value

$$\frac{1}{\sqrt{2}} .$$

In some embodiments, an indicator or a field for one second amplitude coefficient with value 7 may correspond to the second amplitude coefficient with value 1.

In some embodiments, a value of one second amplitude coefficient may be one of

$$\{ \frac{1}{8 \sqrt{2}} , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} .$$

In some embodiments, the bit size for one second amplitude coefficient may be 3 bits. In some embodiments, a value of an indicator or a field for one second amplitude coefficient may be one of {0, 1, 2, 3, 4, 5, 6, 7}.

In some embodiments, an indicator or a field for one second amplitude coefficient with value 0 may correspond to the second amplitude coefficient with value

$$\frac{1}{8 \sqrt{2}} .$$

In some embodiments, an indicator or a field for one second amplitude coefficient with value 1 may correspond to the second amplitude coefficient with value ⅛. In some embodiments, an indicator or a field for one second amplitude coefficient with value 2 may correspond to the second amplitude coefficient with value

$$\frac{1}{4 \sqrt{2}} .$$

In some embodiments, an indicator or a field for one second amplitude coefficient with value 3 may correspond to the second amplitude coefficient with value ¼. In some embodiments, an indicator or a field for one second amplitude coefficient with value 4 may correspond to the second amplitude coefficient with value

$$\frac{1}{2 \sqrt{2}} .$$

In some embodiments, an indicator or a field for one second amplitude coefficient with value 5 may correspond to the second amplitude coefficient with value ½. In some embodiments, an indicator or a field for one second amplitude coefficient with value 6 may correspond to the second amplitude coefficient with value

$$\frac{1}{\sqrt{2}} .$$

In some embodiments, an indicator or a field for one second amplitude coefficient with value 7 may correspond to the second amplitude coefficient with value 1. In some embodiments, one second amplitude coefficient may be a differential value corresponding to one first amplitude coefficient.

In some embodiments, a value of one second amplitude coefficient may be one of

$$\{ \frac{1}{\sqrt{2}} , 1 \} .$$

In some embodiments, the bit size for one second amplitude coefficient may be 1 bit. In some embodiments, a value of an indicator or a field for one second amplitude coefficient may be one of {0, 1}. In some embodiments, an indicator or a field for one second amplitude coefficient with value 0 may correspond to the second amplitude coefficient with value

$$\frac{1}{\sqrt{2}} .$$

In some embodiments, an indicator or a field for one second amplitude coefficient with value 1 may correspond to the second amplitude coefficient with value 1. In some embodiments, one second amplitude coefficient may be a differential value corresponding to one first amplitude coefficient.

In some embodiments, the value of the second amplitude coefficient corresponding to the antenna port group which is not included in the second plurality of antenna port groups may be 0. In some embodiments, the value of the indicator or the field for the second amplitude coefficient corresponding to the antenna port group which is not included in the second plurality of antenna port groups may be 0. In some embodiments, the value of the second amplitude coefficient or the indicator or the field for the second amplitude coefficient corresponding to the antenna port group which is not included in the second plurality of antenna port groups may not be reported in the PMI.

In some embodiments, for bits or codepoints or values of the one or more indicators (or one or more bitmaps) for indicating nonzero coefficients with value to be 0, the value of the first amplitude coefficient corresponding to the bits or codepoints or values may be set to be 0 and/or the value of an indicator or a field for the first amplitude coefficient corresponding to the bits or codepoints or values may be set to be 0. In some embodiments, the value of the first amplitude coefficient corresponding to the bits or codepoints or values and/or the value of an indicator or a field for the first amplitude coefficient corresponding to the bits or codepoints or values may not be reported in the PMI.

In some embodiments, for bits or codepoints or values of the one or more indicators (or one or more bitmaps) for indicating nonzero coefficients with value to be 0, the value of the second amplitude coefficient corresponding to the bits or codepoints or values may be set to be 0 and/or the value of an indicator or a field for the second amplitude coefficient corresponding to the bits or codepoints or values may be set to be 0. In some embodiments, the value of the second amplitude coefficient corresponding to the bits or codepoints or values and/or the value of an indicator or a field for the second amplitude coefficient corresponding to the bits or codepoints or values may not be reported in the PMI.

In some embodiments, for bits or codepoints or values of the one or more indicators (or one or more bitmaps) for indicating nonzero coefficients with value to be 0, the value of at least one of the phase coefficient corresponding to the bits or codepoints or values may be set to be 0 and/or the value of an indicator or a field for at least one of the phase coefficient corresponding to the bits or codepoints or values may be set to be 0. In some embodiments, the value of at least one of the phase coefficient corresponding to the bits or codepoints or values and/or the value of an indicator or a field for at least one of the phase coefficient corresponding to the bits or codepoints or values may not be reported in the PMI.

In some embodiments, a value of one phase coefficient may be e^{j2π·φ}^{ₚ}^{/N}^{_{PSK}}. In some embodiments, φₚ may be a value of one indicator or one field for the phase coefficient. In some embodiments, a value of one second phase coefficient may be e^{j2π·φ}^{ₚ}^{/N}^{_{PSK}}. In some embodiments, φₚ may be a non-negative integer. In some embodiments, 0≤φₚ≤N_{PSK}−1 In some embodiments, φₚ may be one of {0,1,2,3} or {0,1,2,3,4,5,6,7} or {0,1,2,3,4,5,6,7,8,9,10,11,12,13,14,15}. In some embodiments, N_{PSK} may be the size for indication of φₚ. In some embodiments, N_{PSK} may be a positive integer. In some embodiments, N_{PSK} may be one of {2, 4, 8, 16, 32, 64}.

In some embodiments, the work scope of type-II codebook refinement for CJT multi-TRP includes down-selecting at least one or merging from a predefined codebook structure:

In some embodiments, one example of the predefined codebook structure is enabled through per-TRP (port-group or resource) SD/FD basis selection and relative co-phasing/amplitude (including wideband and/or sunbband). Example formulation (N=number of TRPs or TRP groups) is as below:

$$[ \begin{matrix}( {a}_{1} {p}_{1} ) \times {W}_{1 , 1} {\tilde{W}}_{2 , 1} {W}_{f , 1}^{H} \\ ⋮ \\ ( {a}_{{N}_{TRP}} {p}_{{N}_{TRP}} ) \times {W}_{1 , {N}_{TRP}} {W}_{2 , {N}_{TRP}} {W}_{f , {N}_{TRP}}^{H}\end{matrix} ]$$

where aᵣ=co-amplitude and pᵣ=co-phase. Further, include special case of aᵣ=pₜ=1 (no co-scaling) or aᵣ=0.

In some embodiments, another example of the predefined codebook structure is enabled through per-TRP (port-group or resource) joint SD-FD basis selection and relative co-phasing/amplitude (including wideband and/or sunbband). Example formulation (N=number of TRPs or TRP groups):

$$[ \begin{matrix}( {a}_{1} {p}_{1} ) \times {W}_{SF , 1} {\tilde{W}}_{2 , 1} \\ ⋮ \\ ( {a}_{{N}_{TRP}} {p}_{{N}_{TRP}} ) \times {W}_{1 , {N}_{TRP}} {W}_{2 , {N}_{TRP}}\end{matrix} ]$$

where aᵣ=co-amplitude and pᵣ=co-phase. Further, include special case of aᵣ=pᵣ=1 (no co-scaling) or aᵣ=0.

In some embodiments, a further example of the predefined codebook structure is enabled through per-TRP (port-group or resource) SD basis selection and joint (across N TRPs) FD basis selection. Example formulation (N=number of TRPs or TRP groups):

$$[ \begin{matrix}{W}_{1 , 1} & 0 & 0 & 0 \\ 0 & ⋱ & 0 & 0 \\ 0 & 0 & {W}_{1 , {N}_{TRP}} & \\ 0 & 0 & & \end{matrix} ] {\tilde{W}}_{2} {W}_{f , 1}^{H}$$

In some embodiments, the work scope of type-II codebook refinement for a high/medium velocity includes down selection from the following codebook structures:
As for TD basis
TD basis commonly selected for all SD/FD bases, e.g. (W_{f}*⊗W₁)W₂Wₜ^{H}, W_{d} may be the identity as a special case;
TD basis independently selected for different SD/FD bases.
As for DD basis
DD basis commonly selected for all SD/FD bases, e.g. W₁\tilde{W}₂(W_{f}⊗W_{d})^{H}, W_{d} may be the identity as a special case;
DD basis independently selected for different SD/FD bases.

In some embodiments, release 16/17 type-II codebook with multiple W₂ and a single W₁ and W_{f} report may be reused.

In some embodiments, parameter M_{d} refers to the number of bases for DD/TD bases and parameter N₄ refers to the length of the DD/TD basis.

In some embodiments, the terminal device 220 may report to the network device 210, the number of DD/TD bases, a length of the DD/TD basis, a length of a time unit associated with a doppler/time domain, a bitmap of non-zero coefficients in a matrix associated with coefficients for a codebook, or any combination of the above. Alternatively, or in addition, the terminal device 220 can receive from the network device 210, the number of the number of DD/TD bases, a length of the DD/TD basis, a length of a time unit associated with a doppler/time domain, a bitmap of non-zero coefficients in a matrix associated with coefficients for a codebook, or any combination of the above.

In some embodiments, the length, N₄, of DD/TD basis or one third vector may be configured by the network device 210 or reported by the terminal device 220. In one specific example embodiment, the terminal device 220 may include the length N4 in CSI part 1 and then report the CSI to the network device 210. In another specific example embodiment, the terminal device 220 may receive the length N4 from the network device 210. In some embodiments, the length N₄ may be the same as the time intervals between CSI-RS resources for measurement.

In some embodiments, the number of bases for DD/TD bases M_{d} may be configured by the network device 210 or reported by the terminal device 220. For example, the terminal device 220 may include the number M_{d} in CSI part 1 and then report the CSI to the network device 210. As another example, the terminal device 220 may receive the number M_{d} from the network device 210.

In some embodiments, an indication of non-zero coefficients (such as, a bitmap) may be reported by the terminal device 220. The size of the bitmap may be 2L*M_{d}*Mᵥ for one layer with index r, where Mᵥ may be the number of frequency basis vectors or the second vectors.

For specific M_{d} and Mᵥ values, each bit in the bitmap is mapped to a specific doppler-frequency domain coefficient. The indication of non-zero coefficients in bitmap form may be reported by the terminal device 220 to the network device 210. For example, the terminal device 220 may include in the CSI a first indication field indicating non-zero coefficients, and then report the CSI to the network device 210.

In some embodiments, the overall number of non-zero amplitude/phase coefficients across layers may be calculated for all the M_{d} DD/TD bases, i.e., K^{NZ}.

Alternatively, in some embodiments, the number of non-zero amplitude/phase coefficients across layers may be calculated per DD/TD bases. That is,

$${K}^{NZ} = {\sum }_{md = 0}^{Md - 1} {K}_{md}^{NZ} .$$

In some embodiments, the number of SD bases is represented to be L, where L is a positive integer.

In some embodiments, the selection or indication of the plurality of third vectors (e.g. doppler/time basis) may be reported by the terminal device 220 to the network device 210. For example, the terminal device 220 may transmit the selection or indicator of the plurality of third vectors (e.g. doppler/time basis) via an indication field in the CSI report to the network device 210. The size of the second indication field may be ceil(log 2(C(Ns, M_{d}))) or ceil(log 2(Ns−1,Md−1)) (e.g. with rotation, one basis is rotated to be [1,1, . . . 1]), Ns may be at least one of N4 (e.g. in case of orthogonal DFT basis for Doppler/time basis), N4*O3 (e.g. oversampled DFT basis for Doppler/time basis), N5 (e.g. a window selected from N4 or N4*O3, similar as the case of N3>19 for frequency domain compression, e.g. N5=A*Md, A may be 2 or 3 or 4).

In some embodiments, the strongest coefficient indicator (SCI) may be reported by the terminal device 220 to the network device 210. For example, the terminal device 220 may transmit the SCI via an indication field (per layer indication) in the CSI report to the network device 210.

In some embodiments, the codebook matrix may be represented as below equation (2).

$$\tilde{W} = [ \begin{matrix}{v}_{0} {v}_{1} … {v}_{L - 1} & 0 \\ 0 & {v}_{0} {v}_{1} … {v}_{L - 1}\end{matrix} ] * [ \begin{matrix}{W}_{2 , 0} & {W}_{2 , 1} & ⋯ & {W}_{2 , {M}_{v} - 1}\end{matrix} ] * [ \begin{matrix}{y}_{0}^{( 0 )} * {W}_{d} & {y}_{1}^{( 0 )} * {W}_{d} & ⋯ & {y}_{{N}_{3} - 1}^{( 0 )} * {W}_{d} \\ {y}_{0}^{( 1 )} * {W}_{d} & {y}_{1}^{( 1 )} * {W}_{d} & ⋯ & {y}_{{N}_{3} - 1}^{( 1 )} * {W}_{d} \\ ⋮ & ⋮ & ⋮ & ⋮ \\ {y}_{0}^{( {M}_{v} - 1 )} * {W}_{d} & {y}_{1}^{( {M}_{v} - 1 )} * {W}_{d} & ⋯ & {y}_{{N}_{3} - 1}^{( {M}_{v} - 1 )} * {W}_{d}\end{matrix} ] \qquad ( 2 )$$

In the following, some examples about how to configure and report CSI feedback for a scenario where the TD/DD domain compression (or CSI feedback associated with DD/TD basis) is enabled.

As illustrated in FIG. 3, in some embodiments, the network device 210 may configure the terminal device 220 to report CSI feedback. As shown in FIG. 3, the terminal device 220 receives 310 from a network device, configuration(s) for the CSI feedback.

Next, the terminal device 220 transmits 330 the CSI feedback to the network device 210 based on the at least one configuration.

In some embodiments, the CSI feedback comprises a plurality of partitions with different omission priorities, and further the plurality of partitions comprises parameters to be reported (also referred to as CSI information). In particular, the parameters reported by the CSI feedback are associated with a plurality of first vectors, a plurality of second vectors, and a plurality of third vectors.

For better understanding, in the following descriptions, an FD basis would be described as an example of the first vector, an SD basis would be described as an example of the second vector, and the DD/TD basis would be described as an example of the third vector.

In this way, by associating the parameters with three types of vectors, the TD/DD information may be reported together with the SD information and FD information. Moreover, these parameters are included in different partitions with different omission priorities, which ensure that the network device 210 may at least predict the future channel prediction for at least one beam, such that the communication between the network device and the terminal device may not be suspended.

In some embodiments, the priorities may be determined based at least in part on an index of the third vector (i.e., the DD/TD basis).

In some embodiments, the terminal device 220 determines 320 priorities and includes the parameters into the plurality of partitions of the CSI feedback based on the priorities. In some embodiments, the terminal device 220 determines a respective first priority for a first vector (i.e., an FD basis) of the plurality of first vectors. Alternatively, or in addition, in some other embodiments, the terminal device 220 determines a respective second priority for a second vector (i.e., an SD basis) of the plurality of second vectors. Alternatively, or in addition, in some further embodiments, the terminal device 220 determines a respective third priority for a third vector (i.e., a TD/DD basis) of the plurality of third vectors. Alternatively, or in addition, in some further embodiments, the terminal device 220 determines a respective fourth priority for a parameter of the parameters comprised in the CSI feedback. In this way, the dropping risk of the parameters with a higher priority may be reduced.

In some embodiments, some priority rules for CSI feedback may be stipulated for a terminal device 220 with a high or medium velocity.

In some embodiments, some parameters (such as, amplitude and/or phase coefficients) corresponding to a first vector and/or a second vector and/or a third vector may be prioritized or associated with higher priority. In some embodiments, a first subset of parameters has a higher priority than a second subset of parameters, where the first subset of parameters corresponds to a first subset of DD/TD bases and corresponds to a first subset of SD bases and corresponds to a first subset of FD bases, while the second subset of parameters corresponds to a second subset of DD/TD bases and corresponds to a second subset of SD bases and corresponds to a second subset of FD bases.

Alternatively, in some embodiments, a first subset of parameters has a higher priority than a second subset of parameters, where the first subset of parameters corresponds to the plurality of DD/TD bases and corresponds to a first subset of SD bases and corresponds to a first subset of FD bases, while the second subset of parameters corresponds to the plurality of DD/TD bases and corresponds to a second subset of SD bases and corresponds to a second subset of FD bases.

Alternatively, in some embodiments, a first subset of parameters has a higher priority than a second subset of parameters, where the first subset of parameters corresponds to a first subset of DD/TD bases and corresponds to the plurality of SD bases and corresponds to a first subset of FD bases, while the second subset of parameters corresponds to a second subset of DD/TD bases and corresponds to the plurality of SD bases and corresponds to a second subset of FD bases.

Alternatively, in some embodiments, a first subset of parameters has a higher priority than a second subset of parameters, where the first subset of parameters corresponds to a first subset of DD/TD bases and corresponds to a first subset of SD bases and corresponds to the plurality of FD bases), while the second subset of parameters corresponds to a second subset of DD/TD bases and corresponds to a second subset of SD bases and corresponds to the plurality of FD bases).

Alternatively, in some embodiments, a first subset of parameters has a higher priority than a second subset of parameters, where the first subset of parameters corresponds to a first subset of DD/TD bases and corresponds to the plurality of SD bases and corresponds to the plurality of FD bases, while the second subset of parameters corresponds to a second subset of DD/TD bases and corresponds to the plurality of SD bases and corresponds to the plurality of FD bases. In some embodiments, a first subset of parameters has a higher priority than a second subset of parameters, where the first subset of parameters corresponds to the plurality of DD/TD bases and corresponds to the first subset of SD bases and corresponds to the plurality of FD bases, while the second subset of parameters corresponds to the plurality of DD/TD bases and corresponds to a second subset of SD bases and corresponds to the plurality of FD bases. In some embodiments, a first subset of parameters has a higher priority than a second subset of parameters, where the first subset of parameters corresponds to the plurality of DD/TD bases and corresponds to the plurality of SD bases and corresponds to the first subset of FD bases, while the second subset of parameters corresponds to the plurality of DD/TD bases and corresponds to the plurality of SD bases and corresponds to a second subset of FD bases.

In this way, at least a subset of CSI information with at least a subset of DD/TD bases has a higher priority.

In some embodiments, parameters associated with a primary vector (may be one of a primary first vector, a primary second vector, and a primary third vector) may be prioritized or associated with a higher priority. One example of the primary vector is a vector corresponds to the strongest coefficient. Another example of the primary vector is a vector corresponds to the strongest amplitude coefficient. A further example of the primary vector is a vector corresponds to the maximum power. In this way, the network device may at least predict the future channel condition for the strongest beam.

Alternatively, or in addition, in some embodiments, there may be a strongest amplitude coefficient in the at least one codebook indicator, wherein the strongest amplitude coefficient may correspond to a first index of a first vector, and correspond to a second index of a second vector and correspond to a third index of a third vector. In some embodiments, the first vector with the first index may correspond to the primary vector (e.g. primary first vector). In some embodiments, the second vector with the second index may correspond to the primary vector (e.g. primary second vector). In some embodiments, the third vector with the third index may correspond to the primary vector (e.g. primary third vector).

Alternatively, in some embodiments, the parameters associated with a first set of second vectors including the primary second vector (i.e., a first set of SD bases including the primary SD) may be prioritized or associated with higher priority. In this way, some strong beams (i.e., SD bases) with at least a subset or all of complete DD/TD bases have a higher priority. For example, some strong beams (i.e. SD bases) with the plurality of DD/TD bases may be associated with higher priority.

Alternatively, in some embodiments, the parameters associated with a first set of first vectors including the primary first vector (i.e., a first set of FD bases including the primary FD) may be prioritized or associated with higher priority. In this way, some strong subband (i.e., FD bases) with at least a subset or all of complete DD/TD bases have a higher priority. For example, some strong subband (i.e. FD bases) with the plurality of DD/TD bases may be associated with higher priority.

Alternatively, in some embodiments, the parameters associated with a first set of third vectors including the primary third vector (i.e., a first set of DD bases including the primary DD) may be prioritized or associated with higher priority. In this way, some strong time/doppler domain bases (i.e., TD/DD bases) with the plurality of frequency domain bases and/or with the plurality of spatial domain bases have a higher priority.

Reference is now made to FIG. 4B and FIG. 4C. As insulated in FIG. 4B and FIG. 4C, the parameters 424 and 464 correspond to a subset of the plurality of first vectors and/or a subset of the plurality of second vectors, while the parameters 424 and 464 correspond to all of the plurality of the third bases (e.g. full DD/TD information or all of DD/TD bases).

The parameters 422 and 462 correspond to the plurality of first bases and/or the plurality of second bases (e.g. all of the plurality of SD bases and/or all of the plurality of FD bases, or e.g. full SD/FD information) at one specific time unit. For example, the DD/TD information of parameters 422 and 462 is incomplete. In case that the terminal device 220 moves at a high or medium velocity, the network device 210 cannot properly predict the further channel condition relying on the parameters 422 and 462 as lacking enough DD/TD information. By contrast, the network device 210 may properly predict the further channel condition for some SD/FD bases relying on the parameters 424 and 464.

As a result, in the specific example embodiment of FIG. 4B, the parameters 424 have higher priorities compared with the parameters 422. In the specific example embodiment of FIG. 4C, the parameters 464 have higher priorities compared with the parameters 462.

In this way, if CSI information with lower omission priority is dropped, at least some strong beam(s) (with amplitude/phase coefficients) in time domain and/or frequency domain are available.

In the following text, some examples of priority rule are listed as below for better understanding. In some embodiments, for given CSI feedback (such as, a CSI report #n), each reported element of indication fields (such as, the bitmap, the amplitude coefficients and the phase coefficients) indexed by one or more parameters as below:
r, a layer index,
i, an SD basis index (or an index of a second basis),
md, a DD/TD basis index (or an index of a third basis), and
f, an FD basis index (or an index of a first basis).

In one specific example, a priority associated with each reported element or PMI field (such as, a parameter) may be determined by below equation (3-1 or 3-1).

$$Pri ( l , i , f , md ) = 2 \cdot L \cdot {υ}_{ri} \cdot π ( f ) \cdot {\sum }_{md = 0}^{Md} ρ ( md ) + 2 \cdot L \cdot {υ}_{ri} \cdot ρ ( md ) + {υ}_{ri} \cdot i + r \qquad ( 3 - 1 )$$

$$Pri ( l , i , f , md ) = 2 \cdot L \cdot {υ}_{ri} \cdot π ( f ) \cdot max ( ρ ( md ) ) + 2 \cdot L \cdot {υ}_{ri} \cdot ρ ( md ) + {υ}_{ri} \cdot i + r \qquad ( 3 - 2 )$$

In some embodiments,

$$π ( f ) = min ( 2 \cdot {n}_{3 , r}^{( f )} , 2 \cdot ( {N}_{3} - {n}_{3 , r}^{( f )} ) - 1 ) or π ( f ) {n}_{3 , r}^{( f )}$$

or π(f)=f. In some embodiments, r=1,2, . . . , vᵣᵢ, i=0,1, . . . , 2L−1, f=0,1, . . . , Mᵥ−1, md=0,1, . . . , M_{d}−1. In some embodiments, ρ(md) may be ρ(md)=md or a permutation of md. For example,

$$ρ ( md ) = min ( 2 \cdot {n}_{4 , r}^{( md )} , 2 \cdot ( {N}_{4} - {n}_{4 , r}^{( md )} ) - 1 ) .$$

For another example,

$$ρ ( md ) = {n}_{4 , r}^{( md )} .$$

According to the above equation (3-1) or (3-1), the order of contribution for the priority (such as, a parameter) may be {an FD basis index, a DD/TD basis index, an SD basis index, a layer index}. For example, the order may be from lower priority to higher priority.

In another specific example, a priority associated with each reported element (such as, a parameter) (such as, a parameter) is determined by below equation (3-3) or (3-4).

$$Pri ( l , i , f , md ) = 2 \cdot L \cdot {υ}_{ri} \cdot {\sum }_{f = 0}^{{M}_{v}} π ( f ) \cdot ρ ( md ) + 2 \cdot L \cdot {υ}_{ri} \cdot π ( f ) \cdot + {υ}_{ri} \cdot i + r , \qquad ( 3 - 3 )$$

$$Pri ( l , i , f , md ) = 2 \cdot L \cdot {υ}_{ri} \cdot max ( π ( f ) ) \cdot ρ ( md ) + 2 \cdot L \cdot {υ}_{ri} \cdot π ( f ) \cdot + {υ}_{ri} \cdot i + r , \qquad ( 3 - 4 )$$

In some embodiments,

$$π ( f ) = min ( 2 \cdot {n}_{3 , r}^{( f )} , 2 \cdot ( {N}_{3} - {n}_{3 , r}^{( f )} ) - 1 ) or π ( f ) = {n}_{3 , r}^{( f )}$$

or π(f)=. In some embodiments, r=1,2, . . . , vᵣᵢ, i=0,1, . . . , 2L−1, f=0,1, . . . , Mᵥ−1, md=0,1, . . . , M_{d}−1. In some embodiments, ρ(md) may be ρ(md)=md or a permutation of md. For example,

$$ρ ( md ) = min ( 2 \cdot {n}_{4 , r}^{( md )} , 2 \cdot ( {N}_{4} - {n}_{4 , r}^{( md )} ) - 1 ) .$$

For another example,

$$ρ ( md ) = {n}_{4 , r}^{( md )} .$$

According to the above equation (3-3) or (3-4), the order of contribution for the priority (such as, a parameter) may be {a DD/TD basis index, an FD basis index, an SD basis index, a layer index}. For example, the order may be from lower priority to higher priority.

In some embodiments, a priority associated with each reported element (such as, a parameter) (such as, a parameter) is determined by below equation (3-5) or (3-6).

$$Pri ( l , i , f , md ) = 2 \cdot L \cdot {υ}_{ri} \cdot π ( f ) \cdot {\sum }_{md = 0}^{Md} ρ ( md ) + {υ}_{ri} \cdot {\sum }_{md = 0}^{Md} ρ ( md ) \cdot i + {υ}_{ri} \cdot ρ ( md ) + r \qquad ( 3 - 5 )$$

$$Pri ( l , i , f , md ) = 2 \cdot L \cdot {υ}_{ri} \cdot π ( f ) \cdot max ( ρ ( md ) ) + {υ}_{ri} \cdot max ( ρ ( md ) ) \cdot i + {υ}_{ri} \cdot ρ ( md ) + r . \qquad ( 3 - 6 )$$

In some embodiments,

$$π ( f ) = min ( 2 \cdot {n}_{3 , r}^{( f )} , 2 \cdot ( {N}_{3} - {n}_{3 , r}^{( f )} ) - 1 ) or π ( f ) = {n}_{3 , r}^{( f )}$$

or π(f)=f. In some embodiments, r=1,2, . . . , vᵣᵢ, i=0,1, . . . , 2L−1, f=0,1, . . . , Mᵥ−1, md=0,1, . . . , M_{d}−1. In some embodiments, ρ(md) may be ρ(md)=md or a permutation of md. For example,

$$ρ ( md ) = min ( 2 \cdot {n}_{4 , r}^{( md )} , 2 \cdot ( {N}_{4} - {n}_{4 , r}^{( md )} ) - 1 ) .$$

For another example,

$$ρ ( md ) = {n}_{4 , r}^{( md )} .$$

According to the above equation (3-5) or (3-6), the order of contribution for the priority (such as, a parameter) may be {an FD basis index, an SD basis index, a DD/TD basis index, a layer index}. For example, the order may be from lower priority to higher priority.

In some embodiments, max (ρ(md)) may be the maximum value among the values of ρ(md) with md=0,1, . . . , M_{d}−1.

In some embodiments, the terminal device 220 may calculate a priority of at least one codebook indicator (or a parameter corresponding to a layer index, a first basis index, a second basis index and a third basis index) based on an FD basis index or based on an SD basis index and calculate a further priority based on a DD/TD basis index, respectively. In some embodiments, the terminal device 220 may calculate a priority of at least one codebook indicator (or a parameter corresponding to a layer index, a first basis index, a second basis index and a third basis index) based on an FD basis index firstly and then calculate a further priority based on a DD/TD basis index, respectively.

In some embodiments, the terminal device 220 may calculate a priority of at least one codebook indicator (or a parameter corresponding to a layer index, a first basis index, a second basis index and a third basis index) based on a DD/TD basis index firstly and then calculate a further priority based on an SD basis index or based on an FD basis index, respectively.

In some embodiments, the terminal device 220 may divide at least one of a bitmap (indicating non zero amplitude coefficients and/or non-zero phase coefficients), a plurality of amplitude coefficients and a plurality of phase coefficients into two groups (e.g. a first group and a second group) based on priorities calculated based on a layer index, a first basis index and a second basis index. For example, the first group may include a first subset of bits of the bitmap, a first subset of amplitude coefficients and a first subset of phase coefficients with higher priorities, and the second group may include a second subset (or the remaining) of bits of the bitmap, a second subset (or the remaining) of amplitude coefficients and a second subset (or the remaining) of phase coefficients with lower priorities.

In some embodiments, the terminal device 220 may divide the first group into two sub-groups (e.g. a first sub-group and a second sub-group) based on priorities calculated based on a third basis index and/or at least one of a layer index, a first basis index and a second basis index. In some embodiments, the terminal device 220 may divide the second group into two sub-groups (e.g. a third sub-group and a fourth sub-group) based on priorities calculated based on a third basis index and/or at least one of a layer index, a first basis index and a second basis index.

For example, the first sub-group may include a first sub-group of the first subset of bits of the bitmap, a first sub-group of the first subset of amplitude coefficients and a first sub-group of the first subset of phase coefficients with higher priorities, and the second sub-group may include a second sub-group (or the remaining) of the first subset of bits of the bitmap, a second sub-group (or the remaining) of the first subset of amplitude coefficients and a second sub-group (or the remaining) of the first subset of phase coefficients with lower priorities. For another example, the third sub-group may include a first sub-group of the second subset of bits of the bitmap, a first sub-group of the second subset of amplitude coefficients and a first sub-group of the second subset of phase coefficients with higher priorities, and the fourth sub-group may include a second sub-group (or the remaining) of the second subset of bits of the bitmap, a second sub-group (or the remaining) of the second subset of amplitude coefficients and a second sub-group (or the remaining) of the second subset of phase coefficients with lower priorities.

In some embodiments, the terminal device 220 may calculate a priority based on a layer index, an SD basis index and an FD basis index for the first group and second group by below equation (4-1).

$$Pri ( l , i , f ) = 2 \cdot L \cdot {υ}_{ri} \cdot π ( f ) + {υ}_{ri} \cdot i + r \qquad ( 4 - 1 )$$

In some embodiments, the terminal device 220 may calculate a priority for the first sub-group and the second sub-group and/or a priority for the third sub-group and the fourth sub-group based on a DD/TD basis index by below equation (4-2) or (4-3).

$$Pri ( l , i , md ) = 2 \cdot L \cdot {υ}_{ri} \cdot ρ ( md ) + {υ}_{ri} \cdot i + r \qquad ( 4 - 2 )$$

$$Pri ( md ) = ρ ( md ) \qquad ( 4 - 3 )$$

In some embodiments, the terminal device 220 may calculate a priority based on a layer index, an SD basis index and a DD/TD basis index for the first group and second group by below equation (4-4).

$$Pri ( l , i , f ) = 2 \cdot L \cdot {υ}_{ri} \cdot ρ ( md ) + {υ}_{ri} \cdot i + r \qquad ( 4 - 4 )$$

In some embodiments, the terminal device 220 may calculate a priority for the first sub-group and the second sub-group and/or a priority for the third sub-group and the fourth sub-group based on an FD basis index by below equation (4-5) or (4-6).

$$Pri ( l , i , f ) = 2 \cdot L \cdot {υ}_{ri} \cdot π ( f ) + {υ}_{ri} \cdot i + r \qquad ( 4 - 5 )$$

$$Pri ( f ) = π ( f ) \qquad ( 4 - 6 )$$

In some embodiments, the terminal device 220 may calculate a priority based on a layer index, an FD basis index and a DD/TD basis index for the first group and second group by below equation (4-7) or (4-8) or (4-9) or (4-10) or (3-1) or (3-2) or (3-3) or (3-4) or (3-5) or (3-6).

$$Pri ( l , f , md ) = {υ}_{ri} \cdot π ( f ) \cdot {\sum }_{md = 0}^{Md} ρ ( md ) + {υ}_{ri} \cdot ρ ( md ) + r \qquad ( 4 - 7 )$$

$$Pri ( l , f , md ) = {υ}_{ri} \cdot π ( f ) \cdot max ( ρ ( md ) ) + {υ}_{ri} \cdot ρ ( md ) + r \qquad ( 4 - 8 )$$

$$Pri ( l , f , md ) = {υ}_{ri} \cdot {\sum }_{f = 0}^{Mv} π ( f ) \cdot ρ ( md ) + {υ}_{ri} \cdot π ( f ) + r \qquad ( 4 - 9 )$$

$$Pri ( l , f , md ) = {υ}_{ri} \cdot max ( π ( f ) ) \cdot ρ ( md ) + {υ}_{ri} \cdot π ( f ) + r , \qquad ( 4 - 10 )$$

In some embodiments, the terminal device 220 may calculate a priority for the first sub-group and the second sub-group and/or a priority for the third sub-group and the fourth sub-group based on an SD basis index by below equation (4-11) or (4-12).

$$Pri ( l , i , f ) = 2 \cdot L \cdot {υ}_{ri} \cdot π ( f ) + {υ}_{ri} \cdot i + r \qquad ( 4 - 11 )$$

$$Pri ( i ) = i \qquad ( 4 - 12 )$$

In one specific example embodiment, the terminal device 220 may firstly calculate priorities based on the FD basis index and/or SD basis index and/or layer index. Based on the calculated priorities, the parameters may be divided into a highest/higher FD priority group (be presented as group #1) and a lowest/lower FD priority group (be presented as group #2). For each of the group #1 and group #2, the terminal device 220 may further calculate priorities based on the DD/TD basis index. For example, based on the calculated priorities, the parameters may be divided into a first sub-group (be represented as group #1-1) (for example, a sub-group with a highest/higher FD priority and a highest/higher DD priority), a second sub-group (be represented as group #1-2) (for example, a sub-group with a highest/higher FD priority and a lowest/lower DD priority), a third sub-group (be represented as group #2-1) (for example, a sub-group with a lowest/lower FD priority and a highest/higher DD priority) and a fourth sub-group (be represented as group #2-2) (for example, a sub-group with a lowest/lower FD priority and a lowest/lower DD priority).

In some embodiments, the terminal device 220 may calculate a priority based on an FD basis index by below equation (5).

$$Pri ( l , i , f ) = 2 \cdot L \cdot {υ}_{ri} \cdot π ( f ) + {υ}_{ri} \cdot i + r \qquad ( 5 )$$

The terminal device 220 also calculates a priority based on a DD/TD basis index by below equation (6) or (4-3).

$$Pri ( l , i , md ) = 2 \cdot L \cdot {υ}_{ri} \cdot ρ ( md ) + {υ}_{ri} \cdot i + r \qquad ( 6 )$$

In one specific example embodiment, the terminal device 220 may firstly calculate priorities based on the DD/TD basis index and/or SD basis index and/or layer index. Based on the calculated priorities, the parameters may be divided into a highest/higher DD/TD priority group (be presented as group #1) and a lowest/lower DD/TD priority group (be presented as group #2). For each of the group #1 and group #2, the terminal device 220 may further calculate priorities based on the FD basis index. For example, based on the calculated priorities, the parameters may be divided into a first sub-group (be represented as group #1-1) (for example, a sub-group with a highest/higher DD/TD or SD priority and a highest/higher FD priority), a second sub-group (be represented as group #1-2) (for example, a sub-group with a highest/higher DD/TD or SD priority and a lowest/lower FD priority), a third sub-group (be represented as group #2-1) (for example, a sub-group with a lowest/lower DD/TD or SD priority and a highest/higher FD priority) and a fourth sub-group (be represented as group #2-2) (for example, a sub-group with a lowest/lower DD/TD or SD priority and a lowest/lower FD priority).

In one specific example embodiment, the terminal device 220 may firstly calculate priorities based on the DD/TD basis index and/or FD basis index and/or layer index. Based on the calculated priorities, the parameters may be divided into a highest/higher DD/TD or FD or layer priority group (be presented as group #1) and a lowest/lower DD/TD or FD or layer priority group (be presented as group #2). For each of the group #1 and group #2, the terminal device 220 may further calculate priorities based on the SD basis index. For example, based on the calculated priorities, the parameters may be divided into a first sub-group (be represented as group #1-1) (for example, a sub-group with a highest/higher FD or DD/TD priority and a highest/higher SD priority), a second sub-group (be represented as group #1-2) (for example, a sub-group with a highest/higher FD or DD/TD priority and a lowest/lower SD priority), a third sub-group (be represented as group #2-1) (for example, a sub-group with a lowest/lower FD or DD/TD priority and a highest/higher SD priority) and a fourth sub-group (be represented as group #2-2) (for example, a sub-group with a lowest/lower FD or DD/TD priority and a lowest/lower SD priority).

In one specific example embodiment, the terminal device 220 may firstly calculate priorities based on the SD basis index and/or layer index. Based on the calculated priorities, the parameters may be divided into a highest/higher SD or layer priority group (be presented as group #1) and a lowest/lower SD or layer priority group (be presented as group #2). For each of the group #1 and group #2, the terminal device 220 may further calculate priorities based on the FD basis index and/or the DD/TD basis index. For example, based on the calculated priorities, the parameters may be divided into a first sub-group (be represented as group #1-1) (for example, a sub-group with a highest/higher SD or layer priority and a highest/higher FD or DD/TD priority), a second sub-group (be represented as group #1-2) (for example, a sub-group with a highest/higher SD or layer priority and a lowest/lower FD or DD/TD priority), a third sub-group (be represented as group #2-1) (for example, a sub-group with a lowest/lower SD or layer priority and a highest/higher FD or DD/TD priority) and a fourth sub-group (be represented as group #2-2) (for example, a sub-group with a lowest/lower SD or layer priority and a lowest/lower FD or DD/TD priority).

In one specific example embodiment, the terminal device 220 may firstly calculate priorities based on the FD basis index and/or layer index. Based on the calculated priorities, the parameters may be divided into a highest/higher FD or layer priority group (be presented as group #1) and a lowest/lower FD or layer priority group (be presented as group #2). For each of the group #1 and group #2, the terminal device 220 may further calculate priorities based on the SD basis index and/or the DD/TD basis index. For example, based on the calculated priorities, the parameters may be divided into a first sub-group (be represented as group #1-1) (for example, a sub-group with a highest/higher FD or layer priority and a highest/higher SD or DD/TD priority), a second sub-group (be represented as group #1-2) (for example, a sub-group with a highest/higher FD or layer priority and a lowest/lower SD or DD/TD priority), a third sub-group (be represented as group #2-1) (for example, a sub-group with a lowest/lower FD or layer priority and a highest/higher SD or DD/TD priority) and a fourth sub-group (be represented as group #2-2) (for example, a sub-group with a lowest/lower FD or layer priority and a lowest/lower SD or DD/TD priority).

In one specific example embodiment, the terminal device 220 may firstly calculate priorities based on the DD/TD basis index and/or layer index. Based on the calculated priorities, the parameters may be divided into a highest/higher DD/TD or layer priority group (be presented as group #1) and a lowest/lower DD/TD or layer priority group (be presented as group #2). For each of the group #1 and group #2, the terminal device 220 may further calculate priorities based on the FD basis index and/or the SD basis index. For example, based on the calculated priorities, the parameters may be divided into a first sub-group (be represented as group #1-1) (for example, a sub-group with a highest/higher DD/TD or layer priority and a highest/higher FD or SD priority), a second sub-group (be represented as group #1-2) (for example, a sub-group with a highest/higher DD/TD or layer priority and a lowest/lower FD or SD priority), a third sub-group (be represented as group #2-1) (for example, a sub-group with a lowest/lower DD/TD or layer priority and a highest/higher FD or SD priority) and a fourth sub-group (be represented as group #2-2) (for example, a sub-group with a lowest/lower DD/TD or layer priority and a lowest/lower FD or SD priority).

In some embodiments, the parameters may be divided into four groups as below:
Group #1-1: parameters with a highest FD priority and a highest DD/TD priority,
Group #1-2: parameters with a highest FD priority and a lowest DD/TD priority,
Group #2-1: parameters with a lowest FD priority and a highest DD/TD priority,
Group #2-2: parameters with a lowest FD priority and a lowest DD/TD priority.

In another specific example embodiment, the terminal device 220 firstly calculates priorities based on the DD/TD basis index. Based on the calculated priorities, the parameters may be divvied into a highest DD/TD priority group (be presented as group #1) and a lowest DD/TD priority group (be presented as group #2). For each of the group #1 and group #2, the terminal device 220 further calculates priorities based on the FD basis index. In some embodiments, the parameters may be divided into four groups as below:
Group #1-1: parameters with a highest DD/TD priority and a highest FD priority,
Group #1-2: parameters with a highest DD/TD priority and a lowest FD priority,
Group #2-1: parameters with a lowest DD/TD priority and a highest FD priority,
Group #2-2: parameters with a lowest DD/TD priority and a lowest FD priority,

In some embodiments, the terminal device 220 may firstly calculate priorities based on a first basis index (or a second basis index or a third basis index) and/or layer index. Based on the calculated priorities, the parameters may be divided into a highest/higher priority group (be presented as group #1) and a lowest/lower priority group (be presented as group #2). For each of the group #1 and group #2, the terminal device 220 may secondly calculate priorities based on a second basis index (or a third basis index or a first basis index). For example, based on the calculated priorities, the parameters may be divided into a first sub-group (be represented as group #1-1), a second sub-group (be represented as group #1-2), a third sub-group (be represented as group #2-1) and a fourth sub-group (be represented as group #2-2).

Further, for each of the sub-group #1-1, sub-group #1-2, sub-group #2-1 and sub-group #2-2, the terminal device 220 may thirdly calculate priorities based on a third basis index (or a first basis index or a second basis index). For example, based on the calculated priorities, the parameters may be divided into a first subset (be represented as group #1-1-1), a second subset (be represented as group #1-1-2), a third subset (be represented as group #1-2-1), a fourth subset (be represented as group #1-2-2), a fifth subset (be represented as group #2-1-1), a sixth subset (be represented as group #2-1-2), a seventh subset (be represented as group #2-2-1) and an eighth subset (be represented as group #2-2-2).

It is to be understood that all the above discussed example embodiments are only for the purpose of illustration without suggesting any limitations. The specific manner for determining the priority may be modified based on the teaching of the above discussed example embodiments, such modified embodiment should also be considered within the scope of this disclosure.

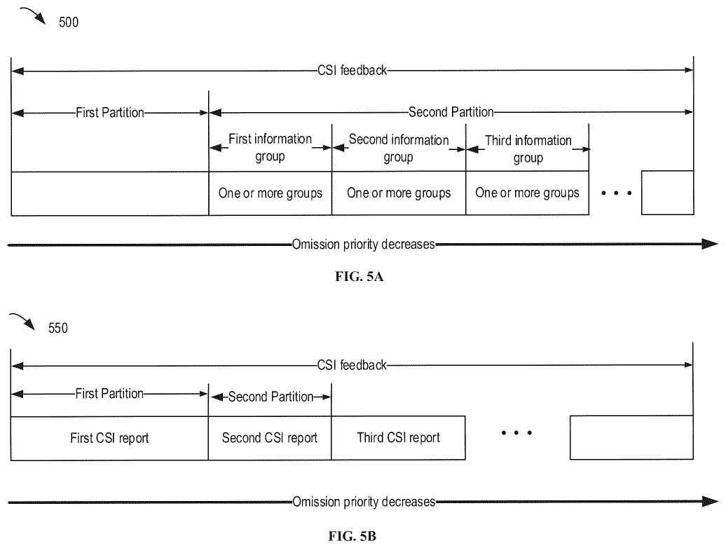

As discussed above, the CSI feedback comprising a plurality of partitions with different omission priorities. FIG. 5A and FIG. 5B illustrate example blocks of CSI feedback 500 and 550 according to some embodiments of the present disclosure. It is to be understood that the specific structures illustrated in FIG. 5A and FIG. 5B are only for the purpose of illustration without suggesting any limitations. In other words, the numbers of partitions, information groups may be changed in the other example embodiments.

In the following text, examples regarding how to include the parameters into different partitions of the CSI feedback will be discussed with reference to FIG. 5A and FIG. 5B.

It is to be clarified that the following examples are discussed only for the purpose of illustration without suggesting any limitations. Moreover, although some specific parameters are discussed to be included in some specific partitions, in the other embodiments, all the discussed parameters and the discussed partitions may be changed based on the teaching of the below discussed example embodiments, such changes should also be considered within the scope of this disclosure.

As illustrated in FIG. 5A and FIG. 5B, the CSI feedback at least comprises a first partition (such as, CSI part 1) and a second partition (such as, CSI part 2). In some embodiments, the first partition is configured with a higher omission priority compared with the second partition. Alternatively, or in addition, in some embodiments, a payload size of the second partition is based on at least one indication in the first partition. Alternatively, or in addition, in some embodiments, a second partition comprises a plurality of information groups, a first information group of the plurality of information groups is configured with a higher omission priority compared with the other information groups of the plurality of information groups.

In some embodiments, the number of information groups comprised in the second partition may be larger than or equal to three. In case that the number of information groups is equal to 3, the CSI feedback may reuse the structure of current CSI report. Alternatively, in case that the number of information groups is larger than three, the structure of the CSI feedback may be more feasible.

Because the first partition or the first information group of the second partition has a relative higher omission priority, some relative important parameters may be included the first partition or the first information group.

Examples of the relative important parameters include but are not limited to:
an indication indicating whether the CSI feedback is associated with a third vector (such as, DD/TD basis) or whether a DD/TD compression is enabled,
a CQI set corresponding to a specific time unit,
an index of the specific time unit,
a first number of non-zero coefficients corresponding to a primary vector,
an index of the primary basis,
a total number of non-zero coefficients,
a length of the plurality of third vectors, or
the number of the plurality of third vectors.

In case that the relative important parameters are included in the first partition, the relative important parameters may enjoy the highest omission priority. In case that the relative important parameters are included in the first information group of the second partition, the first partition of the CSI feedback may reuse the current structure of CSI part 1.

In some embodiment, the first information group of the second partition may further indicates a strongest coefficient for a layer corresponding to the primary vector.

In some embodiments, non-zero coefficient information also may be included in the other information groups (i.e., rather than the first information group, such as, the second information group and the third information group as shown in FIG. 5A) of the second partition. In some embodiment, the non-zero coefficient information indicates a bitmap indicating related non-zero coefficients, amplitude coefficients corresponding to the related non-zero coefficients, or phase coefficients corresponding to the related non-zero coefficients.

Additionally, the related non-zero coefficients may associate with any of a primary first vector (i.e., a primary FD basis), a primary second vector (i.e., a primary SD basis), a primary third vector (i.e., a primary DD/TD basis).

Alternatively, the related non-zero coefficients may associate with any of a subset of the plurality of the first vectors with the primary first vector included or excluded (i.e., a subset of FD bases with primary FD included or excluded), a subset of the plurality of the second vectors with the primary second vector included or excluded (i.e., a subset of SD bases with primary DD included or excluded), a subset of the plurality of the third vectors with the primary third vector included or excluded (i.e., a subset of TD/DD bases with primary TD/DD included or excluded).

Alternatively, the related non-zero coefficients may associate with any of the plurality of first vectors (i.e., all the FD bases), the plurality of second vectors (i.e., all the is SD bases), and the plurality of third vectors (i.e., all the DD/TD bases).

Further, the non-zero coefficients associated with one specific vector/vector set may have different priority levels. In this event, parameters with different priority levels while associated with the same vector/vector set may be included into different information groups.

As one specific example, the other information groups comprise a second information group and a third information group with a lower omission priority compared with the second information group, as shown in FIG. 5A. In this event, the second information group indicates first non-zero coefficient information corresponding to non-zero coefficients with higher priorities, and the third information group indicates second non-zero coefficient information corresponding to non-zero coefficients with lower priorities.

For better understanding, some examples regarding the CSI feedback are illustrated as below. In the following text, different partitions/information groups may be discussed separately, which causes that some parameters are included in more than one discussed partitions/information groups. However, it does not mean that such parameters need to be transmitted more than once, while it means that such parameters may be included in any of the partitions/information groups. In other words, in general rule for including the parameters into the partitions/information groups is that the parameters included in different partitions/information groups should not be overlapped or be repeated.

In some embodiments, the first partition (such as, CSI part 1) may indicate at least one of the following parameters:
An indication indicating a DD/TD basis type or whether DD/TD compression (if reported). Specifically, if the indication indicates that the CSI feedback is associated with a DD/TD basis (or with DD/TD compression), the priority rules discussed in the present discourse would be applied;
A first set of CQI (including wideband CQI and/or a first set of sub-bands differential CQI) corresponding to a first time unit in case of multiple sets of CQIs (corresponding to multiple time units) are reported;
The index of the first time unit;
An indication of the overall number of non-zero amplitude/phase coefficients across layers corresponding to each one of DD/TD bases or FD bases or SD bases

$$( e . g . , {K}_{S}^{NZ} ) ,$$

where the total number of non-zero amplitude/phase coefficients across layers may be a sum of

$${K}_{S}^{NZ}$$

The (relative) index of the first DD/TD basis (i.e., a primary third vector) or the first FD basis (i.e., a primary first vector) or the first SD basis (i.e., a primary second vector) may be included in CSI part 1. The first DD/TD basis/FD basis/SD basis corresponds to the strongest coefficient;
The length of the DD/TD basis, N4, which is configured by the network device 210 or reported by the terminal device 220. There may be N4 time unit indexes;
The number of bases, M_{d}, which is configured by the network device 210 or reported by the terminal device 220;
Rank Indicator (such as, vᵣᵢ),
one set of CQI (including wideband CQI and/or a first set of sub-bands differential CQI) (if only one set of CQI is reported);
An indication of the overall number of non-zero amplitude/phase coefficients across layers corresponding to the plurality of TRPs (such as,

$${K}^{NZ} ) .$$

In some embodiments, the first information group of the second partition (such as, group 0 of CSI part 2) may indicate at least one of the following parameters:
Strongest coefficient for each layer corresponding to the first/primary DD/TD basis (i.e., a primary third vector) or the first/primary FD basis (i.e., a primary first vector) or the first/primary SD basis (i.e., a primary second vector) may be included in CSI part 1. The first DD/TD basis/FD basis/SD basis corresponds to the strongest coefficient,
Relative strongest coefficient indication for each layer corresponding to each one of the subset of DD/TD bases (i.e., the subset of TD/DD bases with the first TD/DD basis excluded),
   The final value of amplitude coefficient and/or phase coefficient of the strongest coefficient corresponding to each one of the subset of doppler/time bases may be based on the reported value (i.e. not assumed to be 1),
   The amplitude coefficient and/or phase coefficient of the strongest coefficient has higher priority,
SD basis indicator (i.e., i_{1,2}) corresponding to the plurality of TRPs,
SD rotation factors (i.e., i_{1,1}) corresponding to the plurality of TRPs, and
Strongest coefficient for each layer.

In some embodiments, one of the other information groups (such as, the second information group, for example, group 1 of CSI part 2) may indicate at least one of the following parameters/elements:
Relative co-phasing coefficient and/or relative amplitude coefficient between DD/TD bases (or corresponding to the subset of TD/DD bases with the first TD/DD basis excluded),
   Phase coefficients and/or amplitude coefficients corresponding to each one of the subset of DD/TD bases may be differential based on the relative co-phasing coefficient and/or relative amplitude coefficient,
Relative strongest coefficient indication for each layer corresponding to each one of the subset of DD/TD bases (the subset of TD/DD bases with the first TD/DD basis excluded) (in case of per basis SCI reporting)
   The final value of amplitude coefficient and/or phase coefficient of the strongest coefficient corresponding to each one of the subset of TD/DD bases may be based on the reported value (i.e. not assumed to be 1),
   The amplitude coefficient and/or phase coefficient of the strongest coefficient has higher priority,
A DD/TD basis indicator (for each layer),
An initial index for DD/FD basis window (if needed).

In the following, some examples are discussed with regards to FD bases. It is to be understood that the examples of discussed with regards to FD bases are also suitable for DD/TD bases/SD bases. Merely for brevity, similar contents are omitted here.

As discussed above, the non-zero coefficient information may be indicated in other information groups (i.e., rather than the first information group, such as, the second information group and the third information group as shown in FIG. 5A). In the following, some examples for the other information groups will be discussed.

In some embodiments, one other information group (such as, the second information group, for example, group 1 of CSI part 2) may indicate at least one of the following parameters/elements:
A plurality of highest priority elements of a bitmap (i_{1,7,r}) (corresponding to the plurality of FD bases, i.e., all the FD bases),
   where the bitmap is to indicate whether the corresponding amplitude/phase coefficient corresponding to the plurality of FD bases is reported, and the field size may be 2*L*vᵣᵢ*Mᵥ*M_{d},
   where the number of the plurality of highest priority elements of the bitmap may be Y_{1_1_1}, e.g. Y_{1_1_1}=2*L*vᵣᵢ*M_{y}*M_{d}−└K^{NZ}/2┘,
A plurality of highest priority elements of an amplitude coefficient indicator (i_{2,4,r}) (e.g. a subset of a plurality of amplitude coefficients corresponding to the plurality of FD bases),
   where the number of the plurality of highest priority elements of the subset of the plurality of amplitude coefficients may be Y_{2_1_1}, e.g.

$${Y}_{2 \_ 1 \_ 1} = max ( 0 , ⌈ \frac{{K}^{NZ}}{2} ⌉ - {v}_{ri} ) ,$$

A plurality of highest priority elements of a phase coefficient indicator (i_{2,5,r}) (e.g. a subset of a plurality of phase coefficients corresponding to the plurality of FD bases),
   where the number of the plurality of highest priority elements of the subset of the plurality of phase coefficients may be Y_{3_1_1}, e.g.

$${Y}_{3 \_ 1 \_ 1} = max ( 0 , ⌈ \frac{{K}^{NZ}}{2} ⌉ - {v}_{ri} ) .$$

In this way, the highest priority of the plurality of FD bases may be prioritized.

Alternatively, in some embodiments, one other information group (such as, the second information group, for example, group 1 of CSI part 2) may indicate at least one of the following parameters/elements:
A plurality of highest priority elements of a bitmap (i_{1,7,r,s}) (corresponding to the first FD basis, i.e., the primary first vector),
   where the bitmap is to indicate whether the corresponding amplitude/phase coefficient corresponding to the first TRP is reported, and the field size may be 2*L*vᵣᵢ*M_{d},
   where the number of the plurality of highest priority elements of the bitmap may be Y1_2_1, e.g. Y1_2_1=2*L*vᵣᵢ*M_{d}−└K₁^{NZ}/2┘,
A plurality of highest priority elements of an amplitude coefficient indicator (i_{2,4,rs}) (e.g. a subset of a plurality of amplitude coefficients corresponding to the first FD basis),
   where the number of the plurality of highest priority elements of the subset of the plurality of amplitude coefficients may be Y_{2_2_1}, e.g.

$${Y}_{2 \_ 2 \_ 1} = max ( 0 , ⌈ \frac{{K}_{S}^{NZ}}{2} ⌉ - {v}_{ri} ) ,$$

A plurality of highest priority elements of a phase coefficient indicator (i_{2,5,r,s}) (e.g. a subset of a plurality of phase coefficients corresponding to the first FD basis),
   where the number of the plurality of highest priority elements of the subset of the plurality of phase coefficients may be Y_{3_2_1}, e.g.

$${Y}_{3 \_ 2 \_ 1} = max ( 0 , ⌈ \frac{{K}_{S}^{NZ}}{2} ⌉ - {v}_{ri} ) .$$

In this way, all the non-zero coefficient information with a highest priority of the first FD may be prioritized.

Alternatively, in some embodiments, one other information group (such as, the second information group, for example, group 1 of CSI part 2) may indicate at least one of the following parameters/elements:
All parameters of the bitmap (i_{1,7,r,s}) (corresponding to the first FD basis),
   where the bitmap is to indicate whether the corresponding amplitude/phase coefficient corresponding to the first FD basis is reported, and the field size may be 2*L*vᵣᵢ*M_{d},
The amplitude coefficient indicator (i_{2,4,r,s}) (e.g. the plurality of amplitude coefficients corresponding to the first FD basis),
   where the number of the plurality of amplitude coefficients may be Y_{2_4_1}, e.g.

$${Y}_{2 \_ 4 \_ 1} = {K}_{S}^{NZ} - {v}_{ri} or max ( 0 , {K}_{S}^{NZ} - {v}_{ri} ) ,$$

The phase coefficient indicator (i_{2,5,r,s}) (e.g. the plurality of phase coefficients corresponding to the first FD basis),
   where the number of the plurality of phase coefficients may be Y_{3_4_1}, e.g

$${Y}_{3 \_ 4 \_ 1} = {K}_{S}^{NZ} - {v}_{ri} or max ( 0 , {K}_{S}^{NZ} - {v}_{ri} ) .$$

In this way, all the parameters associated with the primary FD basis may be prioritized.

Alternatively, in some embodiments, one other information group (such as, the second information group, for example, group 1 of CSI part 2) may indicate at least one of the following parameters/elements:
A bitmap (i_{1,7,r,t1}) (corresponding to the first set of FD bases, i.e., a set of FD bases including the first/primary FD basis),
   where the bitmap is to indicate whether the corresponding amplitude/phase coefficient corresponding to the first set of FD bases is reported, and the field size may be

$$2 * L * ⌈ \frac{{M}_{v}}{2} ⌉ * {v}_{ri} * {M}_{d} or 2 * {L}_{t} * ⌈ \frac{{M}_{v}}{2} ⌉ * {v}_{ri} * {M}_{d} ,$$

An amplitude coefficient indicator (i_{2,4,r,t1}) (e.g. a plurality of amplitude coefficients corresponding to the first set of FD bases),
   where the number of the plurality of amplitude coefficients may be Y_{2_5_1}, e.g.

$${Y}_{2 \_ 5 \_ 1} = {K}_{t 1}^{NZ} - {v}_{ri} or max ( 0 , {K}_{t 1}^{NZ} - {v}_{ri} ) ,$$

$${K}^{NZ} = {K}_{t 1}^{NZ} + {K}_{t 2}^{NZ} ,$$

A phase coefficient indicator (i_{2,5,r,t1}) (e.g. a plurality of phase coefficients corresponding to the first set of FD bases),
   where the number of the plurality of phase coefficients may be Y_{3_5_1}, e.g.

$${Y}_{3 \_ 5 \_ 1} = {K}_{t 1}^{NZ} - {v}_{ri} or max ( 0 , {K}_{t 1}^{NZ} - {v}_{ri} ) .$$

An FD basis indicator for each layer (i_{1,6,r}),
An initial index for FD basis window (i_{1,5}), and
A reference amplitude for weaker polarization for each layer (i_{2,3,r}).

In this way, all the parameters associated with a set of FD basis including the first/primary FD basis may be prioritized.

In some embodiments, one other information group (such as, the third information group, for example, group 2 of CSI part 2) may indicate at least one of the following parameters/elements:
A plurality of lowest priority elements of the first bitmap (i_{1,7,r}) (corresponding to the plurality of FD bases, i.e., all the FD bases),
   where the bitmap is to indicate whether the corresponding amplitude/phase coefficient corresponding to the plurality of FD bases is reported, and the field size may be 2*L*vᵣᵢ*Mᵥ*M_{d},
   where the number of the plurality of lowest priority elements of the bitmap may be Y_{1_1_2}, e.g. Y_{1_1_2}=└K^{NZ}/2┘,
A plurality of lowest priority elements of the amplitude coefficient indicator (i_{2,4,r}) (e.g. a subset of the plurality of amplitude coefficients corresponding to the plurality of FD bases),
   where the number of the plurality of lowest priority elements of the subset of the plurality of amplitude coefficients may be Y_{2_1_2}, e.g.

$${Y}_{2 \_ 1 \_ 2} = min ( {K}^{NZ} - {v}_{ri} , ⌊ \frac{{K}^{NZ}}{2} ⌋ ) ,$$

A plurality of lowest priority elements of the phase coefficient indicator (i_{2,5,r}) (e.g. a subset of the plurality of phase coefficients corresponding to the plurality of FD bases),
   where the number of the plurality of lowest priority elements of the subset of the plurality of phase coefficients may be Y_{3_1_2}, e.g.

$${Y}_{3 \_ 1 \_ 2} = min ( {K}^{NZ} - {v}_{ri} , ⌊ \frac{{K}^{NZ}}{2} ⌋ ) .$$

Alternatively, in some embodiments, one other information group (such as, the third information group, for example, group 2 of CSI part 2) may indicate at least one of the following parameters/elements:
A plurality of lowest priority elements of the bitmap (i_{1,7,r,s}) (corresponding to the first FD basis),
   where the bitmap is to indicate whether the corresponding amplitude/phase coefficient corresponding to the first TRP is reported, and the field size may be 2*L*vᵣᵢ*M_{d},
   where the number of the plurality of lowest priority elements of the bitmap may be

$${Y}_{1 \_ 2 \_ 2} , e . g . {Y}_{1 \_ 2 \_ 2} = ⌊ {K}_{s}^{NZ} / 2 ⌋ ,$$

A plurality of lowest priority elements of the amplitude coefficient indicator (i_{2,4,r,s}) (e.g. a subset of the plurality of amplitude coefficients corresponding to the first FD basis),
   where the number of the plurality of lowest priority elements of the subset of the plurality of amplitude coefficients may be Y_{2_2_2}, e.g.

$${Y}_{2 \_ 2 \_ 2} = min ( {K}_{s}^{NZ} - {v}_{ri} , ⌊ \frac{{K}_{s}^{NZ}}{2} ⌋ ) ,$$

A plurality of lowest priority elements of the phase coefficient indicator (i_{2,5,r,s}) (e.g. a subset of the plurality of phase coefficients corresponding to the first FD basis),
   where the number of the plurality of lowest priority elements of the subset of the plurality of phase coefficients may be Y_{3_2_2}, e.g.

$${Y}_{3 \_ 2 \_ 2} = min ( {K}_{s}^{NZ} - {v}_{ri} ⌊ \frac{{K}_{s}^{NZ}}{2} ⌋ ) ,$$

Alternatively, in some embodiments, one other information group (such as, the third information group, for example, group 2 of CSI part 2) may indicate at least one of the following parameters/elements:
A plurality of highest priority elements of a third bitmap (i_{1,7,r,t}) (corresponding to the subset of FD bases, i.e., a set of FD bases with the first FD excluded),
   where the bitmap is to indicate whether the corresponding amplitude/phase coefficient corresponding to the subset of TRPs is reported, and the field size may be 2*L*vᵣᵢ*(Mᵥ−1)*M_{d},
   where the number of the plurality of highest priority elements of the bitmap may be Y_{1_3_1}, e.g

$${Y}_{1 \_ 3 \_ 1} = 2 * L * {v}_{ri} * ( {M}_{v} - 1 ) * {M}_{d} - ⌊ {K}_{Mv - 1}^{NZ} / 2 ⌋ ,$$

A plurality of highest priority elements of an amplitude coefficient indicator (i_{2,4,r,t}) (e.g. a subset of a plurality of amplitude coefficients corresponding to the subset of FD bases),
   where the number of the plurality of highest priority elements of the subset of the plurality of amplitude coefficients may be Y_{2_3_1}, e.g.

$${Y}_{2 \_ 3 \_ 1} ⌈ \frac{{K}_{N - 1}^{NZ}}{2} ⌉ ,$$

A plurality of highest priority elements of a phase coefficient indicator (i_{2,5,r,t}) (e.g. a subset of a plurality of phase coefficients corresponding to the subset of FD bases),
   where the number of the plurality of highest priority elements of the subset of the plurality of phase coefficients may be Y_{3_3_1}, e.g.

$${Y}_{3 \_ 3 \_ 1} = ⌈ \frac{{K}_{N - 1}^{NZ}}{2} ⌉ .$$

Alternatively, in some embodiments, one other information group (such as, the third information group, for example, group 2 of CSI part 2) may indicate at least one of the following parameters/elements:
The bitmap (i_{1,7,r,t}) (corresponding to the subset of FD bases, i.e., a set of FD bases with the first FD excluded),
   where the bitmap is to indicate whether the corresponding amplitude/phase coefficient corresponding to the subset of TRPs is reported, and the field size may be 2*L*vᵣᵢ*(Mᵥ−1)*M_{d},
The amplitude coefficient indicator (i_{2,4,r,t}) (e.g. the plurality of amplitude coefficients corresponding to the subset of FD bases),
   where the number of the plurality of amplitude coefficients may be Y_{2_4_2}, e.g

$${Y}_{2 \_ 4 \_ 2} = {K}_{Mv - 1}^{NZ} ,$$

The phase coefficient indicator (i_{2,5,r,t}) (e.g. the plurality of phase coefficients corresponding to the subset of FD bases),
   where the number of the plurality of phase coefficients may be Y_{3_4_2}, e.g.

$${Y}_{2 \_ 4 \_ 2} = {K}_{Mv - 1}^{NZ} .$$

Alternatively, in some embodiments, one other information group (such as, the third information group, for example, group 2 of CSI part 2) may indicate at least one of the following parameters/elements:
A bitmap (i_{1,7,r,t2}) (corresponding to the second set of FD bases different from a first set of FD bases, the first set of FD bases comprising the first FD basis),
   where the bitmap is to indicate whether the corresponding amplitude/phase coefficient corresponding to the second set of FD bases is reported, and the field size may be

$$2 * L * ⌊ \frac{{M}_{v}}{2} ⌋ * {v}_{ri} * {M}_{d} or 2 * L * ⌈ \frac{{M}_{v}}{2} ⌉ * {v}_{ri} * {M}_{d} ,$$

An amplitude coefficient indicator (i_{2,4,r,t2}) (e.g. a plurality of amplitude coefficients corresponding to the second set of FD bases),
   where the number of the plurality of amplitude coefficients may be Y_{2_5_2}, e.g.

$${Y}_{2 \_ 5 \_ 2} = {K}_{t 2}^{NZ} ,$$

A phase coefficient indicator (i_{2,5,r,t2}) (e.g. a plurality of phase coefficients corresponding to the second set of FD bases),
   where the number of the plurality of phase coefficients may be Y_{3_5_2}, e.g.

$${Y}_{3 \_ 5 \_ 2} = {K}_{t 2}^{NZ} .$$

As discussed above, the number of the information groups may be larger than three. In the following, some examples are discussed in case that the number of the information groups is larger than three.

In some embodiments, one other information group (such as, the fourth information group, for example, group 3 of CSI part 2) may indicate at least one of the following parameters/elements:
A plurality of lowest priority elements of the third bitmap (i_{1,7,r,t}) (corresponding to the subset of FD bases, i.e., a set of FD bases with the first FD excluded),
   where the bitmap is to indicate whether the corresponding amplitude/phase coefficient corresponding to the subset of TRPs is reported, and the field size may be 2*L*vᵣᵢ*(Mᵥ−1)*M_{d},
   where the number of the plurality of lowest priority elements of the bitmap may be Y_{1_3_2}, e.g.

$${Y}_{1 \_ 3 \_ 2} = ⌊ \frac{{K}_{Mv - 1}^{NZ}}{2} ⌋ ,$$

A plurality of lowest priority elements of the amplitude coefficient indicator (i_{2,4,r,t}) (e.g. a subset of the plurality of amplitude coefficients corresponding to the subset of FD bases),
   where the number of the plurality of lowest priority elements of the second subset of the plurality of amplitude coefficients may be Y_{2_3_2}, e.g

$${Y}_{2 \_ 3 \_ 2} = ⌊ \frac{{K}_{N - 1}^{NZ}}{2} ⌋ ,$$

A plurality of lowest priority elements of the phase coefficient indicator (i_{2,5,r,t}) (e.g. a subset of the plurality of phase coefficients corresponding to the subset of FD bases),
   where the number of the plurality of lowest priority elements of the subset of the plurality of phase coefficients may be Y_{3_3_2}, e.g.

$${Y}_{3 \_ 3 \_ 2} = ⌊ \frac{{K}_{N - 1}^{NZ}}{2} ⌋ .$$

In some embodiments, the terminal device 220 maty report a plurality of sets of CQIs (in each set of CQI, there may be a wideband CQI and/or a plurality of subband CQIs).

In some embodiments, the first set of CQIs may be reported in the first partition (such as, CSI part 1), while the others of the plurality of sets of CQIs may be reported in group 0 or group 1.

In some embodiments, the priority of the others of the plurality of sets of CQIs may be lower compared with any of the following: the indication of DD/TD basis type or whether DD/TD compression, a DD/TD basis indicator, and the first set of CQIs.

In some embodiments, only when DD/TD basis or DD/TD compression is applied, the others of the plurality of sets of CQIs may be reported.

The above examples are discussed with regards to a specific information group. In the followings, some examples are discussed with regards to a specific combination of information groups. Further, in the following example, priority levels comprise the highest priority and lowest priority. Specifically, the highest priority parameters refer to a plurality of highest priority elements (parameters) of codebook indication fields, the lowest priority parameters refer to a plurality of lowest priority elements of codebook indication fields, and all the parameters refers to all of the elements (parameters) of codebook indication fields.

In some embodiments, the codebook indication fields may include at least one of: a bitmap, amplitude coefficient indication fields and phase coefficient indication fields.

Similar with the above discussion, in the following, some examples are discussed with regards to FD bases. It is to be understood that the examples of discussed with regards to FD bases are also suitable for SD bases. Merely for brevity, similar contents are omitted here.

In some embodiments, for a given CSI feedback, the correspondence between the parameters and the other information group of the second partition may be stipulated as below:
The second information group (such as, CSI Group 1): the highest priority parameters of first set of FD bases (i.e., a set of FD bases comprising the first FD basis);
The third information group (such as, CSI Group 2): the lowest priority parameters of the first set of FD bases and all the parameters of the second set of FD bases.

Alternatively, in some embodiments, for a given CSI feedback, the correspondence between the parameters and the other information group of the second partition (such as, CSI part 2) may be stipulated as below:
The second information group (such as, CSI Group 1): all the parameters of the first set of FD bases;
The third information group (such as, CSI Group 2): all the parameters of the second set of FD bases.

Alternatively, in some embodiments, for a given CSI feedback, the correspondence between the parameters and the other information group of the second partition (such as, CSI part 2) may be stipulated as below:
The second information group (such as, CSI Group 1): the highest priority parameters of the first set of FD bases;
The third information group (such as, CSI Group 2): the lowest priority parameters of the first set of FD bases; and the highest priority parameters of the second set of FD bases;
The fourth information group (such as, CSI Group 3): the lowest priority parameters of the second set of FD bases.

Alternatively, in some embodiments, for a given CSI feedback, the correspondence between the parameters and the other information group of the second partition (such as, CSI part 2) may be stipulated as below:
The second information group (such as, CSI Group 1): the highest priority parameters determined based on FD bases and the highest priority parameters determined based on DD/TD bases;
The third information group (such as, CSI Group 2): the lowest priority parameters determined based on FD bases and the highest priority parameters determined based on DD/TD bases;
The fourth information group (such as, CSI Group 3): the highest priority parameters determined based on FD bases and the lowest priority parameters determined based on DD/TD bases;
The fifth information group (such as, CSI Group 4): 1 the lowest priority parameters determined based on FD bases and the lowest priority parameters determined based on DD/TD bases.

Alternatively, in some embodiments, for a given CSI feedback, the correspondence between the parameters and the other information group of the second partition (such as, CSI part 2) may be stipulated as below:
The second information group (such as, CSI Group 1): the highest priority parameters determined based on FD bases and the highest priority parameters determined based on DD/TD bases;
The third information group (such as, CSI Group 2): the highest priority parameters determined based on FD bases and the lowest priority parameters determined based on DD/TD bases;
The fourth information group (such as, CSI Group 3): the lowest priority parameters determined based on FD bases and the highest priority parameters determined based on DD/TD bases;
The fifth information group (such as, CSI Group 4): 1 the lowest priority parameters determined based on FD bases and the lowest priority parameters determined based on DD/TD bases.

It is to be understood that the above examples are illustrated only for the purpose of illustration without suggesting any limitations.

In some embodiments, the CSI feedback comprises a plurality of CSI reports, each of the plurality CSI reports corresponding to a respective time unit of a plurality of time units. FIG. 5B illustrates an example blocks of CSI feedback 550 according to some embodiments of the present disclosure, where the CSI feedback 550 comprises more than one CSI reports.

In some embodiments, each CSI report indicates at least one of the following:
at least one amplitude coefficient corresponding to the respective time unit,
at least one phase coefficient corresponding to the respective time unit,
the number of non-zero coefficients corresponding to the respective time unit,
a bitmap of the non-zero coefficients, or
a strongest coefficient for a layer corresponding to the respective resource.

In some embodiments, if a CSI report of the plurality CSI reports corresponds to a first time unit, the CSI report further indicates at least one of the following: RI, CQI, and the number of the plurality of time units.

In some embodiments, for CSI report for a high/medium velocity, there may be a set of CSI/PMI reports (as shown in FIG. 5B), wherein the number of CSI/PMI reports may be T (wherein T is the number of time units for CSI/PMI reporting), and each CSI/PMI report corresponds to one time unit.

In some embodiments, each CSI/PMI report comprises amplitude/phase coefficients corresponding to the time unit, and at least one of: number of non-zero coefficients corresponding to the time unit, bitmap of non-zero coefficients corresponding to the time unit, SCI corresponding to the time unit, reference co-phasing/amplitude (related to the first time unit) corresponding to the time unit.

In some embodiments, the CSI/PMI report corresponding to the first time unit may further comprise: CQI, RI, SCI (corresponding to the first time unit) and at least one of a strongest time unit index, the number of time units, overall number of non-zero coefficients (among the time units), a bitmap of non-zero coefficients (among the time units), reference co-phasing/amplitude coefficients corresponding to the subset of the time units (excluding the first time unit) SD bases/rotations.

In some embodiments, the CSI/PMI report corresponding to the first time unit has higher priority than other CSI/PMI reports and the other CSI/PMI reports, the priorities of the other CSI/PMI reports may be based on their time unit index. Alternatively, the priorities of the other CSI/PMI reports may be based on a same priority level which is lower than priority of the first time unit.

In some embodiments, if the CSI feedback is irrelevant with TD/DD basis, the terminal device 220 transmits the CSI feedback via a first uplink resource. Alternatively, if the TD/DD domain compression (or CSI feedback associated with doppler/time domain basis) is enabled, the terminal device 220 transmits the CSI feedback via a second uplink resource. Further, any of the first and second the uplink resources is one of a PUSCH or a PUCCH resource.

In some embodiments, the at least one configuration for the CSI feedback indicates the first uplink resource and the second uplink resource.

In some embodiments, for CSI report for a high/medium velocity, the terminal device 22o may report an indication of DD/TD basis type or whether DD/TD compression, and the PUCCH resource ID and/or size of PUCCH/PUSCH time/frequency resource may depend on the indication. Specifically, a first size of PUCCH/PUSCH time/frequency resource being applied in case of a first DD/TD basis type or no DD/TD compression hypothesis may be smaller than a second size of PUCCH/PUSCH time/frequency resource being applied in case of a second DD/TD basis type or DD/TD compression applied.

In some embodiments, the terminal device 220 transmits a first portion of the parameters on a channel with a first type, and transmits a second portion of the parameters on a channel with a second type.

In some embodiments, for CSI report for a high/medium velocity, a subset of PMIs or a subset of the CSI for a high/medium velocity may be reported on PUCCH resource. In some embodiments, the subset of PMI information or the subset of the CSI information may include at least one of CSI part 1, group 0 of CSI part 2. Additionally, in some embodiments, the subset of PMI information or the subset of the CSI information may include at least one of: the SD basis indications, the SD rotation indications, the number of time unit indexes, a value of DD/TD length, the number of DD/TD bases, an RI, an FD basis indication, an indication of DD/TD basis type or whether DD/TD compression.

Additionally, in some embodiments, the other PMI information or other subsets of CSI information may be reported on PUSCH, and the CSI reports for a high/medium velocity carried on the PUSCH can be calculated based on the latest CSI reports for a high/medium velocity carried on PUCCH (e.g. PUCCH format 3 or 4.)

Alternatively, all PMI information or the whole CSI information for a high/medium velocity may be reported on PUSCH.

In some embodiments, a first CSI report carrying CSI information for a high/medium velocity (or CSI feedback with DD/TD bases or time domain channel property (TDCP) measured based on tracking RS (IRS) or CSI feedback with doppler information) may have higher priority than any of: a second CSI report not carrying CSI information for a high/medium velocity, a third CSI report carrying L1-RSRP or L1-SINR (periodicity, semi-persistent, aperiodic).

In some embodiments, if a terminal device 220m is configured/indicated to report a first CSI report for a high/medium velocity (or a first CSI report with DD/TD bases or time domain channel property (TDCP) measured based on tracking RS (TRS), or a first CSI report with doppler information), the terminal device 220 may not report a second CSI report without carrying CSI information for a high/medium velocity, if the time/frequency resource for the first CSI and the time/frequency resource for the second CSI collide or overlap.

### Example of Methods

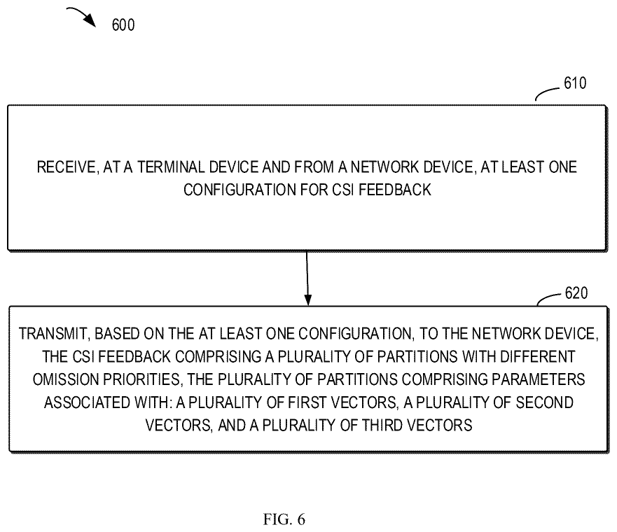

FIG. 6 illustrates a flowchart of an example method 600 in accordance with some embodiments of the present disclosure. For example, the method 600 can be implemented at the terminal device 220 as shown in FIG. 2.

At block 610, the terminal device 220 receives at least one configuration for CSI feedback from a network device 210.

At block 620, the terminal device 220 transmits the CSI feedback to the network device 210 based on at least one configuration. The CSI feedback comprises a plurality of partitions with different omission priorities, the plurality of partitions comprising parameters associated with: a plurality of first vectors, a plurality of second vectors, and a plurality of third vectors.

In some embodiments, the terminal device 220 determines priorities comprising at least one of the following: a respective first priority for a first vector of the plurality of first vectors, a respective second priority for a second vector of the plurality of second vectors, a respective third priority for a third vector of the plurality of third vectors, or a respective fourth priority for a parameter of the parameters comprised in the CSI feedback. The terminal device 220 further includes the parameters into the plurality of partitions of the CSI feedback based on the priorities.

In some embodiments, the terminal device 220 determines the priorities based at least in part on an index of third vector.

In some embodiments, the terminal device 220 prioritizes parameters associated with a primary vector being one of a primary first vector, a primary second vector, and a primary third vector.

Alternatively, or in addition, in some embodiments, the terminal device 220 prioritizes parameters associated with a first set of first vectors, including the primary first vector.

Alternatively, or in addition, in some embodiments, the terminal device 220 prioritizes parameters associated with a first set of second vectors, including the primary second vector.

Alternatively, or in addition, in some embodiments, the terminal device 220 prioritizes parameters associated with a first set of third vectors, including the primary third vector.

In some embodiments, the primary vector corresponds to the strongest coefficient.

Alternatively, or in addition, in some embodiments, the primary vector corresponds the strongest amplitude coefficient.

Alternatively, or in addition, in some embodiments, the primary vector corresponds the maximum power.

In some embodiments, the plurality of partitions at least comprises a first partition and a second partition, and the first partition is configured with a higher omission priority compared with the second partition. The first partition indicates at least one of the following: an indication indicating whether the CSI feedback is associated with a third vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the plurality of partitions at least comprises a first partition and a second partition, and a payload size of the second partition is based on at least one indication in the first partition. The first partition indicates at least one of the following: an indication indicating whether the CSI feedback is associated with a third vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the plurality of partitions at least comprises a first partition and a second partition, and a second partition comprising a plurality of information groups, a first information group of the plurality of information groups configured with a higher omission priority compared with the other information groups of the plurality of information groups. The first information group indicates at least one of the following: an indication indicating whether the CSI feedback is associated with a third vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the first information group of the second partition indicates a strongest coefficient for a layer corresponding to the primary vector.

In some embodiments, the other information groups of the plurality of information groups indicate non-zero coefficient information, the non-zero coefficient information indicating at least one of the following: a bitmap indicating non-zero coefficients, amplitude coefficients corresponding to the non-zero coefficients, or phase coefficients corresponding to the non-zero coefficients. The non-zero coefficients are associated with one of the following: a primary first vector, a primary second vector, a primary third vector, a subset of the plurality of the first vectors with the primary first vector included or excluded, a subset of the plurality of the second vectors with the primary second vector included or excluded, a subset of the plurality of the third vectors with the primary third vector included or excluded, the plurality of first vectors, the plurality of second vectors, or the plurality of third vectors.

In some embodiments, the other information groups of the plurality of information groups comprises a second information group and a third information group with a lower priority compared with the second information group. The second information group indicates first non-zero coefficient information corresponding to non-zero coefficients with higher priorities, and the third information group indicates second non-zero coefficient information corresponding to non-zero coefficients with lower priorities.

In some embodiments, the number of information groups of the plurality of information groups is larger than or equal to three.

In some embodiments, the CSI feedback comprises a plurality of CSI reports, each of the plurality CSI reports corresponding to a respective time unit of a plurality of time units.

In some embodiments, each CSI report indicates at least one of the following: at least one amplitude coefficient corresponding to the respective time unit, at least one phase coefficient corresponding to the respective time unit, the number of non-zero coefficients corresponding to the respective time unit, a bitmap of the non-zero coefficients, or a strongest coefficient for a layer corresponding to the respective resource.

In some embodiments, if a CSI report of the plurality CSI reports corresponds to the first time unit of the plurality of time units, the CSI report indicates at least one of the following: an RI, a CQI, an index of the time unit corresponding to strongest amplitude coefficient, or the number of the plurality of time units.

In some embodiments, the terminal device 220 transmits a first portion of the parameters on a channel with a first type, and transmits a second portion of the parameters on a channel with a second type.

In some embodiments, the CSI feedback is configured with a higher priority compared with a further CSI feedback irrelevant with a third vector.

In some embodiments, the first vector is an FD basis, the second vector is an SD and the third vector is a DD basis.

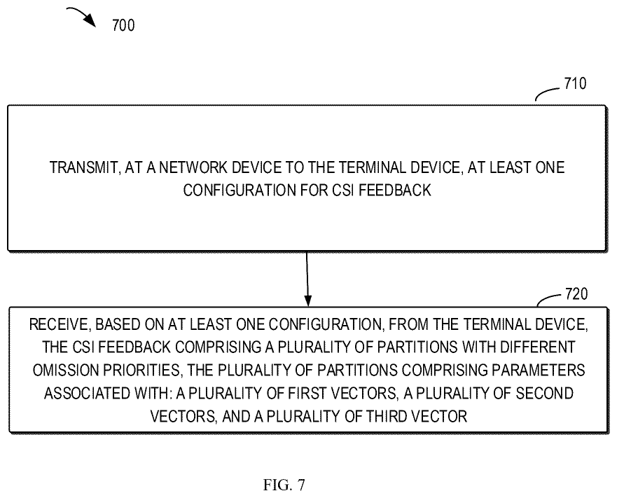

FIG. 7 illustrates a flowchart of an example method 700 in accordance with some embodiments of the present disclosure. For example, the method 700 can be implemented at the network device 210 as shown in FIG. 2.

At block 710, the network device 210 transmits at least one configuration for CSI feedback to a terminal device 220.

At block 720, the network device 210 receives the CSI feedback from the terminal device 220 based on at least one configuration. The CSI feedback comprises a plurality of partitions with different omission priorities, the plurality of partitions comprising parameters associated with: a plurality of first vectors, a plurality of second vectors, and a plurality of third vectors.

In some embodiments, the plurality of partitions at least comprises a first partition and a second partition, and the first partition is configured with a higher omission priority compared with the second partition. The first partition indicates at least one of the following: an indication indicating whether the CSI feedback is associated with a third vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the plurality of partitions at least comprises a first partition and a second partition, and a payload size of the second partition is based on at least one indication in the first partition. The first partition indicates at least one of the following: an indication indicating whether the CSI feedback is associated with a third vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the plurality of partitions at least comprises a first partition and a second partition, and a second partition comprising a plurality of information groups, a first information group of the plurality of information groups configured with a higher omission priority compared with the other information groups of the plurality of information groups. The first information group indicates at least one of the following: an indication indicating whether the CSI feedback is associated with a third vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the first information group of the second partition indicates a strongest coefficient for a layer corresponding to the primary vector.

In some embodiments, the other information groups of the plurality of information groups indicate non-zero coefficient information, the non-zero coefficient information indicating at least one of the following: a bitmap indicating non-zero coefficients, amplitude coefficients corresponding to the non-zero coefficients, or phase coefficients corresponding to the non-zero coefficients. The non-zero coefficients are associated with one of the following: a primary first vector, a primary second vector, a primary third vector, a subset of the plurality of the first vectors with the primary first vector included or excluded, a subset of the plurality of the second vectors with the primary second vector included or excluded, a subset of the plurality of the third vectors with the primary third vector included or excluded, the plurality of first vectors, the plurality of second vectors, or the plurality of third vectors.

In some embodiments, the other information groups of the plurality of information groups comprises a second information group and a third information group with a lower priority compared with the second information group. The second information group indicates first non-zero coefficient information corresponding to non-zero coefficients with higher priorities, and the third information group indicates second non-zero coefficient information corresponding to non-zero coefficients with lower priorities.

In some embodiments, the number of information groups of the plurality of information groups is larger than or equal to three.

In some embodiments, the CSI feedback comprises a plurality of CSI reports, each of the plurality CSI reports corresponding to a respective time unit of a plurality of time units.

In some embodiments, each CSI report indicates at least one of the following: at least one amplitude coefficient corresponding to the respective time unit, at least one phase coefficient corresponding to the respective time unit, the number of non-zero coefficients corresponding to the respective time unit, a bitmap of the non-zero coefficients, or a strongest coefficient for a layer corresponding to the respective resource.

In some embodiments, if a CSI report of the plurality CSI reports corresponds to the first time unit of the plurality of time units, the CSI report indicates at least one of the following: an RI, a CQI, an index of the time unit corresponding to strongest amplitude coefficient, or the number of the plurality of time units.

In some embodiments, the first vector is an FD basis, the second vector is an SD and the third vector is a DD basis.

### Example of Apparatuses and Devices

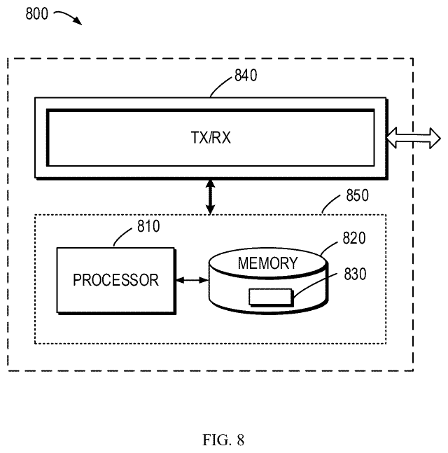

FIG. 8 is a simplified block diagram of a device 800 that is suitable for implementing embodiments of the present disclosure. The device 800 can be considered as a further example implementation of the terminal device 220 or the network device 210 as shown in FIG. 2. Accordingly, the device 800 can be implemented at or as at least a part of the terminal device 220 or the network device 210.

As shown, the device 800 includes a processor 810, a memory 820 coupled to the processor 810, a suitable transmitter (TX)/receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 2 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 880 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device 220 comprises a circuitry configured to

In some embodiments, a terminal device 220 comprises a circuitry configured to: receive at least one configuration for channel state information (CSI) feedback from a network device 210; and transmit the CSI feedback to the network device 210 based on at least one configuration. The CSI feedback comprises a plurality of partitions with different omission priorities, the plurality of partitions comprising parameters associated with: a plurality of first vectors, a plurality of second vectors, and a plurality of third vectors.

In some embodiments, the circuitry is further configured to: determine priorities comprising at least one of the following: a respective first priority for a first vector of the plurality of first vectors, a respective second priority for a second vector of the plurality of second vectors, a respective third priority for a third vector of the plurality of third vectors, or a respective fourth priority for a parameter of the parameters comprised in the CSI feedback. The circuitry is further configured to: include the parameters into the plurality of partitions of the CSI feedback based on the priorities.

In some embodiments, the circuitry is further configured to: determine the priorities based at least in part on an index of third vector.

In some embodiments, the circuitry is further configured to: prioritize parameters associated with a primary vector being one of a primary first vector, a primary second vector, and a primary third vector.

Alternatively, or in addition, in some embodiments, the circuitry is further configured to: prioritize parameters associated with a first set of first vectors, including the primary first vector.

Alternatively, or in addition, in some embodiments, the circuitry is further configured to: prioritize parameters associated with a first set of second vectors, including the primary second vector.

Alternatively, or in addition, in some embodiments, the circuitry is further configured to: prioritize parameters associated with a first set of third vectors, including the primary third vector.

In some embodiments, the primary vector corresponds to the strongest coefficient.

Alternatively, or in addition, in some embodiments, the primary vector corresponds the strongest amplitude coefficient.

Alternatively, or in addition, in some embodiments, the primary vector corresponds the maximum power.

In some embodiments, the plurality of partitions at least comprises a first partition and a second partition, and the first partition is configured with a higher omission priority compared with the second partition. The first partition indicates at least one of the following: an indication indicating whether the CSI feedback is associated with a third vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the plurality of partitions at least comprises a first partition and a second partition, and a payload size of the second partition is based on at least one indication in the first partition. The first partition indicates at least one of the following: an indication indicating whether the CSI feedback is associated with a third vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the plurality of partitions at least comprises a first partition and a second partition, and a second partition comprising a plurality of information groups, a first information group of the plurality of information groups configured with a higher omission priority compared with the other information groups of the plurality of information groups. The first information group indicates at least one of the following: an indication indicating whether the CSI feedback is associated with a third vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the first information group of the second partition indicates a strongest coefficient for a layer corresponding to the primary vector.

In some embodiments, the other information groups of the plurality of information groups indicate non-zero coefficient information, the non-zero coefficient information indicating at least one of the following: a bitmap indicating non-zero coefficients, amplitude coefficients corresponding to the non-zero coefficients, or phase coefficients corresponding to the non-zero coefficients. The non-zero coefficients are associated with one of the following: a primary first vector, a primary second vector, a primary third vector, a subset of the plurality of the first vectors with the primary first vector included or excluded, a subset of the plurality of the second vectors with the primary second vector included or excluded, a subset of the plurality of the third vectors with the primary third vector included or excluded, the plurality of first vectors, the plurality of second vectors, or the plurality of third vectors.

In some embodiments, the other information groups of the plurality of information groups comprises a second information group and a third information group with a lower priority compared with the second information group. The second information group indicates first non-zero coefficient information corresponding to non-zero coefficients with higher priorities, and the third information group indicates second non-zero coefficient information corresponding to non-zero coefficients with lower priorities.

In some embodiments, the number of information groups of the plurality of information groups is larger than or equal to three.

In some embodiments, the CSI feedback comprises a plurality of CSI reports, each of the plurality CSI reports corresponding to a respective time unit of a plurality of time units.

In some embodiments, each CSI report indicates at least one of the following: at least one amplitude coefficient corresponding to the respective time unit, at least one phase coefficient corresponding to the respective time unit, the number of non-zero coefficients corresponding to the respective time unit, a bitmap of the non-zero coefficients, or a strongest coefficient for a layer corresponding to the respective resource.

In some embodiments, if a CSI report of the plurality CSI reports corresponds to the first time unit of the plurality of time units, the CSI report indicates at least one of the following: an RI, a CQI, an index of the time unit corresponding to strongest amplitude coefficient, or the number of the plurality of time units.

In some embodiments, the circuitry is further configured to: transmit a first portion of the parameters on a channel with a first type, and transmits a second portion of the parameters on a channel with a second type.

In some embodiments, the CSI feedback is configured with a higher priority compared with a further CSI feedback irrelevant with a third vector.

In some embodiments, the first vector is an FD basis, the second vector is an SD and the third vector is a DD basis.

In some embodiments, a network device 210 comprises a circuitry configured to: transmit at least one configuration for CSI feedback to a terminal device 220; and receive the CSI feedback from the terminal device 220 based on at least one configuration. The CSI feedback comprises a plurality of partitions with different omission priorities, the plurality of partitions comprising parameters associated with: a plurality of first vectors, a plurality of second vectors, and a plurality of third vectors.

In some embodiments, the plurality of partitions at least comprises a first partition and a second partition, and the first partition is configured with a higher omission priority compared with the second partition. The first partition indicates at least one of the following: an indication indicating whether the CSI feedback is associated with a third vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the plurality of partitions at least comprises a first partition and a second partition, and a payload size of the second partition is based on at least one indication in the first partition. The first partition indicates at least one of the following: an indication indicating whether the CSI feedback is associated with a third vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the plurality of partitions at least comprises a first partition and a second partition, and a second partition comprising a plurality of information groups, a first information group of the plurality of information groups configured with a higher omission priority compared with the other information groups of the plurality of information groups. The first information group indicates at least one of the following: an indication indicating whether the CSI feedback is associated with a third vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the first information group of the second partition indicates a strongest coefficient for a layer corresponding to the primary vector.

In some embodiments, the other information groups of the plurality of information groups indicate non-zero coefficient information, the non-zero coefficient information indicating at least one of the following: a bitmap indicating non-zero coefficients, amplitude coefficients corresponding to the non-zero coefficients, or phase coefficients corresponding to the non-zero coefficients. The non-zero coefficients are associated with one of the following: a primary first vector, a primary second vector, a primary third vector, a subset of the plurality of the first vectors with the primary first vector included or excluded, a subset of the plurality of the second vectors with the primary second vector included or excluded, a subset of the plurality of the third vectors with the primary third vector included or excluded, the plurality of first vectors, the plurality of second vectors, or the plurality of third vectors.

In some embodiments, the other information groups of the plurality of information groups comprises a second information group and a third information group with a lower priority compared with the second information group. The second information group indicates first non-zero coefficient information corresponding to non-zero coefficients with higher priorities, and the third information group indicates second non-zero coefficient information corresponding to non-zero coefficients with lower priorities.

In some embodiments, the number of information groups of the plurality of information groups is larger than or equal to three.

In some embodiments, the CSI feedback comprises a plurality of CSI reports, each of the plurality CSI reports corresponding to a respective time unit of a plurality of time units.

In some embodiments, each CSI report indicates at least one of the following: at least one amplitude coefficient corresponding to the respective time unit, at least one phase coefficient corresponding to the respective time unit, the number of non-zero coefficients corresponding to the respective time unit, a bitmap of the non-zero coefficients, or a strongest coefficient for a layer corresponding to the respective resource.

In some embodiments, if a CSI report of the plurality CSI reports corresponds to the first time unit of the plurality of time units, the CSI report indicates at least one of the following: an RI, a CQI, an index of the time unit corresponding to strongest amplitude coefficient, or the number of the plurality of time units.

In some embodiments, the first vector is an FD basis, the second vector is an SD and the third vector is a DD basis.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication, comprising: receiving, at a terminal device and from a network device, at least one configuration for CSI feedback; and transmitting, based on at least one configuration, to the network device, the CSI feedback comprising a plurality of partitions with different omission priorities, the plurality of partitions comprising parameters associated with: a plurality of first vectors, a plurality of second vectors, and a plurality of third vectors.

In some embodiments, transmitting the CSI feedback comprises: determining, priorities comprising at least one of the following: a respective first priority for a first vector of the plurality of first vectors, a respective second priority for a second vector of the plurality of second vectors, a respective third priority for a third vector of the plurality of third vectors, or a respective fourth priority for a parameter of the parameters comprised in the CSI feedback; and generating, the CSI feedback by including, based on the priorities, the parameters into the plurality of partitions of the CSI feedback.

In some embodiments, determining the priorities comprises: determining the priorities based at least in part on an index of third vector.

In some embodiments, determining the priorities comprises: prioritizing parameters associated with at least one of the following: a primary vector being one of a primary first vector, a primary second vector, and a primary third vector, a first set of first vectors, including the primary first vector, a first set of second vectors, including the primary second vector, or a first set of third vectors, including the primary third vector.

In some embodiments, the primary vector corresponds to one of the following: the strongest coefficient, the strongest amplitude coefficient, or the maximum power.

In some embodiments, the plurality of partitions at least comprises a first partition and a second partition; wherein, the first partition is configured with a higher omission priority compared with the second partition, a payload size of the second partition is based on at least one indication in the first partition, or a second partition comprising a plurality of information groups, a first information group of the plurality of information groups configured with a higher omission priority compared with the other information groups of the plurality of information groups; and wherein one of the first partition and the first information group of the second partition indicates at least one of the following: an indication indicating whether the CSI feedback is associated with a third vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the first information group of the second partition indicates a strongest coefficient for a layer corresponding to the primary vector.

In some embodiments, the other information groups of the plurality of information groups indicate non-zero coefficient information, the non-zero coefficient information indicating at least one of the following: a bitmap indicating non-zero coefficients, the non-zero coefficients associated with one of the following: a primary first vector, a primary second vector, a primary third vector, a subset of the plurality of the first vectors with the primary first vector included or excluded, a subset of the plurality of the second vectors with the primary second vector included or excluded, a subset of the plurality of the third vectors with the primary third vector included or excluded, the plurality of first vectors, the plurality of second vectors, or the plurality of third vectors, amplitude coefficients corresponding to the non-zero coefficients, or phase coefficients corresponding to the non-zero coefficients.

In some embodiments, the other information groups of the plurality of information groups comprises a second information group and a third information group with a lower priority compared with the second information group, and wherein the second information group indicates first non-zero coefficient information corresponding to non-zero coefficients with higher priorities, and the third information group indicates second non-zero coefficient information corresponding to non-zero coefficients with lower priorities.

In some embodiments, the number of information groups of the plurality of information groups is larger than or equal to three.

In some embodiments, the CSI feedback comprises a plurality of CSI reports, each of the plurality CSI reports corresponding to a respective time unit of a plurality of time units.

In some embodiments, each CSI report indicates at least one of the following: at least one amplitude coefficient corresponding to the respective time unit, at least one phase coefficient corresponding to the respective time unit, the number of non-zero coefficients corresponding to the respective time unit, a bitmap of the non-zero coefficients, or a strongest coefficient for a layer corresponding to the respective resource.

In some embodiments, if a CSI report of the plurality CSI reports corresponds to the first time unit of the plurality of time units, the CSI report indicates at least one of the following: an RI, a CQI, an index of the time unit corresponding to strongest amplitude coefficient, or the number of the plurality of time units.

In some embodiments, transmitting the CSI feedback to the network device comprises: transmitting a first portion of the parameters on a channel with a first type, and transmitting a second portion of the parameters on a channel with a second type.

In some embodiments, the CSI feedback is configured with a higher priority compared with a further CSI feedback irrelevant with a third vector.

In some embodiments, the first vector is an FD basis, the second vector is an SD and the third vector is a DD basis.

In another solution, a method of communication, comprising: transmitting, at a network device and to a terminal device, at least one configuration for CSI feedback; and receiving, based on at least one configuration, from the terminal device, the CSI feedback comprising a plurality of partitions with different omission priorities, the plurality of partitions comprising parameters associated with: a plurality of first vectors, a plurality of second vectors, and a plurality of third vectors.

In some embodiments, the plurality of partitions at least comprises a first partition and a second partition; wherein, the first partition is configured with a higher omission priority compared with the second partition, a payload size of the second partition is based on at least one indication in the first partition, or a second partition comprising a plurality of information groups, a first information group of the plurality of information groups configured with a higher omission priority compared with the other information groups of the plurality of information groups; and wherein one of the first partition and the first information group of the second partition indicates at least one of the following: an indication indicating whether the CSI feedback is associated with a first vector or whether a DD compression is enabled, a CQI set corresponding to a specific time unit, an index of the specific time unit, a first number of non-zero coefficients corresponding to a primary vector, an index of the primary basis, a total number of non-zero coefficients, a length of the plurality of third vectors, or the number of the plurality of third vectors.

In some embodiments, the first information group of the second partition indicates a strongest coefficient for a layer corresponding to the primary vector.

In some embodiments, the other information groups of the plurality of information groups indicate non-zero coefficient information, the non-zero coefficient information indicating at least one of the following: a bitmap indicating non-zero coefficients, the non-zero coefficients associated with one of the following: the plurality of first vectors associated with the CSI feedback, the plurality of second vectors, the plurality of third vectors, a primary first vector, a second first vector, a third first vector the plurality of the first vectors with the primary first vector included or excluded, the plurality of the second vectors with the primary second vector included or excluded, the plurality of the third vectors with the primary third vector included or excluded, amplitude coefficients corresponding to the non-zero coefficients, or phase coefficients corresponding to the non-zero coefficients.

In some embodiments, the other information groups of the plurality of information groups comprises a second information group and a third information group with a lower priority compared with the second information group, and wherein the second information group indicates first non-zero coefficient information corresponding to non-zero coefficients with higher priorities, and the third information group indicates second non-zero coefficient information corresponding to non-zero coefficients with lower priorities.

In some embodiments, the number of information groups of the plurality of information groups is larger than or equal to three.

In some embodiments, the CSI feedback comprises a plurality of CSI reports, each of the plurality CSI reports corresponding to a respective time unit of a plurality of time units.

In some embodiments, each CSI report indicates at least one of the following: at least one amplitude coefficient corresponding to the respective time unit, at least one phase coefficient corresponding to the respective time unit, the number of non-zero coefficients corresponding to the respective time unit, a bitmap of the non-zero coefficients, or a strongest coefficient for a layer corresponding to the respective resource.

In some embodiments, if a CSI report of the plurality CSI reports corresponds to the first time unit of the plurality of time units, the CSI report indicates at least one of the following: an RI, a CQI, an index of the time unit corresponding to strongest amplitude coefficient, or the number of the plurality of time units.

In some embodiments, the first vector is an FD basis, the second vector is an SD basis and the third vector is a DD basis.

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method, performed by a terminal device, the method comprising:
receiving, from a network device, a configuration comprising a codebook type; and
transmitting, to the network device, a channel state information (CSI) report corresponding to the configuration,
wherein:
the CSI report comprises a first indicator associated with a doppler domain basis vector and a second indicator of a bitmap, and
each reported element of the second indicator is associated with a priority, the priority is determined based on an index of the doppler domain basis vector.

22. The method of claim 21, wherein
a plurality of precoding matrices corresponding to the CSI report are determined based on a number of doppler domain basis vectors associated with the first indicator.

23. The method of claim 21, wherein
the bitmap indicates an amplitude coefficient or a phase coefficient being reported, and a bit size for the second indicator is equal to 2*L*vᵣᵢ*Mᵥ*M_{d}, wherein L is a number of first vectors, Mᵥ is a number of second vectors, M_{d} is a number of doppler domain vectors associated with the first indicator, vᵣᵢ is a number of layers.

24. The method of claim 21, wherein
the CSI report comprising a first CSI part and a second CSI part, a payload size of the second CSI part is determined based on the first CSI part,
the first CSI part comprises a first CQI corresponding to a first time unit, and the second CSI part comprises a second CQI corresponding to a second time unit.

25. The method of claim 21, wherein
the CSI report comprises a third indicator associated with a strongest coefficient, the strongest coefficient corresponds to the index of the doppler domain vector.

26. A method, performed by a network device, the method comprising:
transmitting, to a terminal device, a configuration comprising a codebook type; and
receiving, from the terminal device, a channel state information (CSI) report corresponding to the configuration,
wherein:
the CSI report comprises a first indicator associated with a doppler domain basis vector and a second indicator of a bitmap, and
each reported element of the second indicator is associated with a priority, the priority is determined based on an index of the doppler domain basis vector.

27. The method of claim 26, wherein
a plurality of precoding matrices corresponding to the CSI report are determined based on a number of doppler domain basis vectors associated with the first indicator.

28. The method of claim 26, wherein
the bitmap indicates an amplitude coefficient or a phase coefficient being reported, and a bit size for the second indicator is equal to 2*L*vᵣᵢ*Mᵥ*M_{d}, wherein L is a number of first vectors, Mᵥ is a number of second vectors, M_{d} is a number of doppler domain vectors associated with the first indicator, vᵣᵢ is a number of layers.

29. The method of claim 26, wherein
the CSI report comprising a first CSI part and a second CSI part, a payload size of the second CSI part is determined based on the first CSI part,
the first CSI part comprises a first CQI corresponding to a first time unit, and the second CSI part comprises a second CQI corresponding to a second time unit.

30. The method of claim 26, wherein
the CSI report comprises a third indicator associated with a strongest coefficient, the strongest coefficient corresponds to the index of the doppler domain vector.

31. A terminal device, comprising a processor configured to cause the terminal device to:
receive, from a network device, a configuration comprising a codebook type; and
transmit, to the network device, a channel state information (CSI) report corresponding to the configuration,
wherein:
the CSI report comprises a first indicator associated with a doppler domain basis vector and a second indicator of a bitmap, and
each reported element of the second indicator is associated with a priority, the priority is determined based on an index of the doppler domain basis vector.

32. The terminal device of claim 31, wherein
a plurality of precoding matrices corresponding to the CSI report are determined based on a number of doppler domain basis vectors associated with the first indicator.

33. The terminal device of claim 31, wherein
the bitmap indicates an amplitude coefficient or a phase coefficient being reported, and a bit size for the second indicator is equal to 2*L*vᵣᵢ*Mᵥ*M_{d}, wherein L is a number of first vectors, Mᵥ is a number of second vectors, M_{d} is a number of doppler domain vectors associated with the first indicator, vᵣᵢ is a number of layers.

34. The terminal device of claim 31, wherein
the CSI report comprising a first CSI part and a second CSI part, a payload size of the second CSI part is determined based on the first CSI part,
the first CSI part comprises a first CQI corresponding to a first time unit, and the second CSI part comprises a second CQI corresponding to a second time unit.

35. The terminal device of claim 31, wherein
the CSI report comprises a third indicator associated with a strongest coefficient, the strongest coefficient corresponds to the index of the doppler domain vector.
